(19) United States
(12) Patent Application Publication
(10) Pub. No.: US 2015/0329364 A1
(43) Pub. Date: Nov. 19, 2015

(54) ACTIVATED CARBON PRODUCTS AND METHODS FOR MAKING AND USING SAME

(71) Applicant: Georgia-Pacific Chemicals LLC, Atlanta, GA (US)

(72) Inventors: Xing Dong, Decatur, GA (US); Scott W. Tull, Decatur, GA (US)

(73) Assignee: Georgia-Pacific Chemicals LLC, Atlanta, GA (US)

(21) Appl. No.: 14/710,059

(22) Filed: May 12, 2015

Related U.S. Application Data
(60) Provisional application No. 61/992,592, filed on May 13, 2014.

(51) Int. Cl. C01B 31/08; C01B 31/12; C01B 31/10

(52) U.S. Cl. CPC C01B 31/08; C01B 31/10; C01B 31/125; C01B 31/12; C01P 2006/12; C01P 2006/14; C01P 2006/16; C01P 2006/80; C01P 2006/40

(57) ABSTRACT

Activated carbon products and methods for making same. In one example, activated carbon products can have a specific surface area of at least 3,050 m²/g to about 7,000 m²/g, a pore volume of about 3 cm³/g to about 10 cm³/g, and an average pore size of about 0.5 nm to about 150 nm. In one example, activated carbon products can be made by reacting a hydroxybenzene compound and an aldehyde compound in the presence of a solvent to produce a prepolymer. The prepolymer and an additive can be reacted to produce a wet gel product that can be dried, pyrolized, and activated to produce an activated carbon product. The activated carbon product can have a specific surface area of about 100 m²/g to about 7,000 m²/g, a pore volume of about 0.2 cm³/g to about 10 cm³/g, and/or an average pore size of about 0.5 nm to about 150 nm.

### CROSS-REFERENCE TO RELATED APPLICATION

This application claims priority to U.S. Provisional Patent Application No. 61/992,592, filed on May 13, 2014, which is incorporated by reference herein.

### BACKGROUND

1. Field

Embodiments described generally relate to activated carbon products and methods for making and using the same. More particularly, embodiments described relate to carbon-containing wet gel products, dried gel products, pyrolized carbon products, activated carbon products, and methods for making same.

2. Description of the Related Art

Carbon-containing wet gels and dried gels made therefrom, such as carbon aerogels, xerogels, and cryogels, have been used in a variety of products to improve various performance properties including, but not limited to, thermal insulation values, electrical conductivity, and energy storage. One particular composition that can be used to make wet gels and dried gels therefrom can include, for example, resorcinol and formaldehyde (a “monomer component” or “sol,” which is a solution or a colloidal dispersion of particles in a liquid) for producing precursor solutions that can be further processed into a large monolithic polymer gel or “sol-gel.”

For many applications, the dried monolithic polymer gels (e.g., aerogels) have pores with diameters between about 2 nm and 50 nm (mesoporous) or greater. The monolithic polymer gels, however, are difficult and expensive to convert into an aerogel. For example, supercritical drying, the drying process typically used to make aerogels, requires specialized equipment and is a time consuming process.

There is a need, therefore, for improved activated carbon products and particles and methods for making same.

### SUMMARY

Activated carbon products and methods for making same are provided. In at least one example, activated carbon products can have a specific surface area of at least 3,050 m²/g to about 7,000 m²/g, a pore volume of about 3 cm³/g to about 10 cm³/g, and an average pore size of about 0.5 nm to about 150 nm. In some examples, the specific surface area can be about 3,200 m²/g to about 5,000 m²/g, and the pore volume can be about 4 cm³/g to about 8 cm³/g. In other examples, the pore volume can be about 5.01 cm³/g to about 8 cm³/g, and the specific surface area can be greater than 3,200 m²/g to about 5,000 m²/g. In other examples, the average pore size can be about 2 nm to about 10 nm. In other examples, the activated carbon products can have at least 99 wt % of carbon.

In at least one example, a method for making an activated carbon product can include reacting a hydroxybenzene compound and an aldehyde compound in the presence of a solvent to produce a prepolymer. The prepolymer and an additive can be combined to produce a wet gel reaction mixture. The additive can include a carboxylic acid, an anhydride, a homopolymer, a copolymer, or any mixture thereof. The prepolymer and the additive can be reacted to produce a wet gel product. The wet gel product can be dried at a pressure below a critical pressure of the solvent to produce a dried gel product. The dried gel product can be pyrolized to produce a pyrolized product. The pyrolized product can be activated to produce an activated carbon product. The activated carbon product can have at least one of the following properties: a specific surface area of about 100 m²/g to about 7,000 m²/g, a pore volume of about 0.2 cm³/g to about 10 cm³/g, and an average pore size of about 0.5 nm to about 150 nm.

In another example, a method for making an activated carbon product can include reacting a hydroxybenzene compound and formaldehyde in the presence of a solvent to produce a prepolymer. The hydroxybenzene compound can include phenol, resorcinol, or a mixture of phenol and resorcinol. The hydroxybenzene compound can be present in an amount of about 50 wt % to about 90 wt % and the formaldehyde can be present in an amount of about 10 wt % to about 50 wt %, based on the combined weight of the hydroxybenzene compound and formaldehyde. The prepolymer, a carboxylic acid, and an anhydride can be combined to produce a wet gel reaction mixture. The wet gel reaction mixture can include about 10 wt % to about 80 wt % of the prepolymer, up to about 85 wt % of the carboxylic acid, and up to about 20 wt % of the anhydride, based on the combined weight of the hydroxybenzene compound, the formaldehyde, the carboxylic acid, and the anhydride. The prepolymer, the carboxylic acid, and the anhydride can be reacted to produce a wet gel product. The wet gel product can be dried to produce a dried gel product. The dried gel product can be pyrolized to produce a pyrolized product. The pyrolized product can be activated to produce an activated carbon product. The activated carbon product can have at least one of the following properties: a specific surface area of about 100 m²/g to about 7,000 m²/g, a pore volume of about 0.2 cm³/g to about 10 cm³/g, and an average pore size of about 0.5 nm to about 150 nm.

### BRIEF DESCRIPTION OF THE DRAWINGS

FIG. 1 is a graphical depiction of galvanostatic test results for sequences 3 to 8 of the ultracap galvanostatic tests from experimental examples 79 and 82 and is plotted in current vs. time.

FIG. 2 is a graphical depiction of an experimental voltage versus time for 2.7 V and 3 V of the cyclic voltammetry tests from experimental examples 79 and 82.

FIG. 3 is a graphical depiction of a charge and discharge cycle according to an ultra-capacitor setting profile ΔV0 from experimental examples 79 and 82.

### DETAILED DESCRIPTION

As used herein, the term “activated carbon products” refers to activated carbon, activated particles, activated carbon particles, activated carbon products, activated carbon materials, or carbonaceous materials, and can be in various forms such as a film, monolith, particles, powders, flakes, rods, nonporous, porous, nanoporous, and the like.

In one or more embodiments, a method for making activated carbon products can include combining one or more hydroxybenzene compounds, one or more aldehyde compounds, and one or more solvents to produce a prepolymer reaction mixture, reacting the hydroxybenzene compound and the aldehyde compound to produce a phenol-formaldehyde prepolymer, and combining the phenol-formaldehyde prepolymer and one or more additives to produce a wet gel reaction mixture. The additive can include one or more carboxylic acids, one or more anhydrides, one or more homopolymers, one or more copolymers, or any mixture thereof. The method can further include reacting the phenol-formaldehyde prepolymer and the at least one additive to produce the wet gel product and drying the wet gel product at a pressure below the critical pressure of the solvent to produce a dried gel product. The method can also include pyrolyzing the dried gel product to produce a pyrolized product and activating the pyrolized product to produce an activated carbon product.

The activated carbon product can have one or more of the following properties, such as a specific surface area of about 100 m²/g to about 7,000 m²/g, a pore volume of about 0.2 cm³/g to about 10 cm³/g, and an average pore size of about 0.5 nm to about 150 nm. In some examples, the activated carbon product can have a specific surface area of about 500 m²/g to about 5,000 m²/g. In other examples, the activated carbon product can have a pore volume of about 0.5 cm³/g to about 8 cm³/g or greater than 1 cm³/g to about 6 cm³/g. In other examples, the activated carbon product can have a specific surface area of at least 3,050 m²/g to about 7,000 m²/g, a pore volume of about 3 cm³/g to about 10 cm³/g, and an average pore size of about 0.5 nm to about 150 nm. In some examples, the specific surface area can be about 3,200 m²/g to about 5,000 m²/g, and the pore volume can be about 4 cm³/g to about 8 cm³/g. In other examples, the pore volume can be about 5.01 cm³/g to about 8 cm³/g and the specific surface area can be greater than 3,200 m²/g to about 5,000 m²/g. In other examples, the average pore size can be about 2 nm to about 10 nm. In some examples, the activated carbon products can have a carbon content of at least 99 wt %, at least 99.2 wt %, at least 99.4 wt %, at least 99.5 wt %, at least 99.6 wt %, at least 99.7 wt %, at least 99.8 wt %, at least 99.9 wt %, at least 99.95 wt %, or at least 99.99 wt %.

In one or more embodiments, a method for making activated carbon products can include combining a solvent, a hydroxybenzene compound, an aldehyde compound, and an additive that can include one or more carboxylic acids, one or more anhydrides, one or more homopolymers, one or more copolymers, or any mixture thereof, to produce a reaction mixture and reacting at least the hydroxybenzene compound and the aldehyde compound to produce a wet gel. The method can further include drying the wet gel product at a pressure below the critical pressure of the solvent to produce a dried gel, pyrolyzing the dried gel to produce a pyrolized product, and activating the pyrolized product to produce an activated carbon product.

In one embodiment, a method for making activated carbon products can include combining one or more hydroxybenzene compounds, one or more aldehyde compounds, and one or more solvents to produce a prepolymer reaction mixture and reacting the hydroxybenzene compound and the aldehyde compound to produce a phenol-formaldehyde prepolymer. The method can further include combining at least the phenol-formaldehyde prepolymer, a carboxylic acid, and an anhydride to produce a wet gel reaction mixture and reacting the phenol-formaldehyde prepolymer, the carboxylic acid, and the anhydride to produce a wet gel product. The method can also include drying the wet gel product to produce a dried gel product, pyrolyzing the dried gel product to produce a pyrolized product, and activating the pyrolized product to produce an activated carbon product.

In one or more embodiments, the method can further include combining one or more activating agents with the wet gel product, the dried gel product, or the pyrolized product. The activating agent can react with the pyrolized product to produce the activated carbon product. In one embodiment, the method can include activating the pyrolized product to produce the activated carbon product. The activation can include heating the pyrolized product to a temperature of about 500° C. to about 1,500° C. in an atmosphere containing at least one or more activating agents. The activating agent can include carbon dioxide, steam, oxygen, ozone, or mixtures thereof. In some examples, the pyrolized product can be heated to a temperature of about 700° C. to about 1,200° C. for about 0.5 hr to about 48 hr in an atmosphere containing carbon dioxide. The atmosphere containing the activating agent can be maintained at a pressure of about 50 kPa to about 200 kPa. For example, the atmosphere containing the activating agent can exert a pressure on the pyrolized product at or below atmospheric pressure.

In one or more embodiments, activation of the pyrolized product to produce the activated carbon product can also include combining the pyrolized product and at least one activating agent to produce an activation mixture, drying the activation mixture to produce a dried activation mixture, and heating the dried activation mixture to a temperature of about 500° C. to about 1,500° C. in an atmosphere containing at least one or more inert gases to produce an activated carbon mixture. In one example, during the activation the pyrolized product to produce the activated carbon product, the method can also include treating the activated carbon mixture with an acidic solution to produce a treated activated carbon mixture, rinsing the treated activated carbon mixture, and drying the treated activated carbon mixture to produce the activated carbon product. Illustrative activating agent can include one or more hydroxides, one or more carbonates, one or more metal halides, one or more phosphorous-containing acids, one or more sulfur-containing acids, salts thereof, or any mixture thereof. In some examples, the activating agent can include an alkali metal hydroxide, an alkaline earth hydroxide, an alkali metal carbonate, an alkaline earth carbonate, carbonic acid, sulfuric acid, phosphoric acid, an alkali metal phosphate, an alkaline earth phosphate, phosphorous acid, an alkali metal phosphite, an alkaline earth phosphite, hypophosphorous acid, an alkali metal hypophosphite, an alkaline earth hypophosphite, a calcium halide, a zinc halide, salts thereof, acids thereof, or any mixture thereof. In some specific examples, the activating agent can include phosphoric acid, potassium carbonate, potassium hydroxide, calcium chloride, zinc chloride, salts thereof, acids thereof, or any mixture thereof. In some embodiments, a combination or mixture of the pyrolized (carbon) product and the activating (chemical) agent can have a weight ratio (e.g., pyrolized (carbon) product to activating (chemical) agent weight ratio) of the pyrolized carbon product to the activating agent of about 1 to about 1 (about 1:1) or about 1 to about 2 (about 1:2).

The at least one additive can include one or more carboxylic acids, one or more anhydrides, one or more homopolymers, one or more copolymers, or any mixture thereof. In one example, the at least one additive can include one or more carboxylic acids and one or more anhydrides. In another example, the one or more carboxylic acids can be acetic acid and citric acid and the one or more anhydrides can be maleic anhydride. In another example, the at least one additive can include one or more homopolymers or one or more copolymers. In another example, the one or more homopolymers or the one or more copolymers independently can include poly(ethylene glycol), polypropylene glycol), or any mixture thereof. In another example, the at least one additive can include poly(ethylene glycol)-polypropylene glycol)-poly(ethylene glycol) block polymer. In another example, the at least one additive can include acetic acid, citric acid, and maleic anhydride. In another example, the at least one additive can include acetic acid, citric acid, maleic anhydride, and a poly(ethylene glycol)-polypropylene glycol)-poly(ethylene glycol) block polymer.

In one or more embodiments, the prepolymer reaction mixture can include about 50 wt % to about 90 wt % of the hydroxybenzene compound and about 10 wt % to about 50 wt % of the aldehyde compound, based on the combined weight of the hydroxybenzene compound and the aldehyde compound. In some embodiments, the wet gel reaction mixture can include about 10 wt % to about 80 wt % of a phenol-formaldehyde prepolymer, up to about 85 wt % of a carboxylic acid, up to about 20 wt % of an anhydride compound, up to about 30 wt % of the homopolymer, and up to about 30 wt % of the copolymer, wherein the wet gel reaction mixture can include about 10 wt % to about 90 wt % of the additive, and where all weight percent values are based on the combined weight of the hydroxybenzene compound, the aldehyde compound, and the one or more additives.

In one or more embodiments, the method can further include pyrolyzing the dried gel product to produce the pyrolized product can also include heating the dried gel product to a temperature of about 500° C. to about 1,400° C. in an atmosphere containing at least one or more inert gases. The pressure maintained on the wet gel product during the drying to produce the dried gel product can be at or below atmospheric pressure. In some examples, the dried gel product can have one or more of the following properties, such as a specific surface area of about 50 m²/g to about 5,000 m²/g, a pore volume of about 0.1 cm³/g to about 10 cm³/g, and an average pore size of about 0.2 nm to about 150 nm.

In one or more embodiments, a method for making pyrolized carbon products can include combining one or more hydroxybenzene compounds, one or more aldehyde compounds, and one or more solvents to produce a prepolymer reaction mixture and reacting the hydroxybenzene compound and the aldehyde compound to produce a phenol-formaldehyde prepolymer. The method can further include combining the phenol-formaldehyde prepolymer and one or more additives to produce a wet gel reaction mixture and reacting the phenol-formaldehyde prepolymer and the at least one additive to produce the wet gel product. The one or more additives can include one or more carboxylic acids, one or more anhydrides, one or more homopolymers, one or more copolymers, or any mixture thereof. The method can also include drying the wet gel product at a pressure below the critical pressure of the solvent to produce a dried gel product and pyrolyzing the dried gel product to produce pyrolized carbon products.

In one or more embodiments, a method for making a wet gel product can include combining one or more hydroxybenzene compounds, one or more aldehyde compounds, and one or more solvents to produce a prepolymer reaction mixture and reacting the hydroxybenzene compound and the aldehyde compound to produce a phenol-formaldehyde prepolymer. The prepolymer reaction mixture can include about 50 wt % to about 90 wt % of the hydroxybenzene compound and about 10 wt % to about 50 wt % of the aldehyde compound, based on the combined weight of the hydroxybenzene compound and the aldehyde compound. The method can further include combining the phenol-formaldehyde prepolymer and one or more additives to produce a wet gel reaction mixture and reacting the phenol-formaldehyde prepolymer and the one or more additives to produce the wet gel product. The wet gel reaction mixture can include about 10 wt % to about 80 wt % of the phenol-formaldehyde prepolymer, up to about 85 wt % of a carboxylic acid, up to about 20 wt % of an anhydride compound, up to about 30 wt % of the homopolymer, and up to about 30 wt % of the copolymer, the wet gel reaction mixture can include about 10 wt % to about 90 wt % of the additive, where all weight percent values are based on the combined weight of the hydroxybenzene compound, the aldehyde compound, and the one or more additives. In some examples, the hydroxybenzene compound can include phenol, resorcinol, cresol, catechol, hydroquinone, phloroglucinol, or any mixture thereof, and the aldehyde compound can include formaldehyde, acetaldehyde, propionaldehyde, butyraldehyde, furfuraldehyde, glucose, benzaldehyde, and cinnamaldehyde, or any mixture thereof.

In one or more embodiments, a wet gel can be formed by reacting or polymerizing a reactant or reaction mixture that can include, but is not limited to, at least one hydroxybenzene compound, at least one aldehyde compound, and at least one additive. The additive can include, but is not limited to, at least one carboxylic acid, at least one anhydride, at least one homopolymer, at least one copolymer, or any mixture thereof. The wet gel can also be formed by reacting or polymerizing a reaction mixture that can include, but is not limited to, a prepolymer and the additive. The prepolymer can be formed by reacting the hydroxybenzene compound and the aldehyde compound. The prepolymer can further polymerize in the presence of the additive such that the additive does not react and/or does react to form part of the polymer forming the wet gel. The reaction mixture can also include, but is not limited to, the hydroxybenzene compound, the aldehyde compound, the prepolymer, and the additive.

As used herein, the terms “wet gel” and “wet gel product” refer to a wet (aqueous or non-aqueous based) network of polymer chains that have one or more pores or voids therein and a liquid at least partially occupying or filling the one or more pores or voids. If the liquid that at least partially occupies or fills the voids is water, the polymer particles can be referred to as a “hydrogel.” As used herein, the term prepolymer refers to the reaction product formed by reacting at least the hydroxybenzene compound and the aldehyde compound with one another so long as the resulting product remains in liquid form at room temperature. The resulting product, i.e., the prepolymer, can also remain in liquid form at room temperature and room pressure. Similar to the activated carbon products, the wet gels or wet gel products can be in various forms such as a film, monolith, particles, powders, flakes, rods, composites, nonporous, porous, nanoporous, and the like.

The reaction mixture can also include, but is not limited to, at least one solvent and/or at least one catalyst. Any one or more of the components of the reaction mixture can be reactive or non-reactive. For example, the hydroxybenzene compound and the aldehyde compound can react with one another to form a polymer. In another example, the solvent can be non-reactive with any of the other components of the reaction mixture.

The wet gel such as polymer particles in gel form or a monolithic polymer structure in gel form can be produced by polymerizing the reaction mixture in a solution, dispersion, suspension, and/or emulsion process. The reaction or polymerization of the reaction mixture can proceed via a sol gel-type process to produce the wet gel. The sol gel process is a well-known process that can be used to produce wet gels in a monolithic form. The sol gel process is discussed and described in, for example, U.S. Pat. Nos. 4,873,218; 4,997,804; 5,124,364; and 5,556,892. The reaction or polymerization of the reaction mixture can proceed via step-growth polymerization, e.g., condensation polymerization, addition polymerization, or a combination of step-growth and addition polymerization. The reaction or polymerization of the reaction mixture and/or the formation of the prepolymer can be carried out in one or more solvents or liquid mediums.

As used herein, the term “solvent” refers to a substance that dissolves or suspends the reactants and provides a medium in which a reaction may occur. Suitable solvents can include, but are not limited to, water, alcohols, alkanes, ketones, aromatic hydrocarbons, or any mixture thereof. Illustrative alcohols can include, but are not limited to, methanol, ethanol, propanol, t-butanol, or any mixture thereof. Illustrative alkanes can include, but are not limited to, hexane, heptane, octane, nonane, decane, and the like, isomers thereof, or any mixture thereof. Illustrative ketones can include, but are not limited to, acetone, benzophenone, acetophenone, 2,2-dimethyl-1,3-cyclopentanedione, or any mixture thereof. Other suitable solvents can include, but are not limited to, tetrahydrofuran, benzene, toluene, xylene, ethylbenzene, cumene, mesitylene, or any mixture thereof. The liquid that at least partially occupies or fills the pores or voids of the wet gel can be or include the solvent. The liquid that at least partially occupies or fills the pores or voids of the wet gel can also include one or more of the reactants in the reaction mixture (the hydroxybenzene compound, the aldehyde compound, the carboxylic acid, the anhydride, the homopolymer, the copolymer, and/or the catalyst). In at least one embodiment, the intentional addition of a solvent can be avoided. Additionally, if the solvent is not added to the reaction mixture, if the hydroxybenzene compound and the aldehyde compound react with one another via a condensation reaction, the water generated from the condensation reaction can become or serve as a solvent or liquid that can at least partially occupy or fill the pores or voids of the wet gel.

The reaction or polymerization of the reaction mixture can proceed via a suspension or dispersion polymerization process to produce the wet gel. As used herein, the terms “suspension process,” “suspension polymerization process,” “dispersion process,” and “dispersion polymerization process” are used interchangeably and refer to a heterogeneous reaction process that uses mechanical agitation to mix the reaction mixture in the solvent or “continuous phase” fluid such as a hydrocarbon and/or water, where the reaction mixture phase and the solvent or continuous phase fluid are not miscible. The reaction mixture can be suspended or dispersed in the solvent or continuous phase as droplets, where the reactants (at least the hydroxybenzene compound and the aldehyde compound) can undergo reaction to form particles of polymer and/or curing to form cured particles of polymer. As used herein, the term “curing” refers to the toughening or hardening of polymers via an increased degree of cross-linking of polymer chains. Cross-linking refers to the structural and/or morphological change that occurs in the pre-polymer and/or polymer, such as by covalent chemical reaction, ionic interaction or clustering, phase transformation or inversion, and/or hydrogen bonding.

The reaction or polymerization of the reaction mixture can proceed via an emulsion polymerization process to produce the wet gel. As used herein, the terms “emulsion process” and “emulsion polymerization process” refer to both “normal” emulsions and “inverse” emulsions. Emulsions differ from suspensions in one or more aspects. One difference is that an emulsion will usually include the use of a surfactant that creates or forms the emulsions (small sized droplets). When the carrier or continuous phase fluid is a hydrophilic fluid such as water and the reaction mixture phase is a hydrophobic compound(s), normal emulsions, such as oil-in-water, form, where droplets of monomers are emulsified with the aid of a surfactant in the carrier or continuous phase fluid. Monomers react in these small sized droplets. These droplets are typically small in size as the particles are stopped from coagulating with each other because each particle is surrounded by the surfactant and the charge on the surfactant electrostatically repels other particles. Whereas suspension polymerization usually creates much larger particles than those made with emulsion polymerization. When the carrier or continuous phase fluid is a hydrophobic fluid such as oil and the reaction mixture phase is hydrophilic compounds, inverse-emulsions, such as water-in-oil, form.

Illustrative suspension and emulsion polymerization processes suitable for preparing the wet gel can include those discussed and described in U.S. Patent Application Publication Nos. 2013/0209348 and 2013/0211005.

In one or more embodiments, the preparation of the wet gel particles can be controlled such that two or more populations of particle size distributions can be produced. For example, introduction of an aqueous phase to an organic phase can be staged. As such, the final wet gel particle distribution can include one or two or more nodes, where the ratio between the highest and lowest node is about 1,000 or less, about 500 or less, about 200 or less, about 100 or less, about 50 or less, about 25 or less, about 10 or less, 5 or less, or about 2 or less.

The hydroxybenzene compound and the aldehyde compound can be pre-polymerized at a temperature of about 20° C., about 25° C., about 30° C., about 35° C., or about 40° C. to about 50° C., about 55° C., about 60° C., about 65° C., about 70° C., about 75° C., about 80° C., about 85° C., about 90° C., about 95° C., about 100° C., about 150° C., about 200° C., about 250° C., or about 300° C. In one or more embodiments, the hydroxybenzene compound and the aldehyde compound can be pre-polymerized under pressure and the temperature during the prepolymerization can be up to the boiling point of the reaction mixture. For example, the hydroxybenzene compound and the aldehyde compound can be pre-polymerized at a temperature of about 30° C. to about 95° C., about 60° C. to about 90° C., about 75° C. to about 95° C., or about 50° C. to about 90° C. In another example, the hydroxybenzene compound and the aldehyde compound can be pre-polymerized at a temperature of about 40° C., about 50° C., about 60° C., about 70° C., about 75° C., about 80° C., about 85° C., about 90° C., or about 95° C. The prepolymer can be mixed, blended, stirred, or otherwise combined with at least one of and the additive, with or without the solvent and/or catalyst.

If the prepolymer is formed by reacting the hydroxybenzene compound with the aldehyde compound, the extent or amount the compounds react to form the prepolymer can be based on one or more properties. Illustrative properties of the reaction product or prepolymer that can be used to monitor the extent of reaction can include, but are not limited to, viscosity, water concentration, refractive index, the unreacted or free concentration of the aldehyde compound, molecular weight, or any combination thereof.

If the prepolymer is formed, the hydroxybenzene compound and the aldehyde compound can be reacted with one another until the prepolymer has a viscosity of about 0.5 cP, about 1 cP, about 2 cP, about 10 cP, or about 50 cP to about 100 cP, about 500 cP, about 1,000 cP, about 2,500 cP, about 5,000 cP, or about 10,000 cP at a temperature of 25° C. For example, the hydroxybenzene and aldehyde can be reacted with one another until the prepolymer has a viscosity of about 1 cP to about 800 cP, about 5 cP to about 500 cP, about 75 cP to about 400 cP, about 125 cP to about 1,100 cP, or about 150 cP to about 300 cP at a temperature of 25° C.

The viscosity of the reaction mixture or prepolymer or other liquids can be determined using a viscometer at a temperature of 25° C. For example, a suitable viscometer can be the model DV-II+ viscometer, available from Brookfield Engineering Laboratories, that can be equipped with a sample adapter, such as a 10 mL sample adapter, and the appropriate spindle to maximize torque, such as a no. 31 spindle. The small sample adapter can allow the sample to be cooled or heated by the chamber jacket to maintain the temperature of the sample surrounding the spindle at a temperature of about 25° C.

If the prepolymer is formed, the hydroxybenzene compound and the aldehyde compound can be reacted with one another until the prepolymer has a water concentration of about 0.5 wt %, about 1 wt %, about 2 wt %, or about 3 wt % to about 50 wt %, about 60 wt %, about 70 wt %, or about 80 wt %, based on the weight of the prepolymer, any unreacted hydroxybenzene compound, any unreacted aldehyde compound, and water. For example, the prepolymer can be produced by reacting phenol and formaldehyde, and the formaldehyde combined with the phenol can be a 50 wt % aqueous solution. As such, the water concentration can be based on water produced or generated during formation of the prepolymer and/or water added to the mixture of phenol and formaldehyde. The hydroxybenzene compound and the aldehyde compound can be reacted with one another to produce the prepolymer with the reaction reduced or stopped and/or the carboxylic acid, the anhydride, the homopolymer, and/or the copolymer added thereto when the prepolymer has a water concentration of about 5 wt % to about 50 wt %, about 1 wt % to about 25 wt %, about 10 wt % to about 40 wt %, about 12 wt % to about 20 wt %, or about 15 wt % to about 35 wt %, based on the weight of the prepolymer, any unreacted hydroxybenzene compound, any unreacted aldehyde compound, and water.

If the prepolymer is formed, the hydroxybenzene compound and the aldehyde compound can be reacted to an endpoint based on the refractive index of the liquid prepolymer. For example, the prepolymer can be polymerized until the prepolymer has a refractive index of about 1.1000, about 1.2000, about 1.3000, or about 1.3200 to about 1.4500, about 1.4800, about 1.5000, about 1.5500, about 1.6000, about 1.6500, about 1.7000, about 1.7500, or about 1.8000. In another example, the polymerization of the monomer mixture to produce the prepolymer can be carried out to a refractive index of about 1.3500 to about 1.4500, about 1.3800 to about 1.4400, about 1.3900 to about 1.4350, about 1.3900 to about 1.4500, about 1.1000 to about 1.7000, about 1.3000 to about 1.6000, about 1.4200 to about 1.5500, about 1.4800 to about 1.6400, or about 1.3700 to about 1.4300.

If the prepolymer is formed, the hydroxybenzene compound and the aldehyde compound can be reacted with one another to an endpoint based on the unreacted or free concentration of the aldehyde compound. For example, the prepolymer can be polymerized until the reaction mixture has no free aldehyde compound remaining or an unreacted or free concentration of the aldehyde compound of about 0.5 wt %, about 1 wt %, about 3 wt %, or about 5 wt % to about 10 wt %, about 15 wt %, about 20 wt %, or about 25 wt %. In another example, the prepolymer can be polymerized until the reaction mixture has an unreacted or free concentration of the aldehyde compound of about 2 wt % to about 17 wt %, about 1 wt % to about 5 wt %, about 4 wt % to about 12 wt %, or about 6 wt % to about 18 wt %.

If the prepolymer is formed, the hydroxybenzene compound and the aldehyde compound can be reacted with one another to an endpoint based on the molecular weight of the prepolymer. For example, the prepolymer can be polymerized until the prepolymer has a weight average molecular weight of about 100, about 300, about 500, or about 800 to about 1,000, about 5,000, about 10,000, or about 20,000. In another example, the prepolymer can be polymerized until the prepolymer has a weight average molecular weight of about 200 to about 1,200, about 400 to about 900, about 600 to about 2,500, about 1,000 to about 6,000, about 3,000 to about 12,000, or about 7,000 to about 16,000.

In one or more embodiments, the reaction mixture can be agitated. For example, the reaction mixture can be agitated to improve and/or maintain a homogeneous or substantially homogenous distribution of the reactants in the solvent or a homogeneous or substantially homogenous distribution of the solvent in the reaction mixture. In one or more embodiments, the reaction mixture is not agitated. The components of the reaction mixture can be combined within one or more mixers. The mixer can be or include any device, system, or combination of device(s) and/or system(s) capable of batch, intermittent, and/or continuous mixing, blending, contacting, or the otherwise combining of two or more components. Illustrative mixers can include, but are not limited to, mechanical mixer agitation, ejectors, static mixers, mechanical/power mixers, shear mixers, sonic mixers, vibration mixing, movement of the mixer itself, or any combination thereof. The mixer can include one or more heating jackets, heating coils, internal heating elements, cooling jackets, cooling coils, internal cooling elements, or the like, to regulate the temperature therein. The mixer can be an open vessel or a closed vessel. The components of the reaction mixture can be combined within the mixer under a vacuum, at atmospheric pressure, or at pressures greater than atmospheric pressure.

Depending, at least in part, on the temperature at which reaction between the components of the reaction mixture is carried out, the reactants can react and/or cure in a time period of about 30 sec to several days. For example, the reaction mixture can be reacted and/or cured for about 1 min, about 2 min, about 3 min, about 4 min, about 5 min, about 10 min, about 15 min, or about 20 min to about 40 min, about 1 hr, about 1.5 hr, about 2 hr, about 3 hr, about 4 hr, about 5 hr, about 10 hr, about 15 hr, about 20 hr, about 1 day, about 2 days, about 3 days, about 4 days, about 5 days, about 6 days, or more to produce the wet gel. The reaction mixture can be reacted and/or cured at a temperature of about 25° C., about 35° C., about 45° C., about 55° C., or about 65° C. to about 85° C., about 100° C., about 125° C., about 150° C., about 175° C., about 200° C., about 225° C., about 250° C., about 275° C., or about 300° C. The pressure of the reaction mixture during reaction can less than atmospheric pressure (e.g., a vacuum) to greater than atmospheric pressure (e.g., an overpressure). For example, the pressure of the reaction mixture during reaction can be about 50 kPa, about 75 kPa, about 100 kPa, or atmospheric pressure (about 101.3 kPa) to about 110 kPa, about 150 kPa, about 200 kPa, about 500 kPa, about 5,000 kPa, about 10,000 kPa, or about 50,000 kPa.

The reaction between at least the hydroxybenzene compound and the aldehyde compound and/or the prepolymer in the presence of the additive can be carried out in one continuous reaction step or two or more reaction steps. One example of a multi-step reaction process can include heating the reactants to a first temperature for a first time period in the reaction vessel to produce a first or intermediate product. The intermediate product can then be heated or cooled to a second temperature for a second time period to produce the wet gel product. The second temperature can be greater than the first temperature or less than the first temperature. The second time period can be greater than the first time period or less than the first time period. Another example of a multi-step reaction process can include heating the reactants to a first temperature for a first time period in the reaction vessel to produce a first or intermediate product. The intermediate product can be heated to a second temperature for a second time period to produce a second intermediate product. The second intermediate product can then be heated to a third temperature for a third time period to produce the wet gel. The third temperature can be greater than the second temperature or less than the second temperature. The third temperature can be greater than the first temperature or less than the first temperature. If the reaction mixture is heated within a sealed reaction vessel during the production of the wet gel, the pressure within the-reaction vessel may increase during heating of the reaction mixture. The wet gel can be made in a reaction vessel that remains open (not sealed), closed (sealed), or the reaction vessel can be open for some of the time and closed for some of the time. The pressure of the reaction mixture, the first intermediate product, and/or the second intermediate product can be anywhere from less than atmospheric pressure to greater than atmospheric pressure.

In at least one specific example, the hydroxybenzene compound and the aldehyde compound and/or the prepolymer formed therefrom and the additive can be combined in the reaction vessel to form a reaction mixture and the reaction mixture can be heated to a first temperature for a first time period to produce a first intermediate product. The one or more catalyst and/or solvents can also be added to the reaction vessel and be present in the reaction mixture. The first temperature can be about 25° C., about 30° C., about 35° C., about 40° C., about 45° C., about 50° C., or about 60° C. to about 80° C., about 90° C., about 95° C., about 100° C. or more. The first time period can be about 30 min, about 1 hr, about 1.5 hr, about 2 hr, or about 3 hr to about 6 hr, about 12 hr, about 18 hr, about 1 day, about 2 days, about 3 days, or more than about 3 days. The first intermediate product can then heated to a second temperature for a second time period to produce a second intermediate product. The second temperature can be about 25° C., about 30° C., about 35° C., about 40° C., about 45° C., about 50° C., or about 60° C. to about 80° C., about 90° C., about 95° C., about 100° C. or more. The second time period can be about 30 min, about 1 hr, about 1.5 hr, about 2 hr, or about 3 hr to about 6 hr, about 12 hr, about 18 hr, about 1 day, about 2 days, about 3 days, or more than 3 days. The second intermediate product can be heated to a third temperature for a third time period to produce the wet gel. The third temperature can be about 25° C., about 30° C., about 35° C., about 40° C., about 45° C., about 50° C., or about 60° C. to about 80° C., about 90° C., about 95° C., about 100° C. or more. The third time period can be about 30 min, about 1 hr, about 1.5 hr, about 2 hr, or about 3 hr to about 6 hr, about 12 hr, about 18 hr, about 1 day, about 2 days, or about 3 days.

If the solvent is present in the reaction mixture, the temperature of the reaction mixture, the first intermediate product, the second intermediate product, and/or any other intermediate products formed before arriving at the wet gel product can be maintained at a temperature below the boiling point of the solvent. If the solvent is present in the reaction mixture, the temperature of the reaction mixture, the first intermediate product, the second intermediate product, and/or any other intermediate products formed before arriving at the wet gel product can be increased above the boiling point of the solvent during heating of any one or more of the reaction mixture, the first intermediate product, the second intermediate product, and/or any other intermediate products.

The reaction between the components of the reaction mixture, e.g., at least the hydroxybenzene compound and the aldehyde compound, can be carried out under a wide range of pH values. For example, the reaction between the components of the reaction mixture can be carried out at a pH value of about 1, about 2, or about 3 to about 7, about 8, about 9, about 10, about 11, or about 12. In one or more embodiments, the reaction can be carried out under acidic conditions. For example, the pH value of the reaction mixture can be less than 7, less than 6.5, less than 6, less than 5.5, less than 5, less than 4.5, or less than 4. In another example, the pH value of the reaction mixture can be about 1 to about 6.5, about 1.5 to about 5.5, about 2 to about 5, about 1.5 to about 4.5, about 1 to about 4, about 2 to about 4, about 1 to about 3.5, or about 2 to about 4.5.

The molar ratio of the hydroxybenzene compound to the aldehyde compound can be about 0.1:1 to about 1.5:1. For example, the molar ratio of the one or more hydroxybenzene compound to the aldehyde compounds can be about 0.2:1 to about 1.4:1, about 0.8:1 to about 1.3:1, about 0.2:1 to about 0.9:1, about 0.3:1 to about 0.8:1, about 0.4:1 to about 0.8:1, about 0.4:1 to about 0.7:1, or about 0.4:1 to about 0.6:1. In at least one example, the molar ratio of the hydroxybenzene compound to the aldehyde compound can be about 0.4:1, about 0.5:1, about 0.6:1, about 0.7:1, about 0.8:1, about 0.9:1, or about 1:1.

If the catalyst is present, the molar ratio of the hydroxybenzene compound to catalyst can be about 2, about 3, about 4, about 5, about 6, or about 7 to about 50, about 100, about 200, about 500, or about 1,000. For example, the molar ratio of the hydroxybenzene compound to catalyst can be about 2 to about 1,000, about 3 to about 800, a about 4 to about 700, about 5 to about 300, about 2 to about 50, about 1 to about 20, about 10 to about 30, about 20 to about 40, or about 30 to about 50. In another example, the molar ratio of the hydroxybenzene compound can be at least 2, at least 3, at least 4, at least 5, at least 10, at least 15, at least 25, at least 40, at least 55, at least 60, at least 65, at least 70, or at least 75 and less than 1,000, less than 500, less than 200, or less than 100.

The reaction mixture can include about 5 wt %, about 10 wt %, about 15 wt %, about 20 wt %, about 25 wt %, or about 30 wt % to about 45 wt %, about 50 wt %, about 55 wt %, about 60 wt %, about 65 wt %, or about 70 wt % of the hydroxybenzene compound, based on the combined weight of the hydroxybenzene compound, the aldehyde compound, and the additive. For example, the reaction mixture can include about 10 wt % to about 50 wt %, about 15 wt % to about 45 wt %, about 17 wt % to about 40 wt %, or about 20 wt % to about 35 wt % of the hydroxybenzene compound, based on the combined weight of the hydroxybenzene compound, the aldehyde compound, and the additive. In another example, the reaction mixture can include at least 12 wt %, at least 15 wt %, at least 17 wt %, or at least 20 wt % to about 35 wt %, about 40 wt %, about 45 wt %, or about 50 wt % of the hydroxybenzene compound, based on the combined weight of the hydroxybenzene compound, the aldehyde compound, and the additive.

The reaction mixture can include about 3 wt %, about 5 wt %, about 7 wt %, about 9 wt %, or about 10 wt % to about 11 wt %, about 12 wt %, about 14 wt %, about 16 wt %, about 18 wt %, about 20 wt %, about 22 wt %, about 25 wt %, or about 30 wt % of the aldehyde compound, based on the combined weight of the hydroxybenzene compound, the aldehyde compound, and the additive. For example, the reaction mixture can include about 6 wt % to about 22 wt %, about 7 wt % to about 18 wt %, about 8 wt % to about 17 wt %, or about 9 wt % to about 16 wt % of the aldehyde compound, based on the combined weight of the hydroxybenzene compound, the aldehyde compound, and the additive. In another example, the reaction mixture can include at least 5 wt %, at least 6 wt %, at least 7 wt %, or at least 8 wt % to about 14 wt %, about 16 wt %, about 18 wt %, or about 20 wt % of the aldehyde compound, based on the combined weight of the hydroxybenzene compound, the aldehyde compound, and the additive.

The reaction mixture can include from low of about 0.1 wt %, about 1 wt %, about 5 wt %, about 10 wt %, or about 15 wt % to about 40 wt %, about 50 wt %, about 60 wt %, about 70 wt %, about 80 wt %, or about 85 wt % of the carboxylic acid, based on the combined weight of the hydroxybenzene compound, the aldehyde compound, and the additive. For example, the reaction mixture an include about 10 wt % to about 75 wt %, about 20 wt % to about 45 wt %, about 35 wt % to about 65 wt %, about 50 wt % to about 70 wt %, about 25 wt % to about 35 wt %, about 30 wt % to about 45 wt %, or about 55 wt % to about 65 wt % of the carboxylic acid, based on the combined weight of the hydroxybenzene compound, the aldehyde compound, and the additive. In another example, the reaction mixture can include at least 20 wt %, at least 25 wt %, at least 30 wt %, or at least 35 wt % to about 60 wt %, about 65 wt %, about 70 wt %, or about 75 wt % of the carboxylic acid, based on the combined weight of the hydroxybenzene compound, the aldehyde compound, and the additive.

The reaction mixture can include about 0.1 wt %, about 1 wt %, about 5 wt %, about 10 wt %, or about 15 wt % to about 20 wt %, about 25 wt %, about 30 wt %, about 35 wt %, or about 40 wt % of the anhydride, based on the combined weight of the hydroxybenzene compound, the aldehyde compound, and the additive. For example, reaction mixture can include about 0.5 wt % to about 6 wt %, about 1 wt % to about 5 wt %, about 1.5 wt % to about 3 wt %, about 5 wt % to about 15 wt %, about 10 wt % to about 25 wt %, about 20 wt % to about 40 wt %, about 10 wt % to about 35 wt %, or about 1 wt % to about 8 wt % of the anhydride, based on the combined weight of the hydroxybenzene compound, the aldehyde compound, and the additive. In another example, the reaction mixture can include at least 0.5 wt %, at least 1 wt %, at least 1.5 wt %, or at least 2 wt % to about 5 wt %, about 10 wt %, about 20 wt %, or about 30 wt % of the anhydride, based on the combined weight of the hydroxybenzene compound, the aldehyde compound, and the additive.

The reaction mixture can include about 0.1 wt %, about 1 wt %, about 5 wt %, about 10 wt %, or about 15 wt % to about 20 wt %, about 25 wt %, about 30 wt %, about 35 wt %, or about 40 wt % of the homopolymer, based on the combined weight of the hydroxybenzene compound, the aldehyde compound, and the additive. For example, the reaction mixture can include about 0.5 wt % to about 6 wt %, about 1 wt % to about 5 wt %, about 1.5 wt % to about 3 wt %, about 5 wt % to about 15 wt %, about 10 wt % to about 25 wt %, about 20 wt % to about 40 wt %, about 10 wt % to about 35 wt %, or about 1 wt % to about 8 wt % of the homopolymer, based on the combined weight of the hydroxybenzene compound, the aldehyde compound, and the additive. In another example, the reaction mixture can include at least 0.5 wt %, at least 1 wt %, at least 1.5 wt %, or at least 2 wt % to about 5 wt %, about 10 wt %, about 20 wt %, or about 30 wt % of the homopolymer, based on the combined weight of the hydroxybenzene compound, the aldehyde compound, and the additive.

The reaction mixture can include about 0.1 wt %, about 1 wt %, about 5 wt %, about 10 wt %, or about 15 wt % to about 20 wt %, about 25 wt %, about 30 wt %, about 35 wt %, or about 40 wt % of the copolymer, based on the combined weight of the hydroxybenzene compound, the aldehyde compound, and the additive. For example, the reaction mixture can include about 0.5 wt % to about 6 wt %, about 1 wt % to about 5 wt %, about 1.5 wt % to about 3 wt %, about 5 wt % to about 15 wt %, about 10 wt % to about 25 wt %, about 20 wt % to about 40 wt %, about 10 wt % to about 35 wt %, or about 1 wt % to about 8 wt % of the copolymer, based on the combined weight of the hydroxybenzene compound, the aldehyde compound, and the additive. In another example, the reaction mixture can include at least 0.5 wt %, at least 1 wt %, at least 1.5 wt %, or at least 2 wt % to about 5 wt %, about 10 wt %, about 20 wt %, or about 30 wt % of the copolymer, based on the combined weight of the hydroxybenzene compound, the aldehyde compound, and the additive.

The reaction mixture can include about 1 wt %, about 3 wt %, about 5 wt %, about 8 wt %, about 10 wt %, about 15 wt %, about 20 wt %, about 30 wt %, or about 35 wt % to about 50 wt %, about 60 wt %, about 70 wt %, about 80 wt %, or about 90 wt % of the additive, based on the combined weight of the hydroxybenzene compound, the aldehyde compound, and the additive. Said another way, the total amount of the additive (the combined amount(s) of carboxylic acid, anhydride, homopolymer, and copolymer) can be about 1 wt %, about 3 wt %, about 5 wt %, about 8 wt %, about 10 wt %, about 15 wt %, about 20 wt %, about 30 wt %, or about 35 wt % to about 50 wt %, about 60 wt %, about 70 wt %, about 80 wt %, or about 90 wt % of the additive, based on the combined weight of the hydroxybenzene compound, the aldehyde compound, and the additive(s). For example, the reaction mixture can include about 50 wt % to about 80 wt %, about 60 wt % to about 75 wt %, about 2 wt % to about 30 wt %, about 15 wt % to about 50 wt %, about 20 wt % to about 45 wt %, about 35 wt % to about 65 wt %, about 55 wt % to about 75 wt %, about 70 wt % to about 85 wt %, or about 30 wt % to about 45 wt % of the additive, based on the combined weight of the hydroxybenzene compound, the aldehyde compound, and the additive. In another example, the reaction mixture can include at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, or at least 60 wt % to about 65 wt %, about 70 wt %, about 75 wt %, about 80 wt %, or about 90 wt % of the additive, based on the combined weight of the hydroxybenzene compound, the aldehyde compound, and the additive.

In one or more embodiments, the reaction mixture can include the additive in an amount of about 10 wt %, about 15 wt %, about 20 wt %, about 25 wt %, about 30 wt %, about 35 wt %, about 40 wt %, about 45 wt %, about 50 wt %, about 55 wt %, about 60 wt % to about 65 wt %, about 70 wt %, about 75 wt %, about 80 wt %, or about 90 wt %, where the reaction mixture includes up to about 65 wt %, up to about 70 wt %, up to about 75 wt %, or up to about 85 wt % of the carboxylic acid, up to about 25 wt %, up to about 30 wt %, up to about 35 wt %, or up to about 40 wt % of the anhydride, up to about 25 wt %, up to about 30 wt %, up to about 35 wt %, or up to about 40 wt % of the homopolymer, and up to about 25 wt %, up to about 30 wt %, up to about 35 wt %, or up to about 40 wt % of the copolymer, and where all weight percent values are based on the combined weight of the hydroxybenzene compound, the aldehyde compound, and the additive. For example, the reaction mixture can include up to about 85 wt % of the carboxylic acid, up to about 40 wt % of the anhydride, up to about 40 wt % of the homopolymer, and up to about 40 wt % of the copolymer, where the reaction mixture includes about 10 wt % to about 90 wt % of the additive, and where all weight percent values are based on the combined weight of the hydroxybenzene compound, the aldehyde compound, and the additive.

The reaction mixture can include about 1 wt %, about 5 wt %, about 10 wt %, about 15 wt %, about 20 wt %, about 25 wt %, about 30 wt %, about 35 wt %, about 40 wt %, or about 45 wt % to about 60 wt %, about 65 wt %, about 70 wt %, about 75 wt %, about 80 wt %, about 85 wt %, about 90 wt %, or about 95 wt % of the solvent, based on the combined weight of the hydroxybenzene compound, the aldehyde compound, the solvent, the catalyst, and the additive. For example, the reaction mixture can include about 1 wt % to about 95 wt %, about 5 wt % to about 90 wt %, about 10 wt % to about 85 wt %, or about 15 wt % to about 75 wt % of the solvent, based on the combined weight of the hydroxybenzene compound, the aldehyde compound, the solvent, the catalyst, and the additive. In another example, the reaction mixture can include at least 1 wt %, at least 5 wt %, at least 10 wt %, at least 15 wt %, or at least 20 wt % to about 60 wt %, about 65 wt %, about 70 wt %, about 75 wt %, about 80 wt %, about 85 wt %, about 90 wt %, or about 95 wt % of the solvent, based on the combined weight of the hydroxybenzene compound, the aldehyde compound, the solvent, the catalyst, and the additive. In still another example, the reaction mixture can include about 1 wt %, about 5 wt %, about 10 wt %, about 15 wt %, about 20 wt %, about 25 wt %, about 30 wt %, about 35 wt %, about 40 wt %, or about 45 wt % to about 60 wt %, about 65 wt %, about 70 wt %, about 75 wt %, about 80 wt %, about 85 wt %, about 90 wt %, or about 95 wt % of the solvent, based on the combined weight of the hydroxybenzene compound, the aldehyde compound, the additive, and the solvent.

The hydroxybenzene compound can be or include substituted phenolic compounds, unsubstituted phenolic compounds, or any combination of substituted and/or unsubstituted phenolic compounds. For example, the hydroxybenzene compound can be or include, but is not limited to, phenol, resorcinol (e.g., 1,3-dihydroxybenzene), or a combination thereof. In another example, the hydroxybenzene compound can also be or include any compound or combination of compounds, from which resorcinol or any resorcinol derivative can be derived. In another example, the hydroxybenzene compound can be a monohydroxybenzene, a dihydroxybenzene, a trihydroxybenzene, any other polyhydroxybenzene, or any combination thereof. In another example, the hydroxybenzene compound can be phenol.

In one or more embodiments, the hydroxybenzene compound can be represented by Formula I:

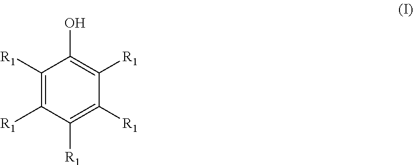

where each R¹ can independently be hydrogen (H), a hydroxy, C1-C5 alkyl, or OR², where R₂ can be a C1-C5 alkyl or C1-C5 aryl. Other suitable hydroxybenzene compounds can be represented by Formula II:

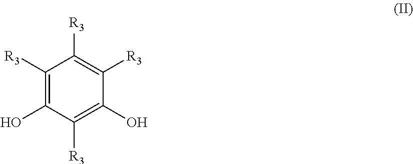

where each R₃ can independently be hydrogen (H); a hydroxy; a halide such as fluoride, chloride, bromide, or iodide; a nitro; a benzo; a carboxy; an acyl such as formyl, an alkyl-carbonyl such as acetyl, and an arylcarbonyl such as benzoyl; alkyl such as methyl, ethyl, propyl, butyl, pentyl, hexyl, heptyl, octyl, nonyl, decyl and the like; an alkenyl such as unsubstituted or substituted vinyl and allyl; unsubstituted or substituted methacrylate, unsubstituted or substituted acrylate; silyl ether; siloxanyl; aryl such as phenyl and naphthyl; aralkyl such as benzyl; or alkyaryl such as alkylphenols, and where at least two R₃ are hydrogen.

Other suitable hydroxybenzene compounds can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; and halogen-substituted phenols such as p-chlorophenol. Dihydric phenols such as catechol, resorcinol, hydroquinone, bisphenol A and bisphenol F also can also be used. In particular, the hydroxybenzene compound can be selected from the group consisting of phenol; resorcinol; catechol; hydroquinone; alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; halogen-substituted phenols such as p-chlorophenol; bisphenol A; and bisphenol F. Still other suitable hydroxybenzene compounds can be or include pyrogallol, 5-methylresorcinol, 5-ethylresorcinol, 5-propylresorcinol, 4-methylresorcinol, 4-ethylresorcinol, 4-propylresorcinol, resorcinol monobenzoate, resorcinol monosinate, resorcinol diphenyl ether, resorcinol monomethyl ether, resorcinol monoacetate, resorcinol dimethyl ether, phloroglucinol, benzoylresorcinol, resorcinol rosinate, alkyl substituted resorcinol, aralkyl substituted resorcinol such as 2-methylresorcinol, phloroglucinol, 1,2,4-benzenetriol, 3,5-dihydroxybenzaldehyde, 2,4-dihydroxybenzaldehyde, 4-ethylresorcinol, 2,5-dimethylresorcinol, 5-methylbenzene-1,2,3-triol, 3,5-dihydroxybenzyl alcohol, 2,4,6-trihydroxytoluene, 4-chlororesorcinol, 2′,6′-dihydroxyacetophenone, 2′,4′-dihydroxyacetophenone, 3′,5′-dihydroxyacetophenone, 2,4,5-trihydroxybenzaldehyde, 2,3,4-trihydroxybenzaldehyde, 2,4,6-trihydroxybenzaldehyde, 3,5-dihydroxybenzoic acid, 2,4-dihydroxybenzoic acid, 2,6-dihydroxybenzoic acid, 1,3-dihydroxynaphthalene, 2′,4′-dihydroxypropiophenone, 2′,4′-dihydroxy-6′-methylacetophenone, 1-(2,6-dihydroxy-3-methylphenyl)ethanone, 3-methyl 3,5-dihydroxybenzoate, methyl 2,4-dihydroxybenzoate, gallacetophenone, 2,4-dihydroxy-3-methylbenzoic acid, 2,6-dihydroxy-4-methylbenzoic acid, methyl 2,6-dihydroxybenzoate, 2-methyl-4-nitroresorcinol, 2,4,5-trihydroxybenzoic acid, 3,4,5-trihydroxybenzoic acid, 2,3,4-trihydroxybenzoic acid, 2,4,6-trihydroxybenzoic acid, 2-nitrophloroglucinol or a combination thereof. Another suitable hydroxybenzene compound can be or include phloroglucinol.

In one or more embodiments, the hydroxybenzene compound can also be or include one or more tannins. As used herein, the term “tannin” refers to both hydrolyzable tannins and condensed tannins. As such, the hydroxybenzene compound can be or include hydrolyzable tannins, condensed tannins, or a combination of hydrolyzable tannins and condensed tannins. Illustrative genera of shrubs and/or trees from which suitable tannins can be derived can include, but are not limited to, Acacia, Castanea, Vachellia, Senegalia, Terminalia, Phyllanthus, Caesalpinia, Quercus, Schinopsis, Tsuga, Rhus, Juglans, Carya, and Pinus, or any combination thereof. In another example, genera from which suitable tannins can be derived can include, but are not limited to, Schinopsis, Acacia, or a combination thereof. In another example, genera from which suitable tannins can be derived can include, but are not limited to, Pinus, Carya, or a combination thereof.

Hydrolyzable tannins are mixtures of simple phenols such as pyrogallol and ellagic acid and of esters of a sugar such as glucose, with gallic and digallic acids. Illustrative hydrolyzable tannins can include, but are not limited to, extracts recovered from Castanea sativa (e.g., chestnut), Terminalia and Phyllanthus (e.g., myrabalans tree species), Caesalpinia coriaria (e.g., divi-divi), Caesalpinia spinosa, (e.g., tara), algarobilla, valonea, and Quercus (e.g., oak). Condensed tannins are polymers formed by the condensation of flavans. Condensed tannins can be linear or branched molecules. Illustrative condensed tannins can include, but are not limited to Acacia mearnsii (e.g., wattle or mimosa bark extract), Schinopsis (e.g., quebracho wood extract), Tsuga (e.g., hemlock bark extract), Rhus (e.g., sumach extract), Juglans (e.g., walnut), Carya illinoinensis (e.g., pecan), and Pinus (e.g., Radiata pine, Maritime pine, bark extract species).

The condensed tannins include about 70 wt % to about 80 wt % active phenolic ingredients (the “tannin fraction”) and the remaining ingredients (the “non-tannin fraction”) can include, but are not limited to, carbohydrates, hydrocolloid gums, and amino and/or imino acid fractions. The condensed tannins can be used as recovered or extracted from the organic matter or the condensed tannins can be purified, e.g., to about 95 wt % or more active phenolic ingredients. Hydrolyzable tannins and condensed tannins can be extracted from the starting material, e.g., trees and/or shrubs, using well established processes. A more detailed discussion of tannins is discussed and described in the Handbook of Adhesive Technology, Second Edition, CRC Press, 2003, chapter 27, “Natural Phenolic Adhesives I: Tannin,” and in Monomers, Polymers and Composites from Renewable Resources, Elsevier, 2008, chapter 8, “Tannins: Major Sources, Properties and Applications.”

The condensed tannins can be classified or grouped into one of two main categories, namely, those containing a resorcinol unit and those containing a phloroglucinol unit. Illustrative tannins that include the resorcinol unit include, but are not limited to, black wattle tannins and quebracho tannins Illustrative tannins that include the phloroglucinol unit include, but are not limited to, pecan tannins and pine tannins.

Suitable aldehyde compounds can be represented by Formula III:

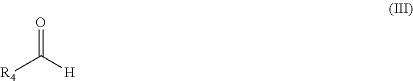

where R⁴ can be a hydrogen, an alkyl, an alkenyl, or alkynyl. The alkyl, alkenyl, or alkynyl can include from 1 to about 8 carbon atoms. In another example, suitable aldehyde compounds can also include the so-called masked aldehydes or aldehyde equivalents, such as acetals or hemiacetals. Illustrative aldehyde compounds can include, but are not limited to, formaldehyde, paraformaldehyde, acetaldehyde, propionaldehyde, butyraldehyde, furfuraldehyde, benzaldehyde, or any combination thereof. One or more other aldehydes, such as glyoxal can be used in place of or in combination with formaldehyde and/or other aldehydes. In at least one example, the aldehyde compound can include formaldehyde, UFC, or a combination thereof.

The aldehyde compounds can be used as a solid, liquid, and/or gas. Considering formaldehyde in particular, the formaldehyde can be or include paraform (solid, polymerized formaldehyde), formalin solutions (aqueous solutions of formaldehyde, sometimes with methanol, in 37 vol %, 44 vol %, or 50 vol % formaldehyde concentrations), urea-formaldehyde concentrate (“UFC”), and/or formaldehyde gas in lieu of or in addition to other forms of formaldehyde can also be used. In another example, the aldehyde can be or include a pre-reacted urea-formaldehyde mixture having a urea to formaldehyde weight ratio of about 1:2 to about 1:3.

The aldehyde compound can also be or include, but is not limited to, one or more multifunctional aldehyde compounds. As used herein, the terms “multifunctional aldehyde compound” and “multifunctional aldehyde” are used interchangeably and refer to compounds having at least two functional groups, with at least one of the functional groups being an aldehyde group. For example, the multifunctional aldehyde can include two or more aldehyde functional groups. In another example, the multifunctional aldehyde can include at least one aldehyde functional group and at least one functional group other than an aldehyde functional group. As used herein, the term “functional group” refers to reactive groups in the multifunctional aldehyde compound and can include, but is not limited to, aldehyde groups, carboxylic acid groups, ester groups, amide groups, imine groups, epoxide groups, aziridine groups, azetidinium groups, and hydroxyl groups.

The multifunctional aldehyde compound can include two or more carbon atoms and have two or more aldehyde functional groups. For example, the multifunctional aldehyde compound can include two, three, four, five, six, or more carbon atoms and have two or more aldehyde functional groups. The multifunctional aldehyde compound can include two or more carbon atoms and have at least one aldehyde functional group and at least one functional group other than an aldehyde group such as a carboxylic acid group, an ester group, an amide group, an imine groups, an epoxide group, an aziridine group, an azetidinium group, and/or a hydroxyl group. For example, the multifunctional aldehyde compound can include two, three, four, five, six, or more carbon atoms and have at least one aldehyde functional group and at least one functional group other than an aldehyde group such as a carboxylic acid group, an ester group, an amide group, an imine groups, an epoxide group, an aziridine group, an azetidinium group, and/or a hydroxyl group. It should be noted that a multi-functional aldehyde compound having an aldehyde group and a carboxylic acid group could be considered as the aldehyde compound or the carboxylic acid compound, but such a multi-functional aldehyde compound is not intended to satisfy both simultaneously. Said another way, the hydroxybenzene compound, the aldehyde compound, and the carboxylic acid, the anhydride, the homopolymer, and/or the copolymer refer to different compounds with respect to one another.

Suitable bifunctional or difunctional aldehydes that include three (3) or more carbon atoms and have two aldehyde functional groups (—CHO) can be represented by Formula IV:

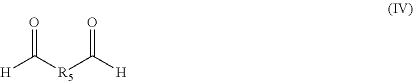

where R⁵ can be an alkenylene, an alkenylene, an alkynyl, a cycloalkenylene, a cycloalkenylene, a cycloalkynyl, or an arylene, having 1 carbon atom to about 12 carbon atoms. Illustrative multi-functional aldehydes can include, but are not limited to, malonaldehyde, succinaldehyde, glutaraldehyde, 2-hydroxyglutaraldehyde, β-methylglutaraldehyde, adipaldehyde, pimelaldehyde, suberaldehyde, malealdehyde, fumaraldehyde, sebacaldehyde, phthalaldehyde, isophthalaldehyde, terephthalaldehyde, ring-substituted aromatic aldehydes, or any combination thereof. A suitable bifunctional or difunctional aldehyde that includes two carbon atoms and has two aldehyde functional groups is glyoxal.

Illustrative multifunctional aldehyde compounds that include an aldehyde group and a functional group other than an aldehyde group can include, but are not limited to, glyoxylic acid, glyoxylic acid esters, glyoxylic acid amides, 5-(hydroxymethyl)furfural, or any combination thereof. The aldehyde group in the multifunctional aldehyde compound can exist in other forms, e.g., as a hydrate. As such, any form or derivative of a particular multifunctional aldehyde compound can be used to prepare the wet gels discussed and described herein. The aldehyde compound can include any combination of two or more aldehyde compounds combined with one another and/or added independent of one another to the reaction mixture.

The carboxylic acid can include, but is not limited to, monocarboxylic acids, dicarboxylic acids, tricarboxylic acids, tetracarboxylic acids, pentacarboxylic acids, carboxylic acids having more than five carboxyl groups, polymeric polycarboxylic acids, and any mixture thereof. The monocarboxylic acid can be represented by Formula V:

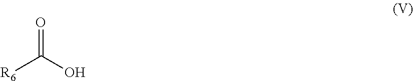

where R⁶ can be an alkyl, an alkenyl, or an alkynyl carbon chain having 1 carbon atom to about 50 carbon atoms. Illustrative monocarboxylic acids can include, but are not limited to, methanoic acid or formic acid, ethanoic acid or acetic acid, propanoic acid, butanoic acid, petanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, hexadecanoic acid, heptadecanoic acid, octadecanoic acid, icosanoic acid, acrylic acid, or any mixture thereof.

The dicarboxylic acid can be represented by Formula VI:

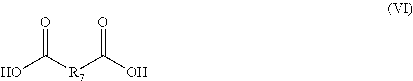

where R⁷ can be an alkylene, alkenylene, or alkynyl carbon chain having 1 carbon atom to about 50 carbon atoms.

The tricarboxylic acid can be represented by Formula VII

R₈(COOH)₃ (VII)

where R⁸ can be an alkylene, alkenylene, or an alkynyl carbon chain having 1 carbon atom to about 50 carbon atoms.

The dicarboxylic acids, tricarboxylic acids, tetracarboxylic acids, pentacarboxylic acids, and carboxylic acids having six or more carboxylic acid groups can be referred to collectively as “polycarboxylic acids.” Suitable polycarboxylic acids can include, but are not limited to, unsaturated aliphatic dicarboxylic acids, saturated aliphatic dicarboxylic acids, aromatic dicarboxylic acids, unsaturated cyclic dicarboxylic acids, saturated cyclic dicarboxylic acids, hydroxy-substituted derivatives thereof, and the like. Other suitable polycarboxylic acids can include unsaturated aliphatic tricarboxylic acids, saturated aliphatic tricarboxylic acids such as citric acid, aromatic tricarboxylic acids, unsaturated cyclic tricarboxylic acids, saturated cyclic tricarboxylic acids, hydroxy-substituted derivatives thereof, and the like. It is appreciated that any such polycarboxylic acids can be optionally substituted, such as with hydroxy, halo, alkyl, alkoxy, and the like.

Illustrative polycarboxylic acids can include, but are not limited to, citric acid, ethanedioic acid, propanedioic acid, butanedioic acid, petanedioic acid, hexanedioic acid, heptanedioic acid, octanedioic acid, nonanedioic acid, decanedioic acid, undecanedioic acid, dodecanedioic acid, or any mixture thereof. Other illustrative dicarboxylic acids can include, but are not limited to, (Z)-butenedioic acid or maleic acid, (E)-butenedioic acid or fumaric acid, pent-2-enedioic acid or glutaconic acid, dodec-2-enedioic acid or traumatic acid, (2E,4E)-hexa-2,4-dienedioic acid or muconic acid, citric acid, isocitric acid, aconitic acid, adipic acid, azelaic acid, butane tetracarboxylic acid dihydride, butane tricarboxylic acid, chlorendic acid, citraconic acid, dicyclopentadiene-maleic acid adducts, diethylenetriamine pentaacetic acid, adducts of dipentene and maleic acid, ethylenediamine tetraacetic acid (EDTA), fully maleated rosin, maleated tall-oil fatty acids, fumaric acid, glutaric acid, isophthalic acid, itaconic acid, maleated rosin oxidized with potassium peroxide to alcohol then carboxylic acid, maleic acid, malic acid, mesaconic acid, biphenol A or bisphenol F reacted via the KOLBE-Schmidt reaction with carbon dioxide to introduce 3-4 carboxyl groups, oxalic acid, phthalic acid, sebacic acid, succinic acid, tartaric acid, terephthalic acid, tetrabromophthalic acid, tetrachlorophthalic acid, tetrahydrophthalic acid, trimellitic acid, trimesic acid, and any mixture thereof.

Suitable polymeric polycarboxylic acids can include organic polymers or oligomers containing more than one pendant carboxy group. The polymeric polycarboxylic acid can be a homopolymer or copolymer prepared from unsaturated carboxylic acids that can include, but are not limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. The polymeric polycarboxylic acid can also be prepared from unsaturated anhydrides. Unsaturated anhydrides can include, but are not limited to, maleic anhydride, itaconic anhydride, acrylic anhydride, methacrylic anhydride, and the like, as well as mixtures thereof.

Preferred polymeric polycarboxylic acids can include polyacrylic acid, polymethacrylic acid, polymaleic acid, and the like. Examples of commercially available polyacrylic acids include AQUASET-529 (Rohm & Haas, Philadelphia, Pa., U.S.A.), CRITERION 2000 (Kemira, Helsinki, Finland, Europe), NF1 (H. B. Fuller, St. Paul, Minn., U.S.A.), and SOKALAN (BASF, Ludwigshafen, Germany, Europe). With respect to SOKALAN, this is believed to be a water-soluble polyacrylic copolymer of acrylic acid and maleic acid, having a molecular weight of approximately 4,000. AQUASET-529 is understood to be a composition containing polyacrylic acid cross-linked with glycerol, also containing sodium hypophosphite as a catalyst. CRITERION 2000 is thought to be an acidic solution of a partial salt of polyacrylic acid, having a molecular weight of approximately 2,000. NF1 is believed to be a copolymer containing carboxylic acid functionality and hydroxy functionality, as well as units with neither functionality; NF1 is also thought to contain chain transfer agents, such as sodium hypophosphite or organophosphate catalysts.

The anhydride can be represented by Formula VII:

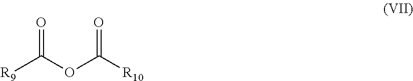

where R⁹ and R¹⁰ can independently be a substituted or unsubstituted linear, branched, cyclic, heterocyclic, or aromatic hydrocarbyl group. For example, R⁹ and R¹⁰ can independently be alkyl, alkenyl, alkynyl, phenyl, or aryl. In some examples, R⁹ and R¹⁰ can independently be an alkyl, an alkenyl, or an alkynyl carbon chain, having 1 carbon atom to about 50 carbon atoms. In one or more embodiments, R⁹ and R¹⁰ can be bonded together to form a cyclic structure. Illustrative anhydrides can include, but are not limited to, maleic anhydride, phthalic anhydride, acetic anhydride, succinic anhydride, styrene maleic anhydride, naphthalic anhydride, 1,2,4-benzenetricarboxylic anhydride, or any mixture thereof.

In addition to the carboxylic acid homopolymers, other suitable homopolymers can include, but are not limited to, polyethylene, polypropylene, polystyrene, polyvinylchloride, or any mixture thereof.

In addition to the carboxylic acid copolymers, other suitable copolymers can include, but are not limited to, alternating copolymers, periodic copolymers, statistical copolymers, terpolymers, block copolymers, linear copolymers, branched copolymers, or any mixture thereof. The alternating copolymer can be represented by the formula: ˜ABABABABABABABAB˜. Illustrative alternating copolymers can include, but are not limited to, poly[styrene-alt-(maleic anhydride)], poly[(ethylene glycol)-alt-(terephthalic acid; isophthalic acid)], or a mixture thereof. The periodic copolymer can be represented by the formula: ˜A-B-A-B-B-A-A-A-A-B-B-B˜. Illustrative periodic copolymers can include, but are not limited to, poly(1,3,6-trioxacyclooctane) poly(oxymethyleneoxyethyleneoxyethyl ene). The statistical copolymer can be represented by the formula: ˜ABBAAABAABBBABAABA˜. Illustrative statistical copolymers can include, but are not limited to, poly(styrene-stat-acrylonitrile-stat-butadiene), poly[(6-aminohexanoic acid)-stat-(7-aminoheptanoic acid)], poly[(4-hydroxybenzoic acid)-co-hydroquinone-co-(terephthalic acid)], poly[styrene-co-(methyl methacrylate)], or any mixture thereof. Illustrative terpolymers can include, but are not limited to, acrylonitrile-butadiene-styrene terpolymer, or any mixture thereof. The block copolymer can be represented by the formula: ˜AAAAA-BBBBBBB˜AAAAAAA˜BBB˜. Illustrative block copolymers can include, but are not limited to, polystyrene-block-polybutadiene-block-polystyrene, poly(ethylene glycol)-polypropylene glycol)-poly(ethylene glycol) block polymer (also known as PEG-PPG-PEG block polymer), poly[poly(methyl methacrylate)-block-polystyrene-block-poly(methyl acrylate)], or any mixture thereof. Illustrative linear copolymers can include, but are not limited to, a copolymer of ethylene and one or more C₃ to C₂₀ alpha olefin comonomers copolymers, or any mixture thereof. Illustrative branched copolymers can include, but are not limited to, branched methacrylate copolymers.

In one or more embodiments, the reaction mixture can further include one or more polyols. Suitable polyols can be represented by the following Formula IX:

R₁(OH)ₙ (IX)

where R¹¹ can be a substituted or unsubstituted alkylene, a substituted or unsubstituted alkenylene, a substituted or unsubstituted alkynylene, a substituted or unsubstituted cycloalkylene, a substituted or unsubstituted cycloalkenylene, a substituted or unsubstituted cycloalkynylene, a substituted or unsubstituted heterocycloalkylene, a substituted or unsubstituted heterocycloalkenylene, a substituted or unsubstituted heterocycloalkynylene, a substituted or unsubstituted arylene, or a substituted or unsubstituted heteroarylene; and n is an integer not less than 2. For example, n can be any integer of 2 to 10, 2 to 50, or 2 to 100.

Illustrative polyols can include, but are not limited to, 1,4-cyclohexanediol catechol, cyanuric acid, diethanolamine, pryogallol, butanediol, 1,6-hexane diol, 1,2,6-hexanetriol, 1,3 butanediol, 1,4-cyclohexane dimethanol, 2,2,4-trimethylpentanediol, alkoxylated bisphenol A, Bis[N, N di beta-hydroxyethyl)]adipamid, bisphenol A, bisphenol A diglycidyl ether, bisphenol F diglycidyl ether, cyclohexanedimethanol, dibromoneopentyl glycol, polyglycerol, diethylene glycol, dipropylene glycol, glycol ethers, ethoxylated DETA, ethylene glycol, glycerine, neopentyl glycol, pentaerythritol, low molecular weight (e.g., a weight average molecular weight of about 750 or less) polyethylene glycol and/or polypropylene glycol, propane 1,3-diol, propylene glycol, polyethylene oxide (hydroxy terminated), sorbitol, tartaric acid, tetrabromoalkoxylate bisphenol A, tetrabromobisphenol A, tetrabromobisphenol diethoxy ether, triethanolamine, triethylene glycol, trimethylolethane, ethyle diethanolamine, methyl diethanolamine, one or more carbohydrates, polyvinyl alcohols, hydroxyethylcellulose, resorcinol, pyrogallol, glycollated ureas, lignin, trimethylolpropane, tripropylene glycol, or any combination thereof. The one or more carbohydrates can include one or more monosaccharides, disaccharides, oligosaccharides, polysaccharides, or any combinations thereof.

One particular subclass of polyols can include carbohydrates. Suitable carbohydrates can include monosaccharides, disaccharides, oligosaccharides, polysaccharides, or any mixture thereof. The carbohydrate can include one or more aldose sugars. The monosaccharide can be or include D-glucose (dextrose monohydrate), L-glucose, or a combination thereof. Other carbohydrate aldose sugars can include, but are not limited to, glyceraldehyde, erythrose, threose, ribose, deoxyribose, arabinose, xylose, lyxose, allose, altrose, gulose, mannose, idose, galactose, talose, and any combination thereof. The carbohydrate can also be or include one or more reduced or modified starches such as dextrin, maltodextrin, and oxidized maltodextrins.

The reaction mixture can include about 0.1 wt %, about 1 wt %, about 5 wt %, about 10 wt %, or about 15 wt % to about 25 wt %, about 30 wt %, about 35 wt %, about 40 wt %, or about 45 wt % of the polyol, based on the combined weight of the hydroxybenzene compound, the aldehyde compound, the additive, and the polyol. For example, the reaction mixture can include about 0.5 wt % to about 15 wt %, about 5 wt % to about 20 wt %, about 10 wt % to about 30 wt %, about 3 wt % to about 12 wt %, about 8 wt % to about 28 wt %, about 23 wt % to about 35 wt %, about 4 wt % to about 12 wt %, or about 1 wt % to about 20 wt % of the polyol, based on the combined weight of the hydroxybenzene compound, the aldehyde compound, the additive, and the polyol. In another example, the reaction mixture can include at least 0.1 wt %, at least 0.5 wt %, at least 1 wt %, at least 2 wt %, at least 3 wt %, at least 4 wt %, at least 5 wt %, at least 7 wt %, or at least 10 wt % to about 15 wt %, about 20 wt %, about 25 wt %, about 30 wt %, about 35 wt %, or about 40 wt % of the polyol, based on the combined weight of the hydroxybenzene compound, the aldehyde compound, the additive, and the polyol.

The solids content of the reaction mixture and/or the prepolymer can vary of about 5%, about 10%, about 15%, about 20%, about 25%, about 35%, about 40%, or about 45% to about 55%, about 60%, about 65%, about 70%, about 75%, about 80%, about 85%, about 90%, about 95%, or about 99%. For example, the solids content of the reaction mixture and/or the prepolymer can be about 35% to about 70%, about 40% to about 60%, or about 45% to about 55%. In another example, the solids content of the reaction mixture and/or the prepolymer can be greater than 20%, greater than 25%, greater than 30%, greater than 35%, greater than 40%, or great than 45%, great than 50%, great than 55%, great than 60%, great than 65%, great than 70%, great than 75%, great than 80%, great than 85%, or great than 90%. In another example, the solids content of the reaction mixture and/or the prepolymer can be less than 90%, less than 85%, less than 80%, less than 75%, less than 70%, less than 65%, less than 60%, less than 55%, less than 50%, less than 45%, less than 40%, less than 35%, less than 30%, less than 25%, less than 20%, or less than 15%.

The solids content of a composition, can be measured by determining the weight loss upon heating a small sample (e.g., about 1 g to about 5 g) of the composition, to a suitable temperature (e.g., about 125° C.) and a time sufficient to remove the liquid. By measuring the weight of the sample before and after heating, the percent solids in the composition can be directly calculated or otherwise estimated.

The catalyst can be combined with the reaction mixture to accelerate the formation of the prepolymer and/or the wet gel. The catalyst can be or include one or more acids, one or more bases, or any mixture thereof. Illustrative acid catalysts can include, but is not limited to, hydrochloric acid, sulfuric acid, phosphoric acid, phosphorous acid, sulfonic acid (including but not limited to monosulfonic acid, disulfonic acid, trisulfonic acid, toluene sulfonic acid, and alkane sulfonic acid), gallic acid, oxalic acid, picric acid, or any combination thereof. Other suitable acid catalyst can include one or more of the carboxylic acids discussed and described above. For example, the acidic catalyst can be or include acetic acid, citric acid, or a mixture thereof. It should be noted that the catalyst, if present, may or may not react with one or more components of the reaction mixture.

Illustrative base catalysts can include, but are not limited to, hydroxides, carbonates, ammonia, amines, or any combination thereof. Illustrative hydroxides can include, but are not limited to, sodium hydroxide, potassium hydroxide, ammonium hydroxide (e.g., aqueous ammonia), lithium hydroxide, cesium hydroxide, aqueous solutions thereof, any combination thereof, or any mixture thereof. Illustrative carbonates can include, but are not limited to, sodium carbonate, potassium carbonate, ammonium carbonate, aqueous solutions thereof, any combination thereof, or any mixture thereof. Illustrative amines can include, but are not limited to, alkanolamines, polyamines, aromatic amines, and any combination thereof. Illustrative alkanolamines can include, but are not limited to, monoethanolamine (MEA), diethanolamine (DEA), triethanolamine (TEA), or any combination thereof. Illustrated alkanolamines can include diethanolamine, triethanolamine, 2-(2-aminoethoxyl)ethanol, aminoethyl ethanolamine, aminobutanol and other aminoalkanols. Illustrative aromatic amines can include, but are not limited to, benzyl amine, aniline, ortho-toludine, meta-toludine, para-toludine, n-methyl aniline, N—N′-dimethyl aniline, diphenyl and triphenyl amines, 1-naphthylamine, 2-naphthylamine, 4-aminophenol, 3-aminophenol and 2-aminophenol. Illustrative polyamines can include, but are not limited to, diethylenetriamine (DETA), triethylenetetramine (TETA), tetraethylenepentamine (TEPA). Other polyamines can include, for example, 1,3-propanediamine, 1,4-butanediamine, polyamidoamines, and polyethylenimines.

Other suitable amines can include, but are not limited to, primary amines (“NH₂R₁”), secondary amines (“NHR₁R₂”), and tertiary amines (“NR₁R₂R₃”), where each R₁, R₂, and R₃ can independently be alkyls, cycloalkyls, heterocycloalkyls, aryls, heteroaryls, and substituted aryls. The alkyls can include branched or unbranched alkyls having 1 carbon atom to about 15 carbon atoms or 1 carbon atom to about 8 carbon atoms. Illustrative alkyls can include, but are not limited to, methyl, ethyl, n-propyl, isopropyl, n-butyl, sec butyl, t-butyl, n-pentyl, n-hexyl, and ethylhexyl, isomers thereof, or any mixture thereof. The cycloalkyls can include 3 carbon atoms to about 7 carbon atoms. Illustrative cycloalkyls can include, but are not limited to, cyclopentyl, substituted cyclopentyl, cyclohexyl, and substituted cyclohexyl. The term “aryl” refers to an aromatic substituent containing a single aromatic ring or multiple aromatic rings that are fused together, linked covalently, or linked to a common group such as a methylene or ethylene moiety. Some specific examples of aryl groups can include one aromatic ring or two or three fused or linked aromatic rings, e.g., phenyl, naphthyl, biphenyl, anthracenyl, phenanthrenyl, isomers thereof, substituted aromatics thereof, and the like. The aryl substituents can include 1 carbon atom to about 20 carbon atoms. The term “heteroatom-containing,” as in a “heteroatom-containing cycloalkyl group,” refers to a molecule or molecular fragment in which one or more carbon atoms is replaced with an atom other than carbon, e.g., nitrogen, oxygen, sulfur, phosphorus, or boron. Similarly, the term “heteroaryl” refers to an aryl substituent that is heteroatom-containing. The term “substituted,” as in “substituted aryls,” refers to a molecule or molecular fragment in which at least one hydrogen atom bound to a carbon atom is replaced with one or more substituents that are functional groups such as hydroxyl, alkoxy, alkylthio, phosphino, amino, halo, silyl, and the like. Illustrative primary amines can include, but are not limited to, methylamine and ethylamine. Illustrative secondary amines can include, but are not limited to, dimethylamine and diethylamine. Illustrative tertiary amines can include, but are not limited to, trimethylamine, triethylamine, triethanolamine, or any combination thereof. Illustrative amides can include, but are not limited to, acetamide, ethanamide, dicyandiamide, and the like, or any combination thereof.

In at least one example, the catalyst can be free or substantially free from any metal or metal ions. In other words, the catalyst can be a non-metal or non-metal ion containing catalyst. A catalyst that is substantially free from any metal or metal ions can contain less than 1 wt %, less than 0.5 wt %, less than 0.3 wt %, less than 0.2 wt %, less than 0.1 wt %, less than 0.7 wt %, less than 0.05 wt %, less than 0.3 wt %, less than 0.01 wt %, less than 0.007 wt %, less than 0.005 wt %, less than 0.003 wt %, less than 0.001 wt %, less than 0.0007 wt %, or less than 0.0005 wt %, based on the total weight of the catalyst.

The catalyst can be present in the reaction mixture in widely varying amounts. For example, the reaction mixture can include the catalyst in an amount of about 0.01 wt %, about 0.05 wt %, about 0.1 wt %, about 0.5 wt %, about 1 wt %, or about 1.5 wt % to about 30 wt %, about 40 wt %, about 50 wt %, or about 60 wt %, based on the combined weight of the hydroxybenzene compound, the aldehyde compound, the solvent, the catalyst, and the additive. In another example, the reaction mixture can include the catalyst in an amount of about 0.01 wt %, about 0.02 wt %, about 0.03 wt %, about 0.04 wt %, about 0.05 wt %, about 0.1 wt %, about 0.5 wt %, about 1 wt %, about 3 wt %, or about 5 wt % to about 45 wt %, about 55 wt %, about 65 wt %, about 70 wt %, about 75 wt %, or about 80 wt %, based on the weight of the hydroxybenzene compound. In another example, the reaction mixture can include the catalyst in an amount of about 0.01 wt %, about 0.02 wt %, about 0.03 wt %, or about 0.04 wt % to about 40 wt %, about 50 wt %, about 60 wt %, about 70 wt %, or about 80 wt %, based on the weight of the aldehyde compound. In another example, the reaction mixture can include the catalyst in an amount of about 0.01 wt %, about 0.02 wt %, about 0.03 wt %, or about 0.04 wt % to about 40 wt %, about 50 wt %, about 60 wt %, or about 70 wt %, based on the combined weight of the hydroxybenzene compound and the aldehyde compound.

If any one or more of the components discussed and described herein include two or more different compounds, those two or more different compounds can be present in any ratio with respect to one another. For example, if the hydroxybenzene includes a first hydroxybenzene compound and a second hydroxybenzene compound, the hydroxybenzene compound can have a concentration of the first hydroxybenzene compound of about 0.1 wt % to about 99.9 wt % and conversely about 99.9 wt % to about 0.1 wt % of the second hydroxybenzene compound, based on the total weight of the first and second hydroxybenzene compounds. In another example, the amount of the first hydroxybenzene compound can be about 5 wt %, about 10 wt %, about 15 wt %, about 20 wt %, about 25 wt % about 30 wt %, about 35 wt %, about 40 wt %, or about 45 wt % to about 60 wt %, about 65 wt %, about 70 wt %, about 75 wt %, about 80 wt %, about 85 wt %, about 90 wt %, or about 95 wt %, based on the total weight of the first and second hydroxybenzene compounds. When the aldehyde compound, carboxylic acid, anhydride, homopolymer, copolymer, catalyst, solvent, and/or any other component includes two or more different compounds, those two or more different compounds can be present in similar amounts as the first and second hydroxybenzene compound.

If the wet gel is in the form of a monolithic structure, the monolithic structure can have any desired shape. Typically, the monolithic structure can take the form or shape of the reaction vessel the wet gel is produced or made in. For example, if the reaction vessel has an inner cylindrical surface having a diameter of about 25 cm, the monolithic wet gel made in the reaction vessel can be in the form of a cylinder having a diameter of about 25 cm and a height corresponding to or dependent on the amount of reactants added to the reaction vessel.

If the wet gel is in the form of a monolithic structure the monolithic structure can be converted into particles. For example, the monolithic structure can be ground, chopped, crushed, milled, or otherwise acted upon to provide a plurality of particulates or particles. Accordingly, the wet gel can be produced as a monolithic structure in the reaction vessel and dried as is or particulated prior to drying or the wet gel can be directly produced as wet gel particles.

The wet gel particles can have an average cross-sectional length of about 0.1 μm, about 1 μm, about 100 μm, about 0.5 mm, about 1 mm, about 1.5 mm, about 2 mm, about 2.5 mm, about 3 mm, about 3.5 mm, about 4 mm, about 4.5 mm, about 5 mm, about 5.5 mm, about 6 mm or greater. For example, the wet gel particles can have an average cross-sectional length of about 0.001 mm, about 0.01 mm, about 0.1 mm, about 0.5 mm, about 1 mm, about 1.5 mm, about 2 mm, about 2.5 mm, about 3 mm, about 3.5 mm, or about 4 mm to about 5 mm, about 7 mm, about 10 mm, about 12 mm, about 15 mm, about 18 mm, about 20 mm, about 25 mm, about 30 mm or greater. In another example, the wet gel particles can have an average cross-sectional length of about 1 μm, about 10 μm, about 50 μm, about 100 μm, about 200 μm, about 300 μm, about 500 μm, about 700 μm, or about 1,000 μm to about 1.1 mm, about 1.3 mm, about 1.5 mm, about 2 mm, about 3 mm, about 4 mm, about 5 mm, about 7 mm, about 10 mm, or greater.

It has been surprisingly and unexpectedly discovered that reacting at least the hydroxybenzene compound and the aldehyde compound with and/or in the presence of the carboxylic acid, the anhydride, the homopolymer, and/or the copolymer can produce a wet gel that can be converted to a dried gel product under a vacuum, at atmospheric pressure, or at a pressure that is less than the supercritical pressure of any solvent present in the wet gel to produce a dried gel product having one or more improved properties as compared to a wet gel made without the carboxylic acid, the anhydride, the homopolymer, and/or the copolymer. The one or more improved properties can include, but are not limited to, an increased pore volume, an increased average pore size, an increased specific surface area, decreased density, or any combination thereof.

As used herein, the term “dried gel” refers to a network of polymer chains having one or more pores or voids therein and a gas occupying or filling the one or more pores or voids. The gas can be or include, but is not limited to, oxygen, nitrogen, argon, helium, carbon monoxide, carbon dioxide, or any mixture thereof. In at least one specific example, the gas occupying or filling the voids can be or include air. Similar to the activated carbon products, the dried gels or dried gel products can be in various forms such as a film, monolith, particles, powders, flakes, rods, composites, nonporous, porous, nanoporous, and the like.

The wet gel can be dried at a pressure less than the critical pressure of the liquid within the pores or voids of the wet gel. For example, if the wet gel includes water within the pores or voids thereof the pressure of the wet gel during drying can remain below the critical pressure of water. The wet gel, regardless of the particular liquid within the pores or voids of the wet gel can be subjected to a pressure that remains below the critical pressure (about 7.38 MPa) of carbon dioxide during drying. The wet gel can be dried at a pressure less than 5,000 kPa, less than 4,000 kPa, less than 3,000 kPa, less than 2,000 kPa, less than 1,000 kPa, less than 900 kPa, less than 800 kPa, less than 700 kPa, less than 600 kPa, less than 500 kPa, less than 400 kPa, less than 300 kPa, less than 200 kPa, less than 150 kPa, less than 125 kPa, or less than 100 kPa. In at least one example, the wet gel can be dried at atmospheric pressure. In at least one other example, the wet gel can be dried at a pressure less than atmospheric pressure.

The wet gel can be dried by heating the wet gel to an elevated temperature of about 5° C., about 10° C., about 15° C., about 20° C., or about 25° C., to about 80° C., about 90° C., about 100° C., about 150° C., about 200° C., or about 300° C. For example, the wet gel can be heated to a temperature of about 5° C. to about 300° C., about 10° C. to about 200° C., about 15° C. to about 150° C., or about 25° C. to about 100° C. to produce the dried gel product. In another example, the wet gel can be heated to a temperature greater than 25° C. and less than 300° C., less than 250° C., less than 200° C., less than 150° C., less than 100° C., or less than 50° C. to produce the dried gel product. In another example, the wet gel can be heated to a temperature of about 5° C. to about 300° C. while at atmospheric pressure or a pressure of less than 250 kPa, less than 200 kPa, less than 150 kPa, or less than 125 kPa to produce the dried gel product.

When heating the wet gel to produce the dried gel product, the wet gel can be heated to the elevated temperature at a rate of about 0.01° C./min, about 0.5° C./min, about 1° C./min, or about 2° C./min, to about 10° C./min, about 15° C./min, about 25° C./min, or about 50° C./min. For example, the wet gel can be heated to the elevated temperature at a rate of about 0.5° C./min to about 50° C./min, about 1° C./min to about 25° C./min, about 2° C./min to about 15° C./min, or about 3° C./min to about 10° C./min. In another example, the wet gel can be placed directly into a furnace or other heating device providing an environment already at the elevated temperature. As such, the temperature of the wet gel can be increased at a near infinite heating rate. Accordingly, the temperature of the wet gel can be increased at any desired rate.

The wet gel can be heated at the elevated temperature for a time period of about 0.01 hr, about 0.5 hr, about 1 hr, about 2 hr, or about 3 hr to about 24 hr, about 48 hr, about 72 hr, about 144 hr, about 288 hr, or longer to produce the dried gel product. For example, the wet gel can be heated to the elevated temperature for a time period of about 0.5 hr to about 72 hr, about 1 hr to about 48 hr, about 2 hr to about 24 hr, about 3 hr to about 12 hr, or about 4 hr to about 6 hr to produce the dried gel product. In another example, the wet gel can be heated to the elevated temperature for a time period of about 1 hr to less than 288 hr, less than 144 hr, less than 72 hr, or less than 48 hr to produce the dried gel product. In another example, the wet gel can be heated to the elevated temperature for a time period of at least 0.01 hr, at least 0.5 hr, at least 1 hr, at least 2 hr, or at least 3 hr and less than 288 hr to produce the dried gel product.

The wet gel can be heated in any desired atmosphere. For example, the wet gel can be heated in an inert gas atmosphere, such as an atmosphere containing one or more inert gases. Illustrative inert gases can include, but are not limited to, nitrogen, argon, helium, neon, or any mixture thereof. In another example, the wet gel can be heated in air, oxygen-rich air (greater than 21 vol % of oxygen), or oxygen-lean air (21 vol % or less of oxygen). Other suitable gases can include, but are not limited to, carbon dioxide, methane, or a mixture thereof.

The process used to dry the wet gel can be free of any solvent exchange. Said another way, the liquid within the pores or voids of the wet gel can be removed without first replacing the liquid with a different liquid. One conventional drying process can include replacing water within the pores or voids of a wet gel with an organic solvent, e.g., acetone, than water. The wet gels discussed and described herein can be dried without undergoing any exchange of liquid, which is often referred to as “solvent exchange.”

The dried gel product can have a pore volume of about 0.03 cm³/g, about 0.05 cm³/g, about 0.1 cm³/g, about 0.3 cm³/g, or about 0.5 cm³/g to about 1 cm³/g, about 1.5 cm³/g, about 2 cm³/g, or about 2.5 cm³/g. For example, the dried gel product can have a pore volume of at least 0.1 cm³/g, at least 0.2 cm³/g, at least 0.25 cm³/g, at least 0.3 cm³/g, at least 0.35 cm³/g, at least 0.4 cm³/g, at least 0.45 cm³/g, at least 0.5 cm³/g, at least 0.55 cm³/g, 0.6 cm³/g, at least 0.65 cm³/g, at least 0.7 cm³/g, at least 0.75 cm³/g, or at least 0.8 cm³/g to about 0.9 cm³/g, about 0.95 cm³/g, about 1 cm³/g, about 1.05 cm³/g, about 1.1 cm³/g, about 1.15 cm³/g, about 1.2 cm³/g, about 1.25 cm³/g, about 1.3 cm³/g, about 1.35 cm³/g, about 1.4 cm³/g, about 1.45 cm³/g, about 1.5 cm³/g, about 1.6 cm³/g, about 1.7 cm³/g, about 1.8 cm³/g, about 1.9 cm³/g, about 2 cm³/g, about 2.1 cm³/g, about 2.2 cm³/g, about 2.3 cm³/g, about 2.4 cm³/g, or about 2.5 cm³/g. In another example, the dried gel product can have a pore volume of about 0.2 cm³/g to about 2 cm³/g, about 0.4 cm³/g to about 1.8 cm³/g, about 0.6 cm³/g to about 1.4 cm³/g, about 1 cm³/g to about 1.9 cm³/g, or about 0.3 cm³/g to about 1.7 cm³/g. The pore volume of the dried gel product activation can be measured using the nitrogen sorption technique as commonly known in the art.

The dried gel product can have an average pore size of about 0.5 nm, about 1 nm, about 1.5 nm, about 2 nm, about 5 nm, about 10 nm, about 15 nm, about 20 nm, about 25 nm, about 30 nm, about 25 nm, about 40 nm, about 45 nm, about 50 nm, about 51 nm, about 52 nm, about 53 nm, about 54 nm, or about 55 nm to about 80 nm, about 90 nm, about 100 nm, about 110 nm, about 120 nm, about 130 nm, about 140 nm, about 150 nm, about 200 nm, about 250 nm, about 300 nm, about 350 nm, about 400 nm, about 450 nm, or about 500 nm. For example, the dried gel product can have an average pore size of at least 10 nm, at least 20 nm, at least 30 nm, at least 40 nm, at least 50 nm, at least 55 nm, or at least 60 nm to about 80 nm, about 90 nm, about 100 nm, about 110 nm, about 120 nm, about 130 nm, about 140 nm, about 150 nm, about 200 nm, about 250 nm, about 300 nm, about 350 nm, about 400 nm, about 450 nm, or about 500 nm. In another example, the dried gel product can have an average pore size of about 1.5 nm to about 150 nm, about 10 nm to about 80 nm, about 30 nm to about 90 nm, about 80 nm to about 100 nm. The average pore size of the dried gel product can be measured according to the Barret-Joyner-Halenda or “BJH” technique (described in E. P. Barret, L. G. Joyner, and P. P. Halenda, J. Amer. Chem. Soc., 73, 373 (1951)). The average pore size of the dried gel product can also be measured according to the density functional theory or “DFT” technique (described in Advances in Colloid and Interface Science, Volumes 76-77, July 1998, pp. 203-226, by P. I. Ravikovitch, G. L. Haller, and A. V. Neimark and C. Lastoski, K. E. Gubbins, and N. Quirke, J. Phys. Chem., 1993, 97 (18), pp. 4786-4796). The average pore size referred to herein, unless otherwise noted, is the peak of the pore size distribution curve.

The dried gel product can have a specific surface area of about 5 m²/g, about 10 m²/g, about 25 m²/g, about 50 m²/g, about 100 m²/g, about 200 m²/g, about 300 m²/g, about 400 m²/g, about 500 m²/g, or about 600 m²/g to about 700 m²/g, about 800 m²/g, about 900 m²/g, about 1,000 m²/g, about 1,100 m²/g, about 1,200 m²/g, about 1,300 m²/g, about 1,400 m²/g, or about 1,500 m²/g. For example, the dried gel product can have a specific surface area of at least 5 m²/g, at least 20 m²/g, at least 30 m²/g, at least 40 m²/g, or at least 50 m²/g to about 100 m²/g, about 400 m²/g, about 700 m²/g, or about 1,000 m²/g. In another example, the dried gel product can have a specific surface area of about 20 m²/g to about 700 m²/g, about 20 m²/g to about 400 m²/g, about 40 m²/g to about 90 m²/g, about 50 m²/g to about 100 m²/g, or about 60 m²/g to about 400 m²/g. The specific surface area of the dried gel product refers to the total specific surface area of the dried gel product measured according to the Brunauer-Emmett-Teller or “BET” technique (described in S. Brunauer, P. H. Emmett, and E. Teller, J. Amer. Chem. Soc., 60, 309 (1938)). The BET technique employs an inert gas, for example nitrogen, to measure the amount of gas adsorbed on a material and is commonly used in the art to determine the accessible surface area of materials.

The dried gel product can have an average pore size of about 10 nm to about 100 nm and a pore volume of about 0.2 cm³/g to about 2 cm³/g. For example, the dried gel product can have an average pore size of about 60 nm to about 120 nm, about 10 nm to about 80 nm, or about 80 nm to about 100 nm and a pore volume of about 0.3 cm³/g to about 1.8 cm³/g, about 0.2 cm³/g to about 2 cm³/g, or about 0.25 cm³/g to about 1.5 cm³/g. In another example, the dried gel product can have pore size of at least 10 nm, at least 30 nm, at least 50 nm, or at least 60 nm to about 80 nm, about 100 nm, about 125 nm, or about 150 nm and a pore volume of at least 0.4 cm³/g, at least 0.5 cm³/g, at least 0.6 cm³/g, or at least 0.7 cm³/g to about 1 cm³/g, about 1.2 cm³/g, about 1.5 cm³/g, about 1.8 cm³/g, or about 2 cm³/g.

The dried gel product can have an average pore size of about 10 nm to about 100 nm and a specific surface area of about 5 m²/g to about 1,500 m²/g. For example, the dried gel product can have an average pore size of about 60 nm to about 120 nm, about 10 nm to about 80 nm, or about 80 nm to about 100 nm and a specific surface area of about 20 m²/g to about 600 m²/g, about 20 m²/g to about 400 m²/g, or about 60 m²/g to about 450 m²/g. In another example, the dried gel product can have pore size of at least 10 nm, at least 30 nm, at least 50 nm, or at least 60 nm to about 80 nm, about 100 nm, about 125 nm, or about 150 nm and a specific surface area of at least 5 m²/g, at least 10 m²/g, at least 15 m²/g, at least 20 m²/g, at least 40 m²/g, or at least 50, or at least 60 m²/g to about 350 m²/g, about 400 m²/g, about 500 m²/g, about 600 m²/g, about 700 m²/g, or about 1,000 m²/g.

The dried gel product can have a specific surface area of about 5 m²/g to about 1,500 m²/g and a pore volume of about 0.2 cm³/g to about 2 cm³/g. For example, the dried gel product can have a specific surface area of about 20 m²/g to about 600 m²/g, about 20 m²/g to about 400 m²/g, or about 60 m²/g to about 450 m²/g and a pore volume of about 0.3 cm³/g to about 1.8 cm³/g, about 0.2 cm³/g to about 2 cm³/g, or about 0.25 cm³/g to about 1.5 cm³/g. In another example, the dried gel product can have a specific surface area of at least 5 m²/g, at least 20 m²/g, at least 40 m²/g, or at least 50 m²/g, or at least 60 m²/g to about 100 m²/g, about 400 m²/g, about 500 m²/g, about 600 m²/g, about 700 m²/g, or about 1,000 m²/g and a pore volume of at least 0.4 cm³/g, at least 0.5 cm³/g, at least 0.6 cm³/g, or at least 0.7 cm³/g to about 1 cm³/g, about 1.2 cm³/g, about 1.5 cm³/g, about 1.8 cm³/g, or about 2 cm³/g.

The dried gel product can have an average pore size of about 10 nm to about 100 nm, a specific surface area of about 5 m²/g to about 1,500 m²/g, and a pore volume of about 0.2 cm³/g to about 2 cm³/g. For example, the dried gel product can have an average pore size of about 60 nm to about 120 nm, about 10 nm to about 80 nm, or about 80 nm to about 100 nm, a specific surface area of about 20 m²/g to about 600 m²/g, about 20 m²/g to about 400 m²/g, or about 60 m²/g to about 450 m²/g and a pore volume of about 0.3 cm³/g to about 1.8 cm³/g, about 0.2 cm³/g to about 2 cm³/g, or about 0.25 cm³/g to about 1.5 cm³/g. In another example, the dried gel product can have pore size of at least 10 nm, at least 30 nm, at least 50 nm, or at least 60 nm to about 80 nm, about 100 nm, about 125 nm, or about 150 nm, a specific surface area of at least 5 m²/g, at least 20 m²/g, at least 40 m²/g, or at least 50 m²/g, or at least 60 m²/g to about 100 m²/g, about 400 m²/g, about 500 m²/g, about 600 m²/g, about 700 m²/g, or about 1,000 m²/g, and a pore volume of at least 0.4 cm³/g, at least 0.5 cm³/g, at least 0.6 cm³/g, or at least 0.7 cm³/g to about 1 cm³/g, about 1.2 cm³/g, about 1.5 cm³/g, about 1.8 cm³/g, or about 2 cm³/g.

The dried gel product can be used as is or the dried gel product can be subjected to a carbonization or pyrolysis process to remove at least a portion of the non-carbon components, e.g., hydrogen, oxygen, nitrogen, and other non-carbon atoms, from the dried particles. The resulting carbonized or pyrolized product contains carbon. Any pyrolysis process can be used. In one example, the dried gel product can be placed into a rotary kiln and heated therein. The pyrolysis process can be carried out under an inert atmospheres, e.g., a nitrogen, argon, or other inert gas or gas mixture. Pyrolysis processes are well known to those of skill in the art. Suitable pyrolysis processes can include those discussed and described in U.S. Pat. Nos. 4,873,218; 4,997,804; 5,124,364; and 5,556,892. Similar to the activated carbon products, the pyrolized products can be in various forms such as a film, monolith, particles, powders, flakes, rods, composites, nonporous, porous, nanoporous, and the like.

The duration of the pyrolysis, e.g., the time period during which the dried gel product is maintained at the elevated temperature can be about 30 sec, about 1 min, about 5 min, about 10 min, about 20 min, or about 30 min to about 1 hr, about 2 hr, about 3 hr, about 5 hr, about 7 hr, about 20 hr, or longer. The dried gel product can by pyrolized by heating the dried gel product to a temperature of about 500° C., about 600° C., about 700° C., about 800° C., about 900° C., or about 1,000° C. to about 1,500° C., about 1,700° C., about 1,900° C., about 2,100° C., about 2,300° C. or about 2,400° C. For example, the pyrolysis dwell temperature can be about 500° C. to about 2,400° C., about 600° C. to about 1,800° C., about 600° C. to about 1,200° C., or about 650° C. to about 1,100° C.

It should be noted that if a pyrolized product is desired, the wet gel can be heated directly to the pyrolysis temperature. For example, a wet gel can be placed into a furnace, oven, or other heating device and can be heated from room temperature to a pyrolysis temperature of about 500° C. to about 2,400° C. for the desired time to produce the pyrolized product. The temperature ramp rate can be the same or similar to the temperature ramp rate used to produce the dried gel product including direct placement of the wet gel into a furnace or other environment already heated to the elevated temperature.

The pyrolized product can be activated. The activating agent, activation time, and/or activation temperature can affect the performance of the resulting activated carbon material, as well as the manufacturing cost thereof. For example, increasing the activation temperature and the activation dwell time can yield higher activation percentage of the pyrolized product, but can also correspond to the removal of more material compared to lower temperatures and shorter dwell times. As such, higher activation can increase performance of the final activated carbon, but it can also increase the cost of the process by reducing the overall carbonized product.

In one or more embodiments, the method can further include combining one or more activating agents with one or more wet gel products, one or more monolithic structures, one or more dried gels or dried gel products, or one or more pyrolized products, which can include one or more pyrolized particles, one or more carbon products, and/or one or more pyrolized carbon products. The activating agent can react with the pyrolized product to produce the activated carbon product. In one embodiment, the method can include activating the pyrolized product to produce the activated carbon product. The activation can include heating the pyrolized product to a specified temperature for a specified time in an atmosphere containing at least one or more activating agents. Illustrative activating agents can include carbon dioxide, steam, oxygen, ozone, or mixtures thereof.

The activation process can be about 1 min to about 2 days, about 5 min to about 1 day, about 1 min to about 18 hr, about 1 min to about 12 hr, about 5 min to about 8 hr, about 1 min to about 10 min, or about 1 hr to about 5 hr. In some examples, the atmosphere containing the activating agent can be maintained at a pressure of about 10 kPa to about 1,000 kPa, about 50 kPa to about 200 kPa, about 75 kPa to about 150 kPa, about 90 kPa to about 110 kPa, or about 101 kPa. For example, the atmosphere containing the activating agent can exert a pressure on the pyrolized carbon product at or below atmospheric pressure. In some examples, activation process can be at a temperature of about 500° C. to about 1,500° C. or about 700° C. to about 1,200° C. For example, the pyrolized product can be heated to a temperature of about 700° C. to about 1,200° C. for about 0.5 hr to about 48 hr.

In one example of an activation process, the pyrolized particles can be weighed and placed in a rotary kiln and an automated gas control manifold and controller can be set to ramp rate of about 20° C. per min. Carbon dioxide can be introduced to the kiln environment for a time period once the proper activation temperature has been reached. After activation has occurred, the carbon dioxide can be replaced by nitrogen and the kiln can be cooled down. The recovered activated particles can be weighed at the end of the process to assess the level of activation. Other activation processes are well known to those of skill in the art. The activation temperature can be about 700° C., about 800° C., about 850° C., or about 900° C. to about 1,100° C., about 1,200° C., about 1,300° C., or about 1,500° C. For example, the activation temperature can be about 800° C. to about 1,300° C., about 900° C. to about 1,050° C., or about 900° C. to about 1,000° C. or about 950° C. to about 1,050° C. or about 975° C. to about 1,025° C.

In some examples, the pyrolized product can be heated to a temperature of about 500° C. to about 1,500° C. or about 700° C. to about 1,200° C. for about 0.5 hr to about 48 hr in an atmosphere containing carbon dioxide. The atmosphere containing the activating agent can be maintained at a pressure of about 50 kPa to about 200 kPa. For example, the atmosphere containing the activating agent can exert a pressure on the pyrolized product at or below atmospheric pressure.

In other embodiments, the pyrolized product can be activated by heating the pyrolized product and at least one activating agent in an atmosphere containing at least one or more inert gases to produce an activated carbon mixture that contains the activated product. In one embodiment, the pyrolized product and at least one activating agent can be combined to produce an activation mixture that can be optionally dried to produce a dried activation mixture. The activation mixture or the dried activation mixture can be heated to a temperature of about 500° C. to about 1,500° C. in an atmosphere containing at least one or more inert gases to produce the activated carbon mixture. In one example, during activation of the pyrolized product to produce the activated carbon product, the method can also include treating the activation mixture and/or the activated carbon mixture with an acidic solution to produce a treated activation mixture and/or treated activated carbon mixture. The treated activation mixture and/or the treated activated carbon mixture can be rinsed with a rinsing liquid, e.g., rinse with water, alcohol (e.g., methanol), water and alcohol mixture, organic solvent, or mixtures thereof to produce a rinsed activation carbon mixture and/or rinsed activated carbon mixture. The rinsed activation carbon mixture and/or the rinsed activated carbon mixture can be dried to produce the activated carbon product.

Illustrative activating agent can include one or more hydroxides, one or more carbonates, one or more metal halides, one or more phosphorous-containing acids, one or more sulfur-containing acids, salts thereof, or any mixture thereof. In some examples, the activating agent can include an alkali metal hydroxide, an alkaline earth hydroxide, an alkali metal carbonate, an alkaline earth carbonate, carbonic acid, sulfuric acid, phosphoric acid, an alkali metal phosphate, an alkaline earth phosphate, phosphorous acid, an alkali metal phosphite, an alkaline earth phosphite, hypophosphorous acid, an alkali metal hypophosphite, an alkaline earth hypophosphite, a calcium halide, a zinc halide, salts thereof, acids thereof, or any mixture thereof. In some specific examples, the activating agent can include phosphoric acid, potassium carbonate, potassium hydroxide, calcium chloride, zinc chloride, salts thereof, acids thereof, or any mixture thereof.

In one or more embodiments, a combination or mixture of the pyrolized product and the activating agent can have a weight ratio (e.g., pyrolized product to activating agent weight ratio) of the pyrolized product to the activating agent of about 1 to about 1 (about 1:1) or about 1 to about 2 (about 1:2). In some embodiments, the weight ratio of the pyrolized product to the activating agent can be about 0.5 to about 5, about 0.6 to about 4, about 0.7 to about 3, about 0.8 to about 3, about 0.9 to about 3, about 1 to about 3, about 1 to less than 3, about 1.1 to less than 3, about 1.2 to less than 3, about 1.3 to less than 3, about 1.4 to less than 3, about 1.5 to less than 3, about 1.6 to less than 3, about 1.7 to less than 3, about 1.8 to less than 3, about 1.9 to less than 3, about 2 to less than 3, about 2.1 to less than 3, about 2.2 to less than 3, about 2.3 to less than 3, about 2.4 to less than 3, about 2.5 to less than 3, about 2.6 to less than 3, about 2.7 to less than 3, about 2.8 to less than 3, or about 2.9 to less than 3. In other examples, the weight ratio of the pyrolized product to the activating agent can be about 0.5 to about 2, about 0.6 to about 2, about 0.7 to about 2, about 0.8 to about 2, about 0.9 to about 2, about 1 to about 2, about 1.1 to about 2, about 1.2 to about 2, about 1.3 to about 2, about 1.4 to about 2, about 1.5 to about 2, about 1.6 to about 2, about 1.7 to about 2, about 1.8 to about 2, or about 1.9 to about 2. In other examples, the weight ratio of the pyrolized product to the activating agent can be about 0.5 to less than 2, about 0.6 to less than 2, about 0.7 to less than 2, about 0.8 to about 3, about 0.9 to less than 2, about 1 to less than 2, about 1.1 to less than 2, about 1.2 to less than 2, about 1.3 to less than 2, about 1.4 to less than 2, about 1.5 to less than 2, about 1.6 to less than 2, about 1.7 to less than 2, about 1.8 to less than 2, or about 1.9 to less than 2.

The degree of activation can be measured in terms of the mass percent of the pyrolized particles that is lost during the activation step. The degree of activation can be about 1%, about 5%, about 10%, about 20%, about 30%, about 40%, or about 50% to about 60%, about 70%, about 80%, about 90%, about 95%, or about 99%.

The pore volume, pore size, and specific surface area of the pyrolized product and the activated carbon product can be measured with the same techniques used to measure the dried gel product. In some embodiments, the pyrolized product and/or the activated carbon product can have a pore volume of about 0.03 cm³/g, about 0.05 cm³/g, about 0.1 cm³/g, about 0.3 cm³/g, or about 0.5 cm³/g, about 1 cm³/g, about 1.5 cm³/g, about 2 cm³/g, about 2.5 cm³/g, about 3 cm³/g, about 3.5 cm³/g, about 4 cm³/g, about 4.5 cm³/g, about 5 cm³/g, about 5.5 cm³/g, about 6 cm³/g, about 6.5 cm³/g, about 7 cm³/g, about 7.5 cm³/g, about 8 cm³/g, about 8.5 cm³/g, about 9 cm³/g, about 9.5 cm³/g, or about 10 cm³/g. For example, the pyrolized product and/or the activated carbon product can have a pore volume of at least 0.1 cm³/g, at least 0.2 cm³/g, at least 0.25 cm³/g, at least 0.3 cm³/g, at least 0.35 cm³/g, at least 0.4 cm³/g, at least 0.45 cm³/g, at least 0.5 cm³/g, at least 0.55 cm³/g, 0.6 cm³/g, at least 0.65 cm³/g, at least 0.7 cm³/g, at least 0.75 cm³/g, at least 0.8 cm³/g, about 0.9 cm³/g, about 0.95 cm³/g, about 1 cm³/g, about 1.05 cm³/g, about 1.1 cm³/g, about 1.15 cm³/g, about 1.2 cm³/g, about 1.25 cm³/g, about 1.3 cm³/g, about 1.35 cm³/g, about 1.4 cm³/g, about 1.45 cm³/g, about 1.5 cm³/g, about 1.6 cm³/g, about 1.7 cm³/g, about 1.8 cm³/g, about 1.9 cm³/g, about 2 cm³/g, about 2.1 cm³/g, about 2.2 cm³/g, about 2.3 cm³/g, about 2.4 cm³/g, about 2.5 cm³/g, about 2.6 cm³/g, about 2.7 cm³/g, about 2.8 cm³/g, about 2.8 cm³/g, about 2.9 cm³/g, about 3 cm³/g, about 3.1 cm³/g, about 3.2 cm³/g, about 3.3 cm³/g, about 3.4 cm³/g, about 3.5 cm³/g, about 3.6 cm³/g, about 3.7 cm³/g, about 3.8 cm³/g, about 3.8 cm³/g, about 3.9 cm³/g, about 4 cm³/g, about 4.1 cm³/g, about 4.2 cm³/g, about 4.3 cm³/g, about 4.4 cm³/g, about 4.5 cm³/g, about 4.6 cm³/g, about 4.7 cm³/g, about 4.8 cm³/g, about 4.8 cm³/g, about 4.9 cm³/g, about 5 cm³/g, about 5.1 cm³/g, about 5.2 cm³/g, about 5.3 cm³/g, about 5.4 cm³/g, about 5.5 cm³/g, about 5.6 cm³/g, about 5.7 cm³/g, about 5.8 cm³/g, about 5.8 cm³/g, about 5.9 cm³/g, about 6 cm³/g, about 6.1 cm³/g, about 6.2 cm³/g, about 6.3 cm³/g, about 6.4 cm³/g, about 6.5 cm³/g, about 6.6 cm³/g, about 6.7 cm³/g, about 6.8 cm³/g, about 6.8 cm³/g, about 6.9 cm³/g, about 7 cm³/g, about 7.1 cm³/g, about 7.2 cm³/g, about 7.3 cm³/g, about 7.4 cm³/g, about 7.5 cm³/g, about 7.6 cm³/g, about 7.7 cm³/g, about 7.8 cm³/g, about 7.8 cm³/g, about 7.9 cm³/g, or about 8 cm³/g, or greater. In another example, the pyrolized product and/or the activated carbon product can have a pore volume of about 0.1 cm³/g to about 10 cm³/g, about 0.2 cm³/g to about 10 cm³/g, about 0.2 cm³/g to about 9 cm³/g, about 0.3 cm³/g to about 9 cm³/g, about 0.4 cm³/g to about 8 cm³/g, about 0.4 cm³/g to about 7 cm³/g, about 0.5 cm³/g to about 7 cm³/g, about 0.5 cm³/g to about 6 cm³/g, or about 0.5 cm³/g to about 5 cm³/g. In some examples, the pyrolized product and/or the activated carbon product can have a pore volume of about 0.5 cm³/g to about 8 cm³/g, about 1 cm³/g to about 8 cm³/g, about 1 cm³/g to about 7 cm³/g, about 1 cm³/g to about 6 cm³/g, about 1 cm³/g to about 5 cm³/g, or about 2 cm³/g to about 8 cm³/g, about 2 cm³/g to about 7 cm³/g, about 3 cm³/g to about 7 cm³/g, or about 4 cm³/g to about 8 cm³/g.

In other embodiments, the pyrolized product and/or the activated carbon product can have a pore volume of about 0.03 cm³/g, about 0.05 cm³/g, about 0.1 cm³/g, about 0.3 cm³/g, or about 0.5 cm³/g to about 1 cm³/g, about 1.5 cm³/g, about 2 cm³/g, or about 2.5 cm³/g. For example, the pyrolized product and/or the activated carbon product can have a pore volume of at least 0.1 cm³/g, at least 0.2 cm³/g, at least 0.25 cm³/g, at least 0.3 cm³/g, at least 0.35 cm³/g, at least 0.4 cm³/g, at least 0.45 cm³/g, at least 0.5 cm³/g, at least 0.55 cm³/g, 0.6 cm³/g, at least 0.65 cm³/g, at least 0.7 cm³/g, at least 0.75 cm³/g, or at least 0.8 cm³/g to about 0.9 cm³/g, about 0.95 cm³/g, about 1 cm³/g, about 1.05 cm³/g, about 1.1 cm³/g, about 1.15 cm³/g, about 1.2 cm³/g, about 1.25 cm³/g, about 1.3 cm³/g, about 1.35 cm³/g, about 1.4 cm³/g, about 1.45 cm³/g, about 1.5 cm³/g, about 1.6 cm³/g, about 1.7 cm³/g, about 1.8 cm³/g, about 1.9 cm³/g, about 2 cm³/g, about 2.1 cm³/g, about 2.2 cm³/g, about 2.3 cm³/g, about 2.4 cm³/g, or about 2.5 cm³/g. In another example, the pyrolized product and/or the activated carbon product can have a pore volume of about 0.2 cm³/g to about 2 cm³/g, about 0.4 cm³/g to about 1.8 cm³/g, about 0.6 cm³/g to about 1.4 cm³/g, about 1 cm³/g to about 1.9 cm³/g, or about 0.3 cm³/g to about 1.7 cm³/g.

In some embodiments, the pyrolized product and/or the activated carbon product can have an average pore size (APS) of about 0.05 nm, about 0.06 nm, about 0.07 nm, about 0.08 nm, about 0.09 nm, about 0.095 nm, about 0.1 nm, about 0.2 nm, about 0.3 nm, about 0.4 nm, about 0.5 nm, about 0.6 nm, about 0.7 nm, about 0.8 nm, about 0.9 nm, about 0.95 nm, about 1 nm, about 1.5 nm, about 2 nm, about 5 nm, about 10 nm, about 15 nm, about 20 nm, about 25 nm, about 30 nm, about 25 nm, about 40 nm, about 45 nm, about 50 nm, about 51 nm, about 52 nm, about 53 nm, about 54 nm, or about 55 nm to about 80 nm, about 90 nm, about 100 nm, about 110 nm, about 120 nm, about 130 nm, about 140 nm, about 150 nm, about 200 nm, about 250 nm, about 300 nm, about 350 nm, about 400 nm, about 450 nm, or about 500 nm. For example, the pyrolized product and/or the activated carbon product can have an average pore size of at least about 0.05 nm, about 0.06 nm, about 0.07 nm, about 0.08 nm, about 0.09 nm, about 0.095 nm, about 0.1 nm, about 0.2 nm, about 0.3 nm, about 0.4 nm, about 0.5 nm, about 0.6 nm, about 0.7 nm, about 0.8 nm, about 0.9 nm, about 0.95 nm, about 1 nm, about 1.5 nm, about 2 nm, about 2.5 nm, about 3 nm, about 3 nm, about 5 nm, about 6 nm, about 7 nm, about 8 nm, about 9 nm, about 10 nm, about 15 nm, at least 20 nm, at least 30 nm, at least 40 nm, at least 50 nm, at least 55 nm, or at least 60 nm to about 80 nm, about 90 nm, about 100 nm, about 110 nm, about 120 nm, about 130 nm, about 140 nm, about 150 nm, about 200 nm, about 250 nm, about 300 nm, about 350 nm, about 400 nm, about 450 nm, or about 500 nm. In another example, the pyrolized product and/or the activated carbon product can have an average pore size of about 0.5 nm to about 150 nm, about 0.5 nm to about 100 nm, about 0.5 nm to about 50 nm, about 0.5 nm to about 10 nm, about 0.5 nm to about 9 nm, about 0.5 nm to about 8 nm, about 0.5 nm to about 7 nm, about 0.5 nm to about 6 nm, about 0.5 nm to about 5 nm, about 0.5 nm to about 4 nm, about 0.5 nm to about 3 nm, about 0.5 nm to about 2 nm, about 0.5 nm to about 1 nm, about 0.5 nm to less than 1 nm, or about 1 nm to about 100 nm, about 1 nm to about 50 nm, about 1 nm to about 10 nm, about 1 nm to about 9 nm, about 1 nm to about 8 nm, about 1 nm to about 7 nm, about 1 nm to about 6 nm, about 1 nm to about 5 nm, about 1 nm to about 4 nm, or about 2 nm to about 8 nm, about 3 nm to about 8 nm, about 4 nm to about 8 nm, or about 5 nm to about 8 nm, or about 2 nm to about 6 nm, or about 3 nm to about 6 nm.

In other embodiments, the pyrolized product and/or the activated carbon product can have an average pore size of about 0.5 nm, about 1 nm, about 1.5 nm, about 2 nm, about 5 nm, about 10 nm, about 15 nm, about 20 nm, about 25 nm, about 30 nm, about 25 nm, about 40 nm, about 45 nm, about 50 nm, about 51 nm, about 52 nm, about 53 nm, about 54 nm, or about 55 nm to about 80 nm, about 90 nm, about 100 nm, about 110 nm, about 120 nm, about 130 nm, about 140 nm, about 150 nm, about 200 nm, about 250 nm, about 300 nm, about 350 nm, about 400 nm, about 450 nm, or about 500 nm. For example, the pyrolized product and/or the activated carbon product can have an average pore size of at least 0.5 nm, at least 1 nm, at least 1.5 nm, at least 2 nm, at least 5 nm, at least 10 nm, at least 20 nm, at least 30 nm, at least 40 nm, at least 50 nm, at least 55 nm, or at least 60 nm to about 80 nm, about 90 nm, about 100 nm, about 110 nm, about 120 nm, about 130 nm, about 140 nm, about 150 nm, about 200 nm, about 250 nm, about 300 nm, about 350 nm, about 400 nm, about 450 nm, or about 500 nm. In another example, the pyrolized product and/or the activated carbon product can have an average pore size of about 1.5 nm to about 150 nm, about 10 nm to about 80 nm, about 30 nm to about 90 nm, about 80 nm to about 100 nm.

In some embodiments, the pyrolized product and/or the activated carbon product can have a specific surface area (SSA) of about 5 m²/g, about 10 m²/g, about 25 m²/g, about 50 m²/g, about 100 m²/g, about 200 m²/g, about 300 m²/g, about 400 m²/g, about 500 m²/g, or about 600 m²/g to about 700 m²/g, about 800 m²/g, about 900 m²/g, about 1,000 m²/g, about 1,100 m²/g, about 1,200 m²/g, about 1,300 m²/g, about 1,400 m²/g, about 1,500 m²/g, about 1,600 m²/g, about 1,700 m²/g, about 1,800 m²/g, about 1,900 m²/g, about 2,000 m²/g, about 2,500 m²/g, about 3,000 m²/g, about 3,500 m²/g, about 4,000 m²/g, about 4,500 m²/g, about 5,000 m²/g, about 5,500 m²/g, about 6,000 m²/g, about 6,500 m²/g, about 7,000 m²/g, about 7,500 m²/g, about 8,000 m²/g, about 8,500 m²/g, about 9,000 m²/g, about 9,500 m²/g, about 10,000 m²/g, or greater. For example, the pyrolized product and/or the activated carbon product can have a specific surface area of at least 100 m²/g, at least 150 m²/g, at least 200 m²/g, at least 250 m²/g, at least 300 m²/g, or at least 350 m²/g to at least 750 m²/g, at least 850 m²/g, at least 1,050 m²/g, at least 1,250 m²/g, at least 1,500 m²/g, at least 2,000 m²/g, at least 2,500 m²/g, at least 3,000 m²/g, at least 3,500 m²/g, at least 4,000 m²/g, at least 4,500 m²/g, at least 5,000 m²/g, at least 5,500 m²/g, at least 6,000 m²/g, at least 6,500 m²/g, at least 7,000 m²/g, at least 7,500 m²/g, at least 8,000 m²/g, at least 8,500 m²/g, at least 9,000 m²/g, at least 9,500 m²/g, at least 10,000 m²/g. In another example, the pyrolized product and/or the activated carbon product can have a specific surface area of about 100 m²/g to about 10,000 m²/g, about 100 m²/g to about 9,000 m²/g, about 100 m²/g to about 8,000 m²/g, about 100 m²/g to about 6,000 m²/g, about 100 m²/g to about 5,000 m²/g, about 100 m²/g to about 4,000 m²/g, about 100 m²/g to about 3,000 m²/g, about 100 m²/g to about 3,000 m²/g, or about 100 m²/g to about 1,000 m²/g.

In other embodiments, the pyrolized product and/or the activated carbon product can have a specific surface area of about 5 m²/g, about 10 m²/g, about 25 m²/g, about 50 m²/g, about 100 m²/g, about 200 m²/g, about 300 m²/g, about 400 m²/g, about 500 m²/g, or about 600 m²/g to about 700 m²/g, about 800 m²/g, about 900 m²/g, about 1,000 m²/g, about 1,100 m²/g, about 1,200 m²/g, about 1,300 m²/g, about 1,400 m²/g, or about 1,500 m²/g. For example, the pyrolized product and/or the activated carbon product can have a specific surface area of at least 150 m²/g, at least 200 m²/g, at least 250 m²/g, at least 300 m²/g, or at least 350 m²/g to about 750 m²/g, about 850 m²/g, about 1,050 m²/g, or about 1,250 m²/g. In another example, the pyrolized product and/or the activated carbon product can have a specific surface area of about 200 m²/g to about 1,000 m²/g, about 200 m²/g to about 800 m²/g, about 300 m²/g to about 550 m²/g, about 350 m²/g to about 600 m²/g, or about 400 m²/g to about 850 m²/g.

The pyrolized product and/or the activated carbon product can have an average pore size of about 10 nm to about 100 nm and a pore volume of about 0.2 cm³/g to about 2 cm³/g. For example, the pyrolized product and/or the activated carbon product can have an average pore size of about 60 nm to about 120 nm, about 10 nm to about 80 nm, or about 80 nm to about 100 nm and a pore volume of about 0.3 cm³/g to about 1.8 cm³/g, about 0.2 cm³/g to about 2 cm³/g, or about 0.25 cm³/g to about 1.5 cm³/g. In another example, the pyrolized product and/or the activated carbon product can have pore size of at least 10 nm, at least 30 nm, at least 50 nm, or at least 60 nm to about 80 nm, about 100 nm, about 125 nm, or about 150 nm and a pore volume of at least 0.4 cm³/g, at least 0.5 cm³/g, at least 0.6 cm³/g, or at least 0.7 cm³/g to about 1 cm³/g, about 1.2 cm³/g, about 1.5 cm³/g, about 1.8 cm³/g, or about 2 cm³/g.

The pyrolized product and/or the activated carbon product can have an average pore size of about 10 nm to about 100 nm and a specific surface area of about 5 m²/g to about 1,500 m²/g. For example, the pyrolized product and/or the activated carbon product can have an average pore size of about 60 nm to about 120 nm, about 10 nm to about 80 nm, or about 80 nm to about 100 nm and a specific surface area of about 200 m²/g to about 1,000 m²/g, about 200 m²/g to about 800 m²/g, or about 400 m²/g to about 900 m²/g. In another example, the pyrolized product and/or the activated carbon product can have pore size of at least 10 nm, at least 30 nm, at least 50 nm, or at least 60 nm to about 80 nm, about 100 nm, about 125 nm, or about 150 nm and a specific surface area of at least 50 m²/g, at least 100 m²/g, at least 150 m²/g, at least 200 m²/g, at least 300 m²/g, at least 350 m²/g, or at least 400 m²/g to about 750 m²/g, about 800 m²/g, about 900 m²/g, about 1,000 m²/g, about 1,100 m²/g, or about 1,250 m²/g.

The pyrolized product and/or the activated carbon product can have a specific surface area of about 5 m²/g to about 1,500 m²/g and a pore volume of about 0.2 cm³/g to about 2 cm³/g. For example, the pyrolized product and/or the activated carbon product can have a specific surface area of about 200 m²/g to about 1,000 m²/g, about 200 m²/g to about 800 m²/g, or about 400 m²/g to about 900 m²/g and a pore volume of about 0.3 cm³/g to about 1.8 cm³/g, about 0.2 cm³/g to about 2 cm³/g, or about 0.25 cm³/g to about 1.5 cm³/g. In another example, the pyrolized product and/or the activated carbon product can have a specific surface area of at least 150 m²/g, at least 200 m²/g, at least 300 m²/g, at least 350 m²/g, or at least 400 m²/g to about 750 m²/g, about 800 m²/g, about 900 m²/g, about 1,000 m²/g, about 1,100 m²/g, or about 1,250 m²/g and a pore volume of at least 0.4 cm³/g, at least 0.5 cm³/g, at least 0.6 cm³/g, or at least 0.7 cm³/g to about 1 cm³/g, about 1.2 cm³/g, about 1.5 cm³/g, about 1.8 cm³/g, or about 2 cm³/g.

The pyrolized product and/or the activated carbon product can have an average pore size of about 10 nm to about 100 nm, a specific surface area of about 5 m²/g to about 1,500 m²/g, and a pore volume of about 0.2 cm³/g to about 2 cm³/g. For example, the pyrolized product and/or the activated carbon product can have an average pore size of about 60 nm to about 120 nm, about 10 nm to about 80 nm, or about 80 nm to about 100 nm, a specific surface area of about 200 m²/g to about 1,000 m²/g, about 200 m²/g to about 800 m²/g, or about 400 m²/g to about 900 m²/g, and a pore volume of about 0.3 cm³/g to about 1.8 cm³/g, about 0.2 cm³/g to about 2 cm³/g, or about 0.25 cm³/g to about 1.5 cm³/g. In another example, the pyrolized product and/or the activated carbon product can have pore size of at least 10 nm, at least 30 nm, at least 50 nm, or at least 60 nm to about 80 nm, about 100 nm, about 125 nm, or about 150 nm, a specific surface area of at least 150 m²/g, at least 200 m²/g, at least 300 m²/g, at least 350 m²/g, or at least 400 m²/g to about 750 m²/g, about 800 m²/g, about 900 m²/g, about 1,000 m²/g, about 1,100 m²/g, or about 1,250 m²/g, and a pore volume of at least 0.4 cm³/g, at least 0.5 cm³/g, at least 0.6 cm³/g, or at least 0.7 cm³/g to about 1 cm³/g, about 1.2 cm³/g, about 1.5 cm³/g, about 1.8 cm³/g, or about 2 cm³/g.

In one or more embodiments, one or more modifier or composite materials can be combined with the reaction mixture, the wet gel, the dried gel product, and/or the pyrolized product. As used herein, the terms “modifier” and “composite material” refer to any chemical element or compound comprising a chemical element, or any combination of different chemical elements and/or compounds that can modify one or more properties of the wet gel, the dried gel product, and/or the pyrolized gel. The modifier can change (increase or decrease) the resistance, capacity, power performance, composition, stability, and other properties of the wet gel, the dried gel product, and/or the pyrolized gel. Examples of modifiers within the context of the present disclosure can include, but are not limited to, elements, and compounds or oxides comprising elements, in groups 12-15 of the periodic table, other elements such as sulfur, tungsten and silver and combinations or mixtures thereof. For example, the modifier can include, but are not limited to, lead, tin, antimony, bismuth, arsenic, tungsten, silver, zinc, cadmium, indium, iron, sulfur, cobalt, nickel, bromine, chlorine, ruthenium, rhodium, platinum, palladium, zirconium, gold, oxides thereof, any alloys thereof, or any mixture thereof.

The modifier can be present in the reaction mixture and/or the wet gel in an amount of about 0.01 wt %, about 0.5 wt %, about 1 wt %, about 2 wt %, or about 3 wt % to about 30 wt %, about 50 wt %, about 70 wt %, about 90 wt %, or about 95 wt %, based on the combined weight of the hydroxybenzene compound, the aldehyde compound, the additive, and the modifier in the reaction mixture. For example, the modifier can be present in the reaction mixture and/or the wet gel in an amount of about 0.01 wt % to about 90 wt %, about 1 wt % to about 70 wt %, about 2 wt % to about 50 wt %, about 3 wt % to about 30 wt %, or about 4 wt % to about 25 wt %, based on the combined weight of the hydroxybenzene compound, the aldehyde compound, the additive, and the modifier in the reaction mixture. Similarly, the modifier can be present in the reaction mixture and/or the wet gel in an amount of about 0.01 wt %, about 0.5 wt %, about 1 wt %, about 2 wt %, or about 3 wt % to about 30 wt %, about 50 wt %, about 70 wt %, about 90 wt %, or about 95 wt %, based on the combined weight of the pyrolized product or the activated carbon product and the modifier. For example, the modifier can be present in the pyrolized and/or activated carbon product in an amount of about 0.01 wt % to about 90 wt %, about 1 wt % to about 70 wt %, about 2 wt % to about 50 wt %, about 3 wt % to about 30 wt %, or about 4 wt % to about 25 wt %, based on the combined weight of the pyrolized produce or the activated carbon product and the modifier.

In one or more embodiments, it may be desirable to produce wet gels and dried gels therefrom having little or no metal ions, e.g., silicon, sodium, iron, lithium, phosphorus, aluminum, arsenic, boron, or potassium. Impurities such as metal atoms and/or metal ions can be introduced to the polymer particles in gel form via any one or more of several possible sources, which can include, but are not limited to, the particular type of catalyst, leaching from the mixer and/or reactor into the monomer component and/or during and/or after the polymer particles in gel form are made. Accordingly, the materials used to make the mixer, line the inner surfaces or walls of the mixer, and/or components thereof, e.g., agitator blades, reactor, and the like can be chosen so as to reduce the potential or likelihood of contamination. For example, depending on a particular metal, the metal can leach or otherwise loose metal ions that can be incorporated into the polymer particle in gel form during the suspension and/or emulsion polymerization thereof.

In one or more embodiments, the wet gel, the dried gel product, the pyrolized product, and/or the activated carbon product can have a concentration of one or more metal atoms, one or more metal ions, or a combination of one or more metal atoms and one or more metal ions of less than 1 wt %, less than 0.9 wt %, less than 0.8 wt %, less than 0.7 wt %, less than 0.6 wt %, less than 0.5 wt %, less than 0.4 wt %, less than 0.3 wt %, less than 0.2 wt %, less than 0.15 wt %, less than 0.1 wt %, less than 0.7 wt %, less than 0.5 wt %, less than 0.3 wt %, less than 0.1 wt %, less than 0.09 wt %, less than 0.07 wt %, less than 0.05 wt %, less than 0.03 wt %, less than 0.01 wt %, less than 0.009 wt %, less than 0.007 wt %, less than 0.005 wt %, less than 0.003 wt %, less than 0.001 wt %, less than 0.0007 wt %, or less than 0.0005 wt %, based on a total weight of the wet gel, the dried gel product, and/or the pyrolized. The concentration of any metal atoms and/or metal ions present in the wet gel, the dried gel product, the pyrolized product, and the activated carbon product can be measured or determined by proton induced x-ray emission or “PIXE.” The metal atoms and/or metal ions and/or other elements can be or include the elements having an atomic number of 11 to 92. The metal atoms and/or metal ions and/or other elements can be or include elements having an atomic number of 3-5 and 11 to 92.

In one or more embodiments, the wet gel, the dried gel product, the pyrolized product, and/or the activated carbon product can contain any one or more of the metal atoms (or metal ions or other elements) having an atomic number of 3 to 5 and/or 11 to 92 independently at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. For example, in one or more embodiments, the wet gel, the dried gel product, the pyrolized product, and/or the activated carbon product can contain sodium at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain magnesium at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain silicon at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain sulfur at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain calcium at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain iron at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain nickel at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain copper at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain chromium at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In one or more embodiments, the wet gel, the dried gel product, the pyrolized product, and/or the activated carbon product can contain zinc at a concentration of less than 1,000 ppm, less than 700 ppm, less than 500 ppm, less than 300 ppm, less than 100 ppm, less than 75 ppm, less than 50 ppm, less than 25 ppm, less than 10 ppm, less than 5 ppm, or less than 1 ppm. In some embodiments, the wet gel, the dried gel product, the pyrolized product, and/or the activated carbon product can have impurities, such as hydrogen, oxygen and/or nitrogen, and each impurity can independently be at concentration of less than 10%, less than 9%, less than 8%, less than 7%, less than 6%, less than 5%, less than 4%, less than 3%, less than 2%, less than 1%, less than 0.5%, less than 0.1%, less than 0.05%, or less than 0.01%.

One way to reduce and/or eliminate contamination of metal or metal ions within the wet gel, the dried, gel, and/or the pyrolized product can be to construct the mixer and/or reactor from non-reactive or very low reactive materials, materials having a reduced tendency to leach or give up metal atoms or ions to the reaction mixture as compared to materials that are known to leach metal atoms into the reaction mixture. Some potential materials that can be suitable for making the mixer and/or reactor used to produce the wet gel that can also help reduce the contamination of metals or metal ions leaching or otherwise transferring from the mixer and/or reactor to the wet gel can include, but are not limited to, metals, glass, e.g., a glass lined vessel, fiber reinforced vessels, e.g., FRP (FRB, FRVE, or FRSVE) and dual laminate like PP/FRP, PVC/FRP, CPVC/FRP, PVDF/FRP, ECTFE/FRP, ETFE/FRP, FEP/FRP, and PFA/FRP, polymer reactors, e.g., polytetrafluoroethylene (PTFE), poly(perfluoroalkoxy) (poly-PFA), poly(fluorinated ethylene propylene) (poly-FEP), other poly(fluorinated alkylenes), polyethylene (PE), polypropylene (PP), chlorinated poly(vinyl chloride) (CPVC). Illustrative materials or metals can include, but are not limited to, cobalt, chromium, tungsten, carbon, silicon, iron, manganese, molybdenum, vanadium, nickel, boron, phosphorous, sulfur, titanium, aluminum, copper, tungsten, alloys thereof, or any combination thereof. For example, the one or more inner surfaces of the reactor can be made of steel, such as stainless steels, carbon steels, tool steels, alloys thereof, or any combination thereof. Illustrative steels can include, but are not limited to, A387 Grade 11 low chrome steel, 304 stainless steel, 316 stainless steel, and 347 stainless steel.

In one or more embodiments, the surfaces of the mixer and/or reactor and/or components thereof can be treated to reduce the likelihood of metal ions (or other impurities) from leaching or otherwise transferring from the surfaces to the wet gel. The inner metal surfaces can be subjected a passivation process to reduce the likelihood of contamination of the wet gel with metal ions. For example, metal surfaces of the mixer and/or reactor that contact the suspension and/or emulsion can be subjected one or more treatment processes such as carburization, boronization, and/or nitridization. In another example the inner surfaces of the mixer and/or reactor can be subjected to a pickling process. A pickling process can include treating a metal or other surface to remove one or more impurities, e.g., one or more states, inorganic contaminants, rust or scale from ferrous, copper, and/or aluminum metals or alloys. The surface can be treated with a solution or “pickle liquor” that contains one or more acids, for example. The one or more acids can be or include, but are not limited to, hydrochloric acid, sulfuric acid, nitric acid, or any combination or mixture thereof.

In one or more embodiments, the mixer and/or reactor or inner surfaces thereof can be heated in the presence of a carbon source to a temperature below the melting point of the inner surfaces, but sufficiently high to cause carbon to deposit within the outer layer or surface of the inner surfaces, e.g., the layer or surface exposed to the reaction mixture. Any suitable form of carbon can be used as the carbon source, for example carbon containing gases, liquids, solids, and/or plasmas. Illustrative gases can include, but are not limited to, carbon dioxide, methane, ethane, propane, or the like. In another example, the mixer and/or reactor or/or inner surfaces thereof can be heated in the presence of a boron source to a sufficient temperature, but below the melting point of the inner surfaces, but sufficiently high to cause boron to diffuse into the surface and form borides with the material. In yet another example, the mixer and/or reactor and/or inner surfaces thereof can be heated in the presence of a nitrogen source to a sufficient temperature, but below the melting point of the inner surfaces, causing nitrogen to diffuse into the surface and form nitrides with the material. Any suitable process can be used to nitride the inner surfaces of the mixer and/or reactor and/or other components thereof. For example, gas nitriding, liquid or salt bath nitriding, and ion or plasma nitriding can be used. In another example, the mixer and/or reactor, and/or inner surfaces thereof can under-go both carburization and nitridization (“carbonitriding”) in which both carbon and nitrogen are diffused into the inner surfaces thereof. Subjecting the mixer and/or reactor and/or other components and/or inner surfaces thereof to carburization, boronization, and/or nitridization can reduce or eliminate the likelihood that metal ions or other contaminants from the mixer and/or reactor and/or other components thereof can leach or otherwise transfer therefrom to the reaction mixture and/or the wet gel.

The particles after drying, after pyrolysis, and/or after activation can have an average cross-sectional length of about 0.1 μm, about 1 μm, about 10 μm, about 50 μm, about 75 μm, about 0.1 mm or more, about 0.5 mm or more, about 1 mm or more, about 1.5 mm or more, about 2 mm or more, about 2.5 mm or more, about 3 mm or more, about 3.5 mm or more, about 4 mm or more, about 4.5 mm or more, about 5 mm or more, about 5.5 mm or more, or about 6 mm or more. The particles after drying, after pyrolysis, and/or after activation can have an average cross-sectional length of about 0.1 mm, about 0.5 mm, about 1 mm, about 1.5 mm, about 2 mm, about 2.5 mm, about 3 mm, about 3.5 mm, or about 4 mm to about 5 mm, about 7 mm, about 10 mm, about 12 mm, about 15 mm, about 18 mm, about 20 mm, about 25 mm, or about 30 mm. In one or more embodiments, the particles after drying, after pyrolyzing, and/or after activation can have an average cross-sectional length of about 1 μm, about 10 μm, about 50 μm, about 100 μm, about 200 μm, about 300 μm, about 500 μm, about 700 μm, or about 1,000 μm to about 1.1 mm, about 1.3 mm, about 1.5 mm, about 2 mm, about 3 mm, about 4 mm, about 5 mm, about 7 mm, or about 10 mm.

If a modifier is used in making the wet gel, the modifier can be incorporated within the pore structure and/or on the surface of the particles after drying, after pyrolysis, and/or after activation or incorporated in any number of other ways. For example, in some embodiments, the particles after drying, after pyrolysis, and/or after activation can include a coating of the modifier at least partially on the surface thereof. In some embodiments, the particles after drying, after pyrolysis, and/or after activation can include about 100 ppm or greater of a modifier.

The properties of the particles after drying, after pyrolysis, and/or after activation can be modified, at least in part, by the amount of the modifier in the particles after drying, after pyrolysis, and/or after activation. Accordingly, in some embodiments, the particles after drying, after pyrolysis, and/or after activation can include at least 0.1%, at least 0.25%, at least 0.5%, at least 1%, at least 5%, at least 10%, at least 25%, at least 50%, at least 75%, at least 90%, at least 95%, at least 99% or at least 99.5% of the modifier. For example, in some embodiments, the particles after drying, after pyrolysis, and/or after activation can include about 0.5% and 99.5% carbon and of about 0.5% and 99.5% modifier. The percent of the modifier is calculated on weight percent basis (wt %). In some other more specific embodiments, the modifier can be selected from iron, tin, nickel, and manganese.

The total ash content of the particles after drying, after pyrolysis, and/or after activation may, in some instances, can have an effect on the performance of the particles after drying, after pyrolysis, and/or after activation. Accordingly, in some embodiments, the ash content of the particles after drying, after pyrolysis, and/or after activation can be about 0.1% to about 0.001% weight percent ash. For example in some specific embodiments the ash content of the particles after drying, after pyrolysis, and/or after activation can be less than 0.1%, less than 0.08%, less than 0.05%, less than 0.03%, than 0.025%, less than 0.01%, less than 0.0075%, less than 0.005% or less than 0.001%.

“Ash content” refers to the nonvolatile inorganic matter which remains after subjecting a substance to a high decomposition temperature. Herein, the ash content of a carbon material, e.g., the polymer particles after drying, after pyrolysis, and/or after activation, can be calculated from the total PIXE impurity content as measured by proton induced x-ray emission, assuming that nonvolatile elements are completely converted to expected combustion products (e.g., oxides).

Depending, at least in part, on the end use of the wet gel, the wet gel itself, the dried gel product, the gel after pyrolyzing, the gel after activation, or a combination of wet gel, dried gel, pyrolized product, and/or activated carbon product can be used in one or more applications. Illustrative applications the wet gel, dried gel, pyrolized product, and/or activated carbon product can be used in can include, but are not limited to, insulation, energy such as in capacitors, batteries, and fuel cells, medicine such as in drug delivery, transportation such as in hydrogen or other fuel storage, sensors, sports, catalysts, hazardous waste water treatment, catalyst supports, sorbents, dielectrics, impedance matcher, detectors, filtrations, ion exchange, high-energy physics applications, waste management, such as adsorption of waste fluids and/or waste gases, and the like. As such, the wet gel, the dried gel product, pyrolized product, the activated carbon product, or a combination of the wet gel, the dried gel product, the pyrolized product, and/or the activated carbon product can be used alone and/or as a component of a system, device, or other structure.

One end use for the wet gel, dried gel, pyrolized product, and/or activated carbon product can include incorporation of the dried gel product into and/or on a composite wood product. Illustrative composite wood products can include, but are not limited to, particleboard, fiberboard such as medium density fiberboard (“MDF”) and/or high density fiberboard (“HDF”), waferboard, oriented strand board plywood (“OSB”), plywood, laminated veneer lumber (“LVL”), laminated veneer boards (“LVB”), engineered wood flooring, and the like.

Another end use for the wet gel, dried gel, pyrolized product, and/or activated carbon product can include incorporation of the dried gel product into and/or on a fiberglass product. As used herein, the terms “fiber,” “fibrous,” “fiberglass,” “fiber glass,” “glass fibers,” and the like are used interchangeably and refer to materials that have an elongated morphology exhibiting an aspect ratio (length to thickness) of greater than 100, generally greater than 500, and often greater than 1,000. Indeed, an aspect ratio of over 10,000 is possible. Suitable fibers can be glass fibers, natural fibers, synthetic fibers, mineral fibers, ceramic fibers, metal fibers, carbon fibers, or any combination thereof. Illustrative glass fibers can include, but are not limited to, A-type glass fibers, C-type glass fibers, E-type glass fibers, S-type glass fibers, ECR-type glass fibers, wool glass fibers, and any combination thereof. The term “natural fibers,” as used herein refers to plant fibers extracted from any part of a plant, including, but not limited to, the stem, seeds, leaves, roots, or phloem. Illustrative natural fibers can include, but are not limited to, cotton, jute, bamboo, ramie, bagasse, hemp, coir, linen, kenaf, sisal, flax, henequen, and any combination thereof. Illustrative synthetic fibers can include, but are not limited to, synthetic polymers, such as polyester, polyamide, aramid, and any combination thereof. In at least one specific embodiment, the fibers can be glass fibers that are wet use chopped strand glass fibers (“WUCS”). Wet use chopped strand glass fibers can be formed by conventional processes known in the art. The WUCS can have a moisture content of about 5%, about 8%, or about 10% to about 20%, about 25%, or about 30%.

Fiberglass products can be used by themselves or incorporated into a variety of products. For example, fiberglass products can be used as or incorporated into insulation batts or rolls, composite flooring, asphalt roofing shingles, siding, gypsum wall board, roving, microglass-based substrate for printed circuit boards, battery separators, filter stock, tape stock, carpet backing, commercial and industrial insulation, and as reinforcement scrim in cementitious and non-cementitious coatings for masonry.

Incorporation of the wet gel, dried gel, pyrolized product, and/or activated carbon product into and/or on a composite wood product and/or a fiberglass product can increase the thermal and/or acoustic insulation properties of the composite product. In one or more embodiments, the wet gel, dried gel, pyrolized product, and/or activated carbon product can be adhered, glued, or otherwise affixed to one or more surfaces of a composite wood product or fiberglass product to provide a thermally and/or acoustically insulated product. In another example, the wet gel, dried gel, pyrolized product, and/or activated carbon product can be sandwiched between two or more layers of wood substrates or fiberglass to produce a product containing the wet gel, dried gel, pyrolized product, and/or activated carbon product. For example, in the context of plywood, a layer of the wet gel, dried gel, pyrolized product, and/or activated carbon product can be sandwiched between two layers of veneer.

Any suitable adhesive can be used to bind the wet gel, dried gel, pyrolized product, and/or activated carbon product to wood and/or fiberglass in making the product containing the dried gel product. Illustrative adhesives can include, but are not limited to, isocyanate resin, aldehyde based resins such as urea-formaldehyde, phenol formaldehyde, melamine formaldehyde, phenol-urea-formaldehyde resin, resorcinol-formaldehyde resin, phenol-resorcinol-formaldehyde resin, and melamine-urea-formaldehyde resin, or any mixture thereof.

Incorporation of the wet gel, dried gel, pyrolized product, and/or activated carbon product into and/or on a composite wood product and/or a fiberglass product can include affixing the wet gel, dried gel, pyrolized product, and/or activated carbon product onto one or more sheets or layers of material. Illustrative sheets of material can include, but are not limited to, paper sheets, polymer sheets, paper/polymer sheets, or any mixture thereof. In another example, incorporation of the wet gel, dried gel, pyrolized product, and/or activated carbon product into and/or on a composite wood product and/or a fiberglass product can include applying a layer or covering of material that contains the dried gel product. For example, wet gel, dried gel, pyrolized product, and/or activated carbon product particles can be sandwiched between two or more layers of the sheet of material. This sandwiched layer having at least a first outer layer and a second outer layer of the sheet material and a core layer of the wet gel, dried gel, pyrolized product, and/or activated carbon product can be affixed to one or more outer surfaces of the composite wood product and/or the fiberglass product and/or incorporated into the composite wood product and/or the fiberglass product.

Another end use for the described products and materials, such as wet gels, wet gel products, dried gels, dried gel products, pyrolized products, pyrolized carbon products, activated products, and/or activated carbon products can include incorporation into one or more liquids that can be used to coat a surface. For example, the wet gels, wet gel products, dried gels, dried gel products, pyrolized products, pyrolized carbon products, activated products, and/or activated carbon products can be incorporated into a paint. The paint can then be applied to a wall or to an exterior and/or interior side of a roof or any other surface to provide a coated surface containing the wet gels, wet gel products, dried gels, dried gel products, pyrolized products, pyrolized carbon products, activated products, and/or activated carbon products.

In one or more embodiments, another end use for the dried gels, dried gel products, pyrolized products, pyrolized carbon products, activated products, and/or activated carbon products can be used in energy storage devices. In some examples, energy storage devices having the dried gel products, pyrolized products, pyrolized carbon products, activated products, and/or activated carbon products can have a capacitance of greater than 120 F/g, a maximum theoretical capacitance of greater than 14 F/cm³, and a frequency response of about 45 Hz is greater than 1. In other examples, energy storage devices having the dried gel products, pyrolized products, pyrolized carbon products, activated products, and/or activated carbon products can have a capacitance of greater than 110 F/g, a maximum theoretical capacitance of greater than 25 F/cm³, and a frequency response of about 45 Hz is greater than 0.5. In one or more embodiments, another end use for the dried gel products, pyrolized products, pyrolized carbon products, activated products, and/or activated carbon products can be used in adsorption applications and/or separation applications.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

### Examples 1-15

For Examples 1-15, a phenol-formaldehyde prepolymer was produced according to the following procedure. About 520 grams of phenol and about 465 grams of formaldehyde (50 wt % aqueous solution) were added to a reactor and heated to a temperature of about 55° C. About 16 grams of triethylamine was added to the reactor and the temperature of the mixture was increased to about 78° C. and reaction between the components of the mixture was continued until a viscosity of about 60 centistokes was reached. The reaction mixture was cooled to about 55° C. and distilled to provide a water content of about 12%. The reaction mixture was further cooled to about 25° C. and named as prepolymer.

To the prepolymer the appropriate amounts of acetic acid, maleic anhydride, ethylene glycol, PEG-PPG-PEG copolymer, citric acid, and/or resorcinol were added to produce a reaction mixture. The amount of each component relative to one another in the reaction mixture is shown in Table 1 below. The reaction mixture was heated in a 10 liter glass reactor to about 85° C. for about 5 hr under agitation. The mixture was cooled to about 55° C. and transferred to two 2.5 gallon containers. The containers were sealed and placed in a heated oven at about 70° C. for about 48 hr. The sealed containers were then heated to about 90° C. for about 24 hr and cooled to provide the wet gel product.

TABLE 1
Wet-Gel Composition

| | | | Acetic | Maleic | Ethylene | PEG-PPG- | Citric | | | | F:P |
|---|---|---|---|---|---|---|---|---|---|---|---|
| Ex. | Phenol, | Form., | Acid, | Anhy., | Glycol, | PEG Copoly- | Acid, | Resorc., | TEA, | Water, | Molar |
| No. | wt % | wt % | wt % | wt % | wt % | mer, wt % | wt % | wt % | wt % | wt % | Ratio |
| 1 | 19.1 | 8.53 | 60.98 | 2.74 | — | 4.57 | 1.22 | — | 0.57 | 2.29 | 1.4:1 |
| 2 | 24.09 | 10.76 | 53.85 | 2.31 | — | 3.08 | 2.31 | — | 0.72 | 2.88 | 1.4:1 |
| 3 | 23.82 | 10.64 | 53.20 | 4.94 | — | 3.04 | 0.76 | — | 0.71 | 3.60 | 1.4:1 |
| 4 | 27.72 | 12.38 | 53.10 | 2.65 | — | — | — | — | 0.83 | 3.32 | 1.4:1 |
| 5 | 19.76 | 8.83 | 63.09 | 0.63 | — | 4.73 | — | — | 0.59 | 2.37 | 1.4:1 |
| 6 | 20.47 | 9.14 | 65.36 | 0.65 | — | — | 1.31 | — | 0.61 | 2.46 | 1.4:1 |
| 7 | 36.21 | 16.17 | 34.68 | 5.20 | — | — | 2.31 | — | 1.09 | 4.34 | 1.4:1 |
| 8 | 20.74 | 9.26 | 66.23 | 0.66 | — | — | — | — | 0.62 | 2.49 | 1.4:1 |
| 9 | 20.01 | 8.94 | 63.90 | 2.88 | — | — | 1.28 | — | 0.60 | 2.39 | 1.4:1 |
| 10 | 15.82 | 7.07 | 70.71 | 1.52 | — | 2.02 | 0.51 | — | 0.47 | 1.88 | 1.4:1 |
| 11 | 18.79 | 8.39 | 30.00 | 5.00 | 10.00 | 10.00 | 10.00 | 5.00 | 0.56 | 2.25 | 2.5:1 |
| 12 | 18.47 | 8.25 | 68.74 | 1.77 | — | — | — | — | 0.55 | 2.22 | 1.4:1 |
| 13 | 40.71 | 18.19 | 30.00 | 5.00 | — | — | — | — | 1.22 | 4.88 | 2.5:1 |
| 14 | 42.04 | 18.78 | 26.85 | 6.04 | — | — | — | — | 1.26 | 5.03 | 1.4:1 |
| 15 | 31.32 | 13.99 | 30.00 | — | 10.00 | 10.00 | — | — | 0.94 | 3.75 | 2.5:1 |

The wet gels were dried in an air atmosphere at a temperature of about 200° C. for about 15 hr to produce dried gels. The specific surface area (SSA), pore volume (PV), and pore size distribution (PSD) were measured for the dried gel products in Examples 1-3 and 5-10. All of the dried gel products in Examples 1-15 were pyrolized under a nitrogen atmosphere at a temperature of about 900° C. for about 2 hr to produce a pyrolized or carbon product. The specific surface area (SSA), pore volume (PV), and pore size distribution (PSD) were measured for the pyrolized products in Examples 1-15. The specific surface area (SSA), pore volume (PV), and pore size distribution (PSD) for the dried gel products and the pyrolized products are shown in Table 2 below.

TABLE 2
Properties

| Pyrolized Product Properties | | | | Dried Gel Properties | | |
|---|---|---|---|---|---|---|
| Ex. | SSA | PV | PSD | SSA | PV | PSD |
| No. | (m²/g) | (cm³/g) | (nm) | (m²/g) | (cm³/g) | (nm) |
| 1 | 473 | 1.38 | 90 | 145 | 0.72 | 50 |
| 2 | 424 | 0.93 | 30 | 167 | 0.77 | 25 |
| 3 | 496 | 0.91 | 48 | 167 | 0.91 | 50 |
| 4 | 380 | 0.85 | 50 | — | — | — |
| 5 | 428 | 0.66 | 90 | 97 | 0.39 | 85 |
| 6 | 426 | 0.56 | 90 | 87 | 0.41 | 90 |
| 7 | 389 | 0.51 | 15 | 270 | 0.59 | 18 |
| 8 | 404 | 0.47 | 90 | 91 | 0.40 | 90 |
| 9 | 460 | 0.41 | 40 | 100 | 0.31 | 90 |
| 10 | 485 | 0.41 | 90 | 47 | 0.16 | 90 |
| 11 | 318 | 0.39 | 20 | — | — | — |
| 12 | 488 | 0.39 | 35 | — | — | — |
| 13 | 335 | 0.38 | 25 | — | — | — |
| 14 | 342 | 0.36 | 15 | — | — | — |
| 15 | 142 | 0.1 | 80 | — | — | — |

As shown in Table 2 above, the physical properties of the dried gel products and the pyrolized products could be adjusted or tailored based on the particular composition of the reaction mixture. For example, under some conditions increasing acetic acid increased the average pore size, pore volume, and specific surface area.

### Example 16

In Example 16, a wet gel was made and pyrolized to produce a pyrolized product composed of carbon. A prepolymer was made according to the preparation described above for Examples 1-15. To about 200 grams of the prepolymer, a mixture containing about 6 grams resorcinol, about 6 grams maleic anhydride, about 10 grams citric acid, about 10 grams poly(ethylene glycol)-poly(propylene glycol)-poly(ethylene glycol) block polymer (also known as PEG-PPG-PEG block polymer), about 50 grams acetic acid, and about 50 grams ethylene glycol was added. The mixture was placed into a container, sealed, and heated in an oven at about 90° C. for about 43 hr. The resulting wet gel was then placed in a tube furnace and pyrolized under a nitrogen atmosphere at a temperature of about 900° C. for about 2 hr. The pore volume of the resulting pyrolized product was about 0.25 cm³/g and the average pore size distribution was about 20 nm.

### Example 17

In Example 17, a wet gel containing metal powder was made and pyrolized to produce a pyrolized product.

### Example 18

### Wet Gel

In Example 18, a wet gel was produced according to the following procedure. A prepolymer was made according to the preparation described above for Examples 1-15. A mixture containing about 1.4 grams of maleic anhydride, about 0.6 grams of citric acid, about 30.5 grams of acetic acid, and about 2.3 grams of PEG-PPG-PEG block polymer was added to about 15.2 grams of the prepolymer. The mixture was placed into a container, sealed, and heated in an oven at about 85° C. for about 48 hr to produce a wet gel.

### Example 19

### Pyrolized Carbon

In Example 19, a pyrolized carbon product was produced according to the following procedure. A wet gel was made according to the preparation described above for Example 18. The wet gel was placed in a tube furnace and pyrolized under a nitrogen atmosphere at a temperature of about 900° C. for about 1 hr. The pore volume of the resulting pyrolized product was about 1.4 cm³/g and the average pore size was about 12 nm.

### Example 20

### Wet Gel

In Example 20, a wet gel was produced according to the following procedure. A prepolymer was made according to the preparation described above for Examples 1-15. A mixture containing about 2.6 grams of maleic anhydride, about 1.2 grams of citric acid, and about 17.3 grams of acetic acid was added to about 28.9 grams of the prepolymer. The mixture was placed into a container, sealed, and heated in an oven at about 85° C. for about 48 hr to produce a wet gel.

### Example 21

### Pyrolized Carbon

In Example 21, a pyrolized carbon product was produced according to the following procedure. A wet gel was made according to the preparation described above for Example 20. The wet gel was placed in a tube furnace and pyrolized under a nitrogen atmosphere at a temperature of about 900° C. for about 1 hr. The pore volume of the resulting pyrolized product was about 0.5 cm³/g and the average pore size was about 5 nm.

### Examples 22-40

### Carbon Activation by Carbon Dioxide

In Examples 22-40, activated carbon products were produced according to the following procedure. For Examples 22-30, pyrolized carbon products were made according to the preparation described above for Example 19. For Examples 31-40, pyrolized carbon products were made according to the preparation described above for Example 21. The pyrolized carbon products were placed in a tube furnace and heated under an atmosphere of carbon dioxide at the specified temperatures for the specified times listed below in Table 3. The specific surface area (SSA), the pore volume (PV), and the average pore size (APS) were measured for the activated carbon products in Examples 22-40 and are listed below in Table 3.

TABLE 3
Activated carbon products by CO₂

| Ex. | Temp* | Time* | SSA | PV | APS |
|---|---|---|---|---|---|
| No. | (° C.) | (hr) | (m²/g) | (cm³/g) | (nm) |
| 22 | 700 | 12 | 611 | 0.84 | 6.2 |
| 23 | 700 | 20 | n/a | n/a | n/a |
| 24 | 900 | 10 | 1054 | 1.72 | 6.5 |
| 25 | 900 | 20 | 2566 | 2.43 | 3.8 |
| 26 | 1050 | 10 | n/a | n/a | n/a |
| 27 | 1050 | 4 | n/a | n/a | n/a |
| 28 | 1050 | 2.3 | n/a | n/a | n/a |
| 29 | 1050 | 1 | 2766 | 3.97 | 5.7 |
| 30 | 1050 | 1.5 | 3299 | 5.02 | 6.1 |
| 31 | 700 | 12 | 537 | 0.52 | 3.9 |
| 32 | 700 | 20 | n/a | n/a | n/a |
| 33 | 900 | 10 | 1115 | 0.89 | 2.9 |
| 34 | 900 | 20 | 1569 | 1.15 | 3.2 |
| 35 | 1050 | 10 | n/a | n/a | n/a |
| 36 | 1050 | 4 | n/a | n/a | n/a |
| 37 | 1050 | 2.3 | n/a | n/a | n/a |
| 38 | 1050 | 1 | 1608 | 1.21 | 3.0 |
| 39 | 1050 | 1.5 | 2234 | 1.71 | 3.1 |
| 40 | 1050 | n/a | n/a | n/a | n/a |

*Note:
The actual values of the listed temperature and time may have a deviation of about ±25° C. and about ±0.25 hr.

### Examples 41A-72B

### Carbon Activation by Various Activating Agents

In Examples 41A-72B, activated carbon products were produced according to the following procedure. For Examples 41A-68B, pyrolized carbon products were made according to the preparation described above for Example 19. For Examples 69A-72B, wet gels were made according to the preparation described above for Example 18. The activating agents used in Examples 41A-72B were potassium hydroxide (KOH), potassium carbonate (K₂CO₃), calcium chloride (CaCl₂), and phosphoric acid (H₃PO₄), as specifically indicated for each example listed below in Table 4. For each Example 41A-68B, the pyrolized carbon product and the activating chemical agent were combined at the specified weight ratio (pyrolized carbon product weight to activating agent weight, as listed as “C:AA” in Table 4) and agitated to produce a mixture. For each Example 69A-72B, the wet gel and the activating agent were combined at the specified weight ratio (wet gel weight to activating agent weight, also listed as “C:AA” in Table 4) and agitated to produce a mixture. The pyrolized carbon and activating agent mixtures (Examples 41A-68B) and the wet gel and activating agent mixtures (Examples 69A-72B) were heated in an oven until dried, generally, at a temperature of about 50° C. to about 200° C. (e.g., about 110° C.) for about 6 hr to about 48 hr (e.g., about 18 hr). Each dried mixture was weighed and placed in a sample boat, then placed in a tube furnace and heated under an atmosphere of nitrogen at the specified temperature for the specified time, as listed below in Table 4 for each Example 41A-72B, to produce activated carbon products. For Examples 61A-64B, the samples were initially ramp to a temperature of about 800° C. over a period of about 45 min prior to maintaining the samples at about 800° C. for about 4 hrs. For Examples 65A-68B, the samples were initially ramp to a temperature of about 800° C. over a period of about 160 min prior to maintaining the samples at about 800° C. for about 4 hrs.

For the “A” Examples (Examples 41A-72A), no further treatment was performed to the samples. The specific surface area (SSA), the pore volume (PV), and the average pore size (APS) were measured for the activated carbon products in Examples 41A-72A, as listed below and labeled as “Non-Treated” in Table 4.

For the “B” Examples (Examples 41B-72B), the activated carbon products and hydrochloric acid (having a normality of about 0.1 N to about 1 N of HCl) were combined and agitated until well mixed, such as for several minutes. The liquid was decanted. Subsequently, deionized water was added to the activated carbon products and placed in a sonication bath for about 10 min to about 30 min (e.g., about 15 min). The liquid was then decanted and fresh deionized water was added to the activated carbon products and followed by another sonication. This cycle of adding deionized water, sonicating, and decanting was repeated for a total of three completed cycles. The solid (e.g., activated carbon products) was rinsed with fresh deionized water on a fritted funnel under vacuum until pH of the eluate reached neutral (e.g., pH of about 7). The wet solid samples were heated in an oven until dried, generally, at a temperature of about 50° C. to about 200° C. (e.g., about 110° C.) for about 6 hr to about 48 hr (e.g., about 18 hr), for each Example 41B-72B.

TABLE 4
Activated carbon products by Activating Agents

| | | | | | “A” Examples | | | “B” Examples | | |
|---|---|---|---|---|---|---|---|---|---|---|
| | | | | | 41A-72A | | | 41B-72B | | |
| | | Wt. | | | (Non-Treated) | | | (Treated) | | |
| Ex. | Activating | Ratio | Temp | Time | SSA | PV | APS | SSA | PV | APS |
| No. | Agent | (C:AA) | * (° C.) | * (hr) | (m²/g) | (cm³/g) | (nm) | (m²/g) | (cm³/g) | (nm) |
| 41A, B | KOH | 1:1 | 1050 | 1 | 158 | 0.29 | 7.2 | 1478 | 1.00 | 2.7 |
| 42A, B | K₂CO₃ | 1:1 | 1050 | 1 | 744 | 0.76 | 4.1 | 939 | 0.65 | 2.8 |
| 43A, B | CaCl₂ | 1:1 | 1050 | 1 | 269 | 0.41 | 6.1 | 374 | 0.32 | 3.4 |
| 44A, B | H₃PO₄ | 1:1 | 1050 | 1 | 462 | 0.56 | 4.9 | 515 | 0.40 | 3.1 |
| 45A, B | KOH | 1:1 | 1050 | 2 | 386 | 1.29 | 13.7 | 1392 | 1.54 | 4.4 |
| 46A, B | K₂CO₃ | 1:1 | 1050 | 2 | 1057 | 0.78 | 2.9 | 1082 | 1.10 | 4.1 |
| 47A, B | CaCl₂ | 1:1 | 1050 | 2 | 210 | 0.72 | 14 | 294 | 0.30 | 4.1 |
| 48A, B | H₃PO₄ | 1:1 | 1050 | 2 | 425 | 0.70 | 6.600 | 441 | 0.36 | 3.3 |
| 49A, B | KOH | 1:1 | 1050 | 4 | 462 | 0.39 | 3.3 | n/a | n/a | n/a |
| 50A, B | K₂CO₃ | 1:1 | 1050 | 4 | 1002 | 1.87 | 7.5 | n/a | n/a | n/a |
| 51A, B | CaCl₂ | 1:1 | 1050 | 4 | 255 | 0.79 | 12.4 | 181 | 0.58 | 12.9 |
| 52A, B | H₃PO₄ | 1:1 | 1050 | 4 | n/a | n/a | n/a | 347 | 0.71 | 8.2 |
| 53A, B | KOH | 2:1 | 1050 | 2 | 897 | 0.89 | 4 | 2307 | 2.56 | 4.4 |
| 54A, B | K₂CO₃ | 2:1 | 1050 | 2 | n/a | n/a | n/a | 1683 | 1.16 | 2.8 |
| 55A, B | CaCl₂ | 2:1 | 1050 | 2 | 113 | 0.47 | 16.5 | 273 | 0.51 | 7.4 |
| 56A, B | H₃PO₄ | 2:1 | 1050 | 2 | 552 | 1.59 | 11.5 | 534 | 0.73 | 5.5 |
| 57A, B | KOH | 1:1 | 800 | 2 | n/a | n/a | n/a | 1581 | 1.24 | 3.1 |
| 58A, B | K₂CO₃ | 1:1 | 800 | 2 | n/a | n/a | n/a | 1080 | 0.90 | 3.3 |
| 59A, B | CaCl₂ | 1:1 | 800 | 2 | n/a | n/a | n/a | 442 | 0.62 | 5.7 |
| 60A, B | H₃PO₄ | 1:1 | 800 | 2 | n/a | n/a | n/a | 533 | 0.74 | 5.5 |
| 61A, B | KOH | 2:1 | 800 | 4 | n/a | n/a | n/a | n/a | n/a | n/a |
| 62A, B | K₂CO₃ | 2:1 | 800 | 4 | n/a | n/a | n/a | 1367 | 1.10 | 3.2 |
| 63A, B | CaCl₂ | 2:1 | 800 | 4 | n/a | n/a | n/a | 240 | 0.37 | 6.2 |
| 64A, B | H₃PO₄ | 2:1 | 800 | 4 | n/a | n/a | n/a | 444 | 0.69 | 6.2 |
| 65A, B | KOH | 2:1 | 800 | 4 | n/a | n/a | n/a | n/a | n/a | n/a |
| 66A, B | K₂CO₃ | 2:1 | 800 | 4 | n/a | n/a | n/a | 1008 | 0.74 | 2.9 |
| 67A, B | CaCl₂ | 2:1 | 800 | 4 | n/a | n/a | n/a | n/a | n/a | n/a |
| 68A, B | H₃PO₄ | 2:1 | 800 | 4 | n/a | n/a | n/a | 371 | 0.66 | 7.1 |
| 69A, B | KOH | 1:1 | 1050 | 1 | 11 | 0.02 | 6.7 | 1094 | 0.79 | 2.9 |
| 70A, B | K₂CO₃ | 1:1 | 1050 | 1 | 521 | 0.34 | 2.6 | 1435 | 0.84 | 2.3 |
| 71A, B | CaCl₂ | 1:1 | 1050 | 1 | 69 | 0.19 | 11.2 | 204 | 0.30 | 5.9 |
| 72A, B | H₃PO₄ | 1:1 | 1050 | 1 | 795 | 0.60 | 3.100 | 766 | 0.60 | 3.1 |

* Note:
The actual values of the listed temperature and time may have a deviation of about ±25° C. and about ±0.25 hr.

### Examples 73 and 74

### Adsorption Kinetics Experiments

For Example 73, a solution was prepared by combining into a container the following: about 100 mL of deionized water, about 100 ppm of phenol (based on deionized water), and about 100 mg of the activated and treated carbon products made according to the preparation described above for Example 57B. For Example 74, a solution was prepared by combining into a container the following: about 100 mL of deionized water, about 100 ppm of phenol (based on deionized water), and about 100 mg of the activated and treated carbon products made according to the preparation described above for Example 39. For each Example 73 and 74, aliquots of the prepared solution were injected into a gas chromatograph (GC) at specified time intervals, as listed below in Table 5 for each aliquot (Samples 1-8). The collected GC spectra reveal the concentration of the free phenol (i.e., phenol not adsorbed by the activated carbon products) per aliquot at each specified time interval. Therefore, the percent reduction of free phenol, as listed in Table 5, relative to time provides the rate that the activated carbon products adsorbed the free phenol (e.g., kinetics of phenol adsorption).

TABLE 5
Adsorption Kinetics Data

| Ex. | Activated | Time | Sample | Phenol | Reduction | Adsorption |
|---|---|---|---|---|---|---|
| No. | Carbon | (hr) | No. | (ppm) | (%) | (mg/g) |
| 73 | Ex. 57B | 0 | 1 | 78 | 0 | 0 |
| | | 1 | 2 | 33 | 57.7 | 45.0 |
| | | 2 | 3 | 29 | 62.8 | 49.0 |
| | | 4 | 4 | 22 | 71.8 | 56.0 |
| | | 6 | 5 | 26 | 66.7 | 52.0 |
| | | 8 | 6 | 23 | 70.5 | 55.0 |
| | | 28 | 7 | 20 | 74.4 | 58.0 |
| | | 31 | 8 | 19 | 75.6 | 59.0 |
| 74 | Ex. 39 | 0 | 1 | 78 | 0.0 | 0.0 |
| | | 1 | 2 | 22 | 71.8 | 56.0 |
| | | 2 | 3 | 21 | 73.1 | 57.0 |
| | | 4 | 4 | 17 | 78.2 | 61.0 |
| | | 6 | 5 | 19 | 75.6 | 59.0 |
| | | 8 | 6 | 19 | 75.6 | 59.0 |
| | | 28 | 7 | 15 | 80.8 | 63.0 |
| | | 31 | 8 | 14 | 82.1 | 64.0 |

### Examples 75 and 76

### Adsorption Capacity Experiments

For Example 75, a solution was prepared by combining into a container the following: about 100 mL of deionized water, about 500 ppm of phenol (based on deionized water), and about 100 mg of the activated and treated carbon products made according to the preparation described above for Example 57B. For Example 76, a solution was prepared by combining into a container the following: about 100 mL of deionized water, about 500 ppm of phenol (based on deionized water), and about 100 mg of the activated and treated carbon products made according to the preparation described above for Example 39. For each Example 75 and 76, aliquots of the prepared solution were injected into the GC at specified time intervals, as listed below in Table 6 for each aliquot (Ex. 75, Samples 1-5; Ex. 76, Samples 1-4). The collected GC spectra reveal the concentration of the free phenol (i.e., phenol not adsorbed by the activated carbon products) per aliquot at each specified time interval. The maximum adsorption of phenol the activated carbon products was measured at about 148 mg/g for Ex. 75, Sample 4 and about 149 mg/g for Ex. 76, Sample 3, where the adsorption is based on the milligrams of phenol adsorbed by the grams of activated carbon products.

TABLE 6
Adsorption Capacity Data

| Ex. | Activated | Time | Sample | Phenol | Reduction | Adsorption |
|---|---|---|---|---|---|---|
| No. | Carbon | (hr) | No. | (ppm) | (%) | (mg/g) |
| 75 | Ex. 57B | 0 | 1 | 493 | 0 | 0 |
| | | 1 | 2 | 418 | 15.2 | 75 |
| | | 18 | 3 | 401 | 18.7 | 92 |
| | | 26 | 4 | 345 | 30.0 | 148 |
| | | 42 | 5 | 397 | 19.5 | 96 |
| 76 | Ex. 39 | 0 | 1 | 493 | 0 | 0 |
| | | 2 | 2 | 376 | 23.7 | 117 |
| | | 24 | 3 | 344 | 30.2 | 149 |
| | | 30 | 4 | 387 | 21.5 | 106 |

### Example 77

### Wet Gel

In Example 77, a wet gel was produced according to the following procedure. A prepolymer was made according to the preparation described above for Examples 1-15. A mixture containing about 1.5 grams of maleic anhydride, about 1.5 grams of resorcinol, and about 50 grams of acetic acid was added to about 50 grams of the prepolymer. The mixture was placed into a container, sealed, and heated in an oven at about 85° C. for about 48 hr to produce a wet gel.

### Example 78

### Pyrolized Carbon

In Example 78, a pyrolized carbon product was produced according to the following procedure. A wet gel was made according to the preparation described above for Example 77. About 15 g of the wet gel was added to about 150 g of preheated Flint Hills Base Oil 100-HC at about 95° C. and being stirred. After resin particles were formed, the mixture was further cured at about 85° C. for about 4 days. The oil was removed from the solid sample by centrifuge. The remaining resin particles were heated at about 900° C. for about 1 hr under nitrogen to produce the pyrolized carbon product.

### Example 79

### Carbon Activation by Carbon Dioxide

In Example 79, the activated carbon product was produced according to the following procedure. The pyrolized carbon product was made according to the preparation described above for Example 78. The pyrolized carbon product was placed in a tube furnace and heated under an atmosphere of carbon dioxide at about 900° C. for about 2 hr.

### Example 80

### Wet Gel

In Example 80, a wet gel was produced according to the following procedure. A prepolymer was made according to the preparation described above for Examples 1-15. A mixture containing about 2.6 grams of maleic anhydride, about 1.2 grams of citric acid, and about 17.3 grams of acetic acid was added to about 28.9 grams of the prepolymer. The mixture was placed into a container, sealed, and heated in an oven at about 85° C. for about 48 hr to produce a wet gel.

### Example 81

### Pyrolized Carbon

In Example 81, a pyrolized carbon product was produced according to the following procedure. A wet gel was made according to the preparation described above for Example 80. About 15 g of the wet gel was added to about 150 g of preheated Flint Hills Base Oil 100-HC at about 95° C. and being stirred. After resin particles were formed, the mixture was further cured at about 85° C. for about 4 days. The oil was removed from the solid sample by centrifuge. The remaining resin particles were heated at about 900° C. for about 1 hr under nitrogen to produce the pyrolized carbon product.

### Example 82

### Carbon Activation by Carbon Dioxide

In Example 82, the activated carbon product was produced according to the following procedure. The pyrolized carbon product was made according to the preparation described above for Example 81. The pyrolized carbon product was placed in a tube furnace and heated under an atmosphere of carbon dioxide at about 900° C. for about 15 hr.

### Electrochemical Testing (ECT) Experiments

Examples 79 and 82 were submitted to ECT testing. The ECT data was measured, as listed in below Table 7. The ECT protocol is provided below.

TABLE 7
ECT Data

| | | Actual | Max. | Freq. | Grav. | | | Electrode Comp |
|---|---|---|---|---|---|---|---|---|
| Ex. | | Vol. Cap. | Theor. Cap. | Resp. | Cap. | R1 | R2 | (AM:CE:B - |
| No. | Decode | (F/cc) | (F/cc) | (Hz) | (F/g) | (ohm) | (ohm) | wt ratio) |
| 79 | energy | 24.7 | 25.7 | 0.57 | 114.2 | 3.92 | 2.44 | 92:5:3 |
| | carbon | | | | | | | |
| 82 | power | 15.7 | 15.0 | 1.03 | 122.5 | 2.09 | 3.06 | 94:0:6 |
| | carbon | | | | | | | |

### ECT Experiments

### Electrode Fabrication and Coin Cell Assembly

Carbon was blended with polytetrafluoroethylene tape and a conductivity enhancer in a 92:3:5 ratio and then roll pressed into a 50 micron thick electrode sheet. Individual electrodes were “punched” out of the sheet (⅝″) and grouped into similarly massed pairs. Coin cells (of size 2325) were assembled with a carbon coated current collector, acetonitrile electrolyte, separator (NKK), electrodes, spring and spacer as well as positive and negative caps (with a grommet) inside an argon atmosphere glove box. A VMP3 machine was used and the constructed cells were tested according to the galvanostatic testing protocol described below:

### Ultracap-Galvanostatic Test

This protocol was developed as a charge and discharge test performed at different current rates of 1 mA, 5 mA, 10 mA, 25 mA, 50 mA, and 100 mA. These current values were calculated from ¾″ coin cells, and can be quantified based on the footprint area of the cell. For example, for pouch cell electrodes with the dimension of 3.6 cm×2.6 cm the current rates are calculated by a factor of 4 mA (4 mA, 20 mA, 40 mA, 100 mA, 200 mA, and 400 mA). It is a baseline test for ultra-capacitor carbons as run in the coin cell system. This test can be used to calculate capacitance and resistance at different currents. This test included the following sequences: (1) Sequences 1 and 2 were conditioning sequences; and (2) Sequences 3 through 8 were 2.7 V charge/discharge sequences.

The reason for choosing these values for voltage and current were mainly due to meeting desired product specifications and thus validating the product. Upper voltage limits of 2.7 V and 3 V were chosen to meet the specifications of commercial products. The lower voltage limit, however, was slightly over 0 voltage (0.1 V) to avoid changing polarity of anode and cathode by forcing ions to transfer in the opposite direction.

The baseline test started with conditioning, which was designed for preparing cells to become fully charged and discharged in proper timing manner. By conditioning, ions were placed and migrated to carbon surface structure and thus facilitated charging and discharging.

Before starting to condition, the cell was held at open circuit voltage (OCV) for 10 seconds. For conditioning, the cell was subjected to two sequences of charging to 2.7 V, holding for 2 minutes, and discharging to 0.1 V at current rates of 1 mA and 10 mA for sequence 1 and 2 respectively.

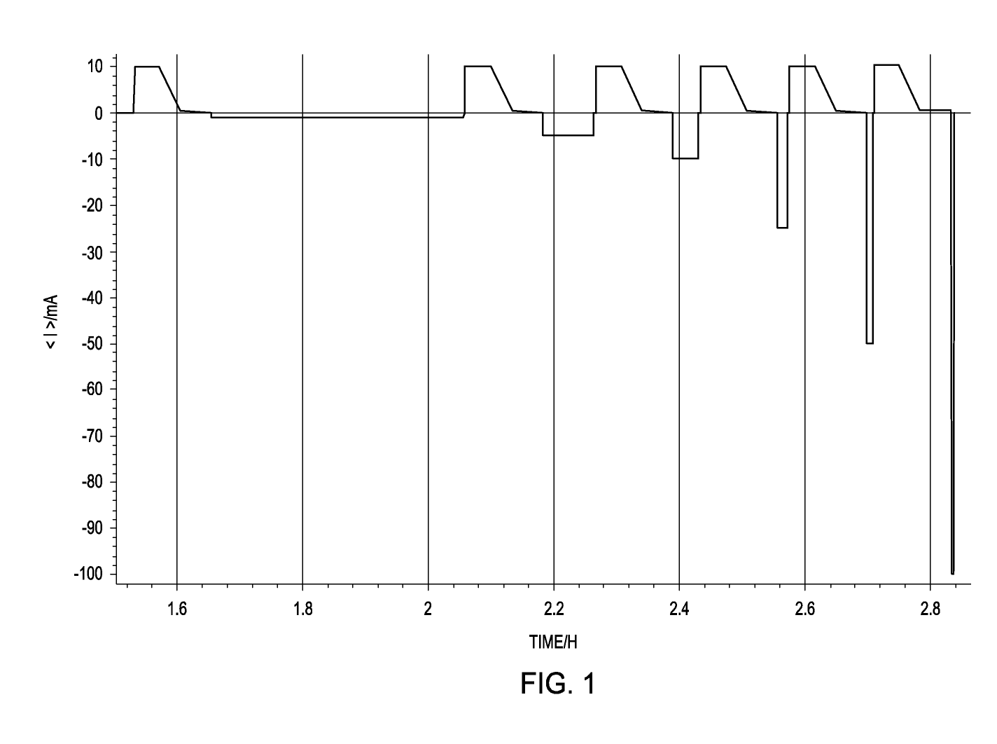

After conditioning, the baseline test was developed to calculate capacitance and resistance of electrochemical cells. These sequences of charge/discharge were at different current rates, which were increased sequentially to examine the electrochemical responses at different conditions. The test started with holding each cell at OCV for 10 seconds and then charging at a current rate of 1 mA to 2.7 V, holding for 2 minutes, and discharging to 0.1 V. Following sequence three, from sequence 4 to sequence 8 current rates were increased from 5 mA to 10 mA, 25 mA, 50 mA, and 100 mA, respectively, with the same protocol as sequence three, shown in FIG. 1: Galvanostatic test for sequences 3 to 8, plotted current vs. time.

### Ultracap-Cyclic Voltammetry Test

### Cyclic Voltammetry (CV)

The CV test was used to analyze electrolyte breakdown, voltage window, and capacitance. The characteristics of the CV curve represent the ionic conductivity and electrochemical performance of electrodes.

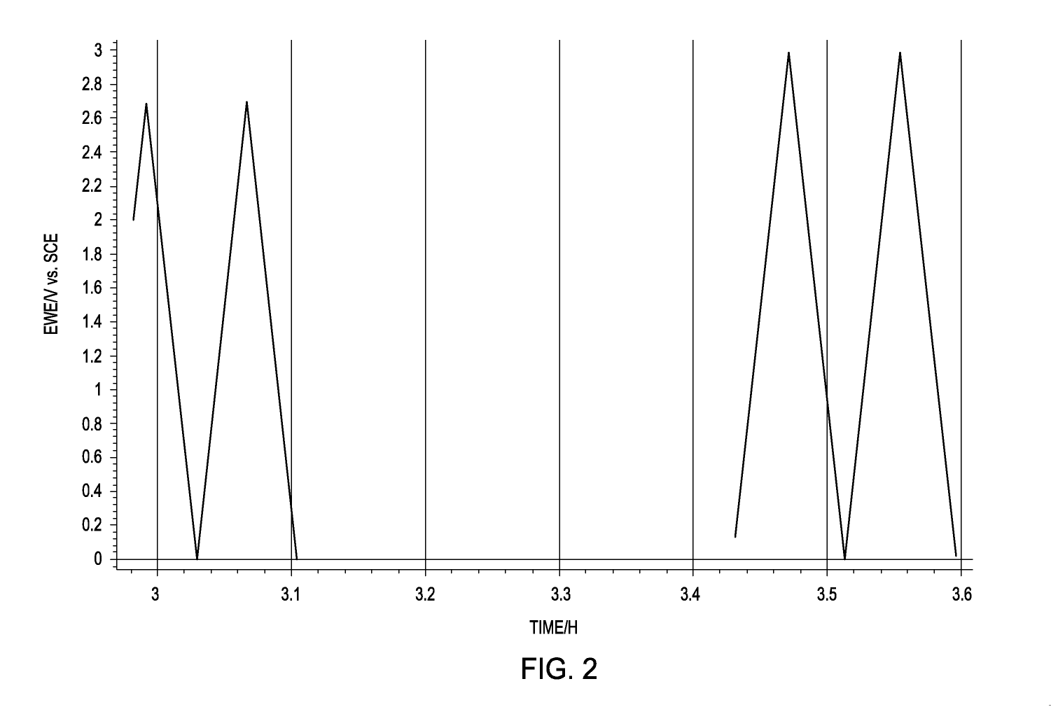

From the CV test, the capacitance was calculated from the area under the CV curve where the voltage range was 2.43 V to 1.89 V, based on IUPAC standard (90% of upper voltage limit and 70% of lower voltage limit). For higher voltage (more than 3 Volt) applications, the CV curve would be deformed because of degrading of electrolyte and thus would not representing real values of capacitance and ESR. The test started with a scan rate of 20 mV/s from 0 V to 2.7 V and the next cycle was recorded with the same scan rate but up to 3 V. FIG. 2 depicts an experimental plot of voltage versus time for 2.7 V and 3 V from a cyclic voltammetry experiment. The graph shows CV tests for 2.7 V and 3 V with each one and half cycles.

### Capacitance (C)

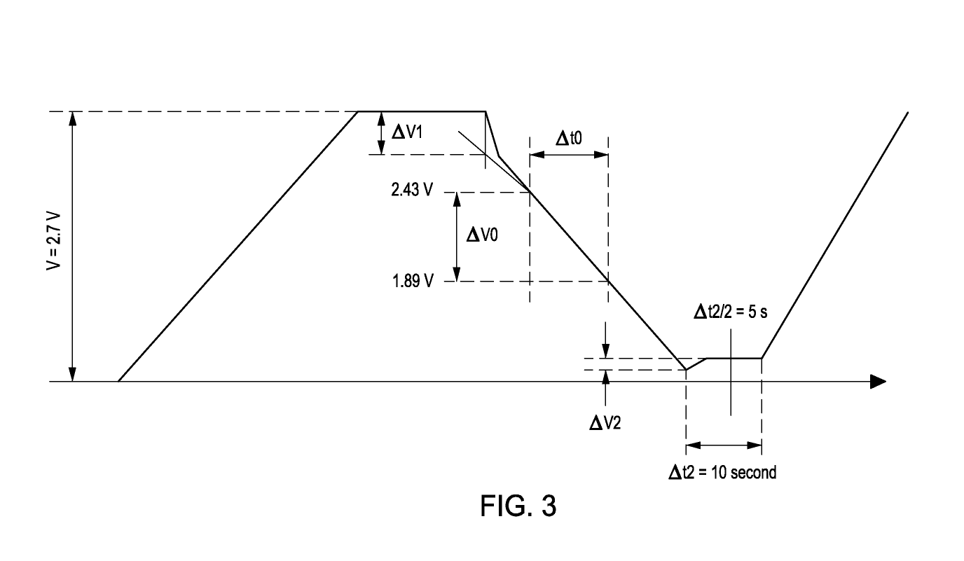

The capacitance calculation was based on the product of changing time (from 2.43 volt to 1.89 volt) for each discharge cycle and the discharge current (I). Then, the actual capacitance was considered at a current density of 0.5 A/g. The formula was C=Δt0*I/ΔV0, which also follows the graph of FIG. 3 that depicts an experimental plot of a charge and discharge cycle according to an ultra-capacitor setting profile ΔV0.

### Capacitance and Resistance Calculation for Ultra-Capacitors

### IR Drop (R1)

According to the graph shown in FIG. 3, the changing voltage (ΔV1), the difference between the cut-off charge-voltage (V=2.7 volt) and the intersection point of a tangent line of the discharge plot and a perpendicular line of the starting voltage of the IR drop, was divided by discharge current (I). Then the actual measurement was considered at the current density of 0.5 A/g. The formula was R1=ΔV1/I.

### Voltage Relaxation (R2)

Based on the graph shown in FIG. 3, the changing voltage (ΔV2), was the difference between cut-off discharge-voltage and the voltage at 5-second open-circuit voltage, divided by discharge current. The actual calculation was taken from the current density of 0.5 A/g. The formula was R2=ΔV2/I.

### Ultracap AC Impedance Spectroscopy (EIS)

EIS test for an ultracapacitor was:
Voltage was set at 2V
Voltage was perturbed between 2.005V and 1.995V at different frequencies
Frequency sweeps from 400 kHz to 10 mHz
Nyquist plots and Bode Plots were generated from this data
   Nyquist plots are the real component of impedance on the x-axis and imaginary component of impedance on the y-axis
   Bode plots are the log of the frequency on the x-axis, the log of the impedance on the y₁-axis and the phase angle on the y₂-axis

Embodiments of the present disclosure further relate to any one or more of the following paragraphs:

1. A method for making activated carbon products, comprising: combining a hydroxybenzene compound, an aldehyde compound, and a solvent to produce a prepolymer reaction mixture; reacting the hydroxybenzene compound and the aldehyde compound to produce a prepolymer; combining the prepolymer and one or more additives to produce a wet gel reaction mixture, wherein the additive comprises a carboxylic acid, an anhydride, a homopolymer, a copolymer, or any mixture thereof; reacting the prepolymer and the at least one additive to produce the wet gel product; drying the wet gel product at a pressure below the critical pressure of the solvent to produce a dried gel product; pyrolyzing the dried gel product to produce a pyrolized product; and activating the pyrolized product to produce an activated carbon product, wherein the activated carbon product has at least one property selected from the group consisting of a specific surface area of about 100 m²/g to about 7,000 m²/g, a pore volume of about 0.2 cm³/g to about 10 cm³/g, and an average pore size of about 0.5 nm to about 150 nm.

2. A method for making activated carbon products, comprising: combining a hydroxybenzene compound, an aldehyde compound, and a solvent to produce a prepolymer reaction mixture; reacting the hydroxybenzene compound and the aldehyde compound to produce a prepolymer; combining at least the prepolymer, a carboxylic acid, and an anhydride to produce a wet gel reaction mixture; reacting the prepolymer, the carboxylic acid, and the anhydride to produce a wet gel product; drying the wet gel product to produce a dried gel product; pyrolyzing the dried gel product to produce a pyrolized product; and activating the pyrolized product to produce an activated carbon product, wherein the activated carbon product has at least one property selected from the group consisting of: a specific surface area of about 100 m²/g to about 7,000 m²/g, a pore volume of about 0.2 cm³/g to about 10 cm³/g, and an average pore size of about 0.5 nm to about 150 nm.

3. A method for making activated carbon products, comprising: combining a solvent, a hydroxybenzene compound, an aldehyde compound, and an additive comprising a carboxylic acid, an anhydride, a homopolymer, a copolymer, or any mixture thereof, to produce a reaction mixture; reacting at least the hydroxybenzene compound and the aldehyde compound to produce a wet gel; drying the wet gel product at a pressure below the critical pressure of the solvent to produce a dried gel; pyrolyzing the dried gel to produce a pyrolized product; and activating the pyrolized product to produce an activated carbon product, wherein the activated carbon product has at least one property selected from the group consisting of: a specific surface area of about 100 m²/g to about 7,000 m²/g, a pore volume of about 0.2 cm³/g to about 10 cm³/g, and an average pore size of about 0.5 nm to about 150 nm.

4. A method for making activated carbon products, comprising: combining a hydroxybenzene compound, an aldehyde compound, and a solvent to produce a prepolymer reaction mixture; reacting the hydroxybenzene compound and the aldehyde compound to produce a prepolymer; combining the prepolymer and one or more additives to produce a wet gel reaction mixture, wherein the additive comprises a carboxylic acid, an anhydride, a homopolymer, a copolymer, or any mixture thereof; reacting the phenol-formaldehyde prepolymer and the at least one additive to produce the wet gel product; drying the wet gel product at a pressure below the critical pressure of the solvent to produce a dried gel product; pyrolyzing the dried gel product to produce a pyrolized product; and activating the pyrolized product to produce an activated carbon product.

5. The method according to any one of paragraphs 1 to 4, wherein the activated carbon product has a specific surface area of about 500 m²/g to about 5,000 m²/g.

6. The method according to any one of paragraphs 1 to 4, wherein the activated carbon product has a pore volume of about 0.5 cm³/g to about 8 cm³/g.

7. The method according to any one of paragraphs 1 to 4, wherein the activated carbon product has a pore volume of greater than 1 cm³/g to about 6 cm³/g.

8. The method according to any one of paragraphs 1 to 4, wherein the activated carbon product has an average pore size of about 2 nm to about 10 nm.

9. The method according to any one of paragraphs 1 to 4, wherein activating the pyrolized product to produce the activated carbon product further comprises heating the pyrolized product to a temperature of about 500° C. to about 1,500° C. in an atmosphere comprising an activating agent.

10. The method according to paragraph 9, wherein the pyrolized product is heated to a temperature of about 700° C. to about 1,200° C. for about 0.5 hr to about 48 hr.

11. The method according to paragraph 9, wherein the activating agent comprises carbon dioxide, steam, oxygen, ozone, or mixtures thereof.

12. The method according to paragraph 9, wherein the atmosphere comprising the activating agent is maintained at a pressure of about 50 kPa to about 200 kPa.

13. The method according to paragraph 9, wherein the atmosphere comprising the activating agent exerts a pressure on the pyrolized product at or below atmospheric pressure.

14. The method according to any one of paragraphs 1 to 4, wherein activating the pyrolized product to produce the activated carbon product further comprises: combining the pyrolized product and at least one activating agent to produce an activation mixture; drying the activation mixture to produce a dried activation mixture; and heating the dried activation mixture to a temperature of about 500° C. to about 1,500° C. in an atmosphere comprising an inert gas to produce an activated carbon mixture.

15. The method according to paragraph 14, wherein activating the pyrolized product to produce the activated carbon product further comprises: treating the activated carbon mixture with an acidic solution to produce a treated activated carbon mixture; rinsing the treated activated carbon mixture with water; and drying the treated activated carbon mixture to produce the activated carbon product.

16. The method according to paragraph 14, wherein the activating agent comprises a hydroxide, a carbonate, a metal halide, a phosphorous-containing acid, a sulfur-containing acid, salts thereof, or any mixture thereof.

17. The method according to paragraph 14, wherein the activating agent comprises an alkali metal hydroxide, an alkaline earth hydroxide, an alkali metal carbonate, an alkaline earth carbonate, carbonic acid, sulfuric acid, phosphoric acid, an alkali metal phosphate, an alkaline earth phosphate, phosphorous acid, an alkali metal phosphite, an alkaline earth phosphite, hypophosphorous acid, an alkali metal hypophosphite, an alkaline earth hypophosphite, a calcium halide, a zinc halide, salts thereof, acids thereof, or any mixture thereof.

18. The method according to paragraph 14, wherein the activating agent comprises phosphoric acid, potassium carbonate, potassium hydroxide, calcium chloride, zinc chloride, salts thereof, acids thereof, or any mixture thereof.

19. The method according to paragraph 14, wherein the pyrolized product and the activating agent are combined at a pyrolized product to activating agent weight ratio of about 1:1 to about 5:1.

20. The method according to paragraph 14, wherein the pyrolized product and the activating agent are combined at a pyrolized product to activating agent weight ratio of about 1:1 to about 2:1.

21. The method according to any one of paragraphs 1 to 4, further comprising combining one or more activating agents with the wet gel product, the dried gel product, or the pyrolized product, wherein the activating agents react with the pyrolized product to produce the activated carbon product.

22. The method according to any one of paragraphs 1 to 4, wherein the at least one additive comprises a carboxylic acid, an anhydride, a homopolymer, a copolymer, or any mixture thereof.

23. The method according to paragraph 22, wherein the at least one additive comprises one or more carboxylic acids and one or more anhydrides.

24. The method according to paragraph 22, wherein the at least one additive comprises one or more carboxylic acids and one or more anhydrides, and wherein the one or more carboxylic acids comprise acetic acid and citric acid and the one or more anhydrides comprise maleic anhydride.

25. The method according to paragraph 22, wherein the at least one additive comprises one or more carboxylic acids and one or more anhydrides, and wherein the at least one additive comprises one or more homopolymers or one or more copolymers.

26. The method according to paragraph 22, wherein the at least one additive comprises one or more carboxylic acids and one or more anhydrides, wherein the at least one additive comprises one or more homopolymers or one or more copolymers, and wherein the one or more homopolymers or the one or more copolymers independently comprises poly(ethylene glycol), poly(propylene glycol), or any mixture thereof.

27. The method according to paragraph 22, wherein the at least one additive comprises one or more carboxylic acids and one or more anhydrides, wherein the at least one additive comprises one or more homopolymers or one or more copolymers, and wherein the at least one additive comprises poly(ethylene glycol)-poly(propylene glycol)-poly(ethylene glycol) block polymer.

28. The method according to paragraph 22, wherein the at least one additive comprises one or more carboxylic acids and one or more anhydrides, wherein the at least one additive comprises one or more homopolymers or one or more copolymers, and wherein the at least one additive comprises acetic acid, citric acid, and maleic anhydride.

29. The method according to paragraph 22, wherein the at least one additive comprises one or more carboxylic acids and one or more anhydrides, wherein the at least one additive comprises one or more homopolymers or one or more copolymers, and wherein the at least one additive comprises acetic acid, citric acid, maleic anhydride, and a poly(ethylene glycol)-poly(propylene glycol)-poly(ethylene glycol) block polymer.

30. The method according to any one of paragraphs 1 to 4, wherein the prepolymer reaction mixture comprises about 50 wt % to about 90 wt % of the hydroxybenzene compound and about 10 wt % to about 50 wt % of the aldehyde compound, based on the combined weight of the hydroxybenzene compound and the aldehyde compound.

31. The method according to any one of paragraphs 1 to 4, wherein the wet gel reaction mixture comprises about 10 wt % to about 80 wt % of the phenol-formaldehyde prepolymer, up to about 85 wt % of a carboxylic acid, up to about 20 wt % of an anhydride compound, up to about 30 wt % of the homopolymer, and up to about 30 wt % of the copolymer, wherein the wet gel reaction mixture comprises about 10 wt % to about 90 wt % of the additive, and wherein all weight percent values are based on the combined weight of the hydroxybenzene compound, the aldehyde compound, and the one or more additives.

32. The method according to any one of paragraphs 1 to 4, wherein pyrolyzing the dried gel product to produce the pyrolized product further comprises heating the dried gel product to a temperature of about 500° C. to about 1,400° C. in an atmosphere comprising an inert gas.

33. The method according to any one of paragraphs 1 to 4, wherein the pressure maintained on the wet gel product during the drying to produce the dried gel product is at or below atmospheric pressure.

34. The method according to any one of paragraphs 1 to 4, wherein the dried gel product has at least one property selected from the group consisting of: a specific surface area of about 50 m²/g to about 5,000 m²/g, a pore volume of about 0.1 cm³/g to about 10 cm³/g, and an average pore size of about 0.2 nm to about 150 nm.

35. A method for making pyrolized carbon products, comprising: combining a hydroxybenzene compound, an aldehyde compound, and a solvent to produce a prepolymer reaction mixture; reacting the hydroxybenzene compound and the aldehyde compound to produce a prepolymer; combining the prepolymer and one or more additives to produce a wet gel reaction mixture, wherein the additive comprises a carboxylic acid, an anhydride, a homopolymer, a copolymer, or any mixture thereof; reacting the prepolymer and the at least one additive to produce the wet gel product; drying the wet gel product at a pressure below the critical pressure of the solvent to produce a dried gel product; and pyrolyzing the dried gel product to produce pyrolized carbon products.

36. A method for making a wet gel product, comprising: combining a hydroxybenzene compound, an aldehyde compound, and a solvent to produce a prepolymer reaction mixture, wherein the prepolymer reaction mixture comprises about 50 wt % to about 90 wt % of the hydroxybenzene compound and about 10 wt % to about 50 wt % of the aldehyde compound, based on the combined weight of the hydroxybenzene compound and the aldehyde compound; reacting the hydroxybenzene compound and the aldehyde compound to produce a prepolymer; combining the prepolymer and one or more additives to produce a wet gel reaction mixture, wherein the wet gel reaction mixture comprises about 10 wt % to about 80 wt % of the prepolymer, up to about 85 wt % of a carboxylic acid, up to about 20 wt % of an anhydride compound, up to about 30 wt % of the homopolymer, and up to about 30 wt % of the copolymer, wherein the wet gel reaction mixture comprises about 10 wt % to about 90 wt % of the additive, and wherein all weight percent values are based on the combined weight of the hydroxybenzene compound, the aldehyde compound, and the one or more additives; and reacting the phenol-formaldehyde prepolymer and the one or more additives to produce the wet gel product.

37. The method according to paragraph 36, wherein the hydroxybenzene compound comprises phenol, resorcinol, cresol, catechol, hydroquinone, phloroglucinol, or any mixture thereof.

38. The method according to paragraph 36, wherein the aldehyde compound comprises formaldehyde, acetaldehyde, propionaldehyde, butyraldehyde, furfuraldehyde, glucose, benzaldehyde, and cinnamaldehyde, or any mixture thereof.

39. Activated carbon products, comprising: a specific surface area of at least 3,050 m²/g to about 7,000 m²/g; a pore volume of about 3 cm³/g to about 10 cm³/g; and an average pore size of about 0.5 nm to about 150 nm.

40. The activated carbon products according to paragraph 39, wherein the specific surface area is about 3,200 m²/g to about 5,000 m²/g.

41. The activated carbon products according to paragraph 39, wherein the pore volume is about 4 cm³/g to about 8 cm³/g.

42. The activated carbon products according to paragraph 41, wherein the pore volume is about 5.01 cm³/g to about 8 cm³/g, and the specific surface area is greater than 3,200 m²/g to about 5,000 m²/g.

43. The activated carbon products according to paragraph 39, wherein the average pore size is about 2 nm to about 10 nm.

44. The activated carbon products according to paragraph 39, wherein the activated carbon products comprise at least 99 wt % of carbon.

45. An activated carbon product, comprising: a specific surface area of at least 2,500 m²/g to about 7,000 m²/g; a pore volume of about 1 cm³/g to about 10 cm³/g; and an average pore size of about 0.5 nm to about 150 nm.

46. An activated carbon product, comprising: a specific surface area of at least 3,050 m²/g to about 7,000 m²/g; a pore volume of about 3 cm³/g to about 10 cm³/g; and an average pore size of about 0.5 nm to about 150 nm.

47. The activated carbon product according to paragraph 45 or 46, wherein the specific surface area is about 3,200 m²/g to about 5,000 m²/g.

48. The activated carbon product according to any one of paragraphs 45 to 47, wherein the pore volume is about 4 cm³/g to about 8 cm³/g.

49. The activated carbon product according to any one of paragraphs 45 to 48, wherein the pore volume is about 5.01 cm³/g to about 8 cm³/g, and the specific surface area is greater than 3,200 m²/g to about 5,000 m²/g.

50. The activated carbon product according to any one of paragraphs 45 to 49, wherein the average pore size is about 2 nm to about 10 nm.

51. The activated carbon product according to any one of paragraphs 45 to 50, wherein: the pore volume is about 5.01 cm³/g to about 8 cm³/g, the specific surface area is greater than 3,200 m²/g to about 5,000 m²/g, the average pore size is about 2 nm to about 10 nm, and the activated carbon product has a carbon content of at least 99 wt %.

52. A method for making an activated carbon product, comprising: reacting a hydroxybenzene compound and an aldehyde compound in the presence of a solvent to produce a prepolymer; combining the prepolymer and an additive to produce a wet gel reaction mixture, wherein the additive comprises a carboxylic acid, an anhydride, a homopolymer, a copolymer, or any mixture thereof; reacting the prepolymer and the additive to produce a wet gel product; drying the wet gel product at a pressure below a critical pressure of the solvent to produce a dried gel product; pyrolyzing the dried gel product to produce a pyrolized product; and activating the pyrolized product to produce an activated carbon product, wherein the activated carbon product has at least one property selected from the group consisting of: a specific surface area of about 100 m²/g to about 7,000 m²/g, a pore volume of about 0.2 cm³/g to about 10 cm³/g, and an average pore size of about 0.5 nm to about 150 nm.

53. The method according to paragraph 52, wherein the specific surface area is about 500 m²/g to about 5,000 m²/g.

54. The method according to paragraph 52 or 53, wherein the pore volume is greater than 1 cm³/g to about 6 cm³/g.

55. The method according to any one of paragraphs 52 to 54, wherein the average pore size is about 2 nm to about 10 nm.

56. The method according to any one of paragraphs 52 to 55, wherein: the specific surface area is at least 3,050 m²/g to about 7,000 m²/g, the pore volume is about 3 cm³/g to about 10 cm³/g, and the average pore size is about 0.5 nm to about 150 nm.

57. The method according to any one of paragraphs 52 to 56, wherein: pore volume is about 5.01 cm³/g to about 8 cm³/g, the specific surface area is greater than 3,200 m²/g to about 5,000 m²/g, the average pore size is about 2 nm to about 10 nm, and the activated carbon product has a carbon content of at least 99 wt %.

58. The method according to any one of paragraphs 52 to 57, wherein: the pyrolized product is heated to a temperature of about 700° C. to about 1,500° C. for about 0.5 hours to about 48 hours in an atmosphere comprising an activating agent to produce the activated carbon product, the activating agent comprises carbon dioxide, steam, oxygen, ozone, or any mixture thereof, and the atmosphere comprising the activating agent is maintained at a pressure of about 50 kPa to about 200 kPa.

59. The method according to any one of paragraphs 52 to 58, wherein: the pyrolized product and an activating agent are combined to produce an activation mixture, the activating agent comprises a hydroxide, a carbonate, a metal halide, a phosphorous-containing acid, a sulfur-containing acid, salts thereof, or any mixture thereof, the activation mixture is dried to produce a dried activation mixture, and the dried activation mixture is heated to a temperature of about 500° C. to about 1,500° C. in an atmosphere comprising an inert gas to produce the activated carbon mixture.

60. The method according to any one of paragraphs 52 to 59, further comprising combining an activating agent with the wet gel product, the dried gel product, or the pyrolized product, wherein the activating agent reacts with the pyrolized product to produce the activated carbon product.

61. The method according to any one of paragraphs 52 to 60, wherein the solvent comprises water, one or more alcohols, one or more alkanes, one or more ketones, one or more aromatic hydrocarbons, or any mixture thereof, and wherein the additive comprises the carboxylic acid and the anhydride.

62. The method according to any one of paragraphs 52 to 61, wherein the additive comprises the homopolymer or the copolymer.

63. The method according to any one of paragraphs 52 to 62, wherein the wet gel reaction mixture comprises about 10 wt % to about 80 wt % of the prepolymer, up to about 85 wt % of the carboxylic acid, up to about 20 wt % of the anhydride, up to about 30 wt % of the homopolymer, and up to about 30 wt % of the copolymer, and about 10 wt % to about 90 wt % of the additive, and wherein all weight percent values are based on the combined weight of the hydroxybenzene compound, the aldehyde compound, and the additive.

64. The method according to any one of paragraphs 1-38 or 52-63, wherein the hydroxy benzene compound comprises phenol, resorcinol, or a mixture thereof.

65. The method according to any one of paragraphs 1-38 or 52-64, wherein the aldehyde compound comprises formaldehyde.

66. The method according to any one of paragraphs 1-38 or 52 to 60, or 62 to 65, wherein the solvent comprises water, one or more alcohols, one or more alkanes, one or more ketones, one or more aromatic hydrocarbons, or any mixture thereof.

67. The method according to any one of paragraphs 1-38 or 52 to 60, or 62 to 66, wherein the solvent comprises water, methanol, ethanol, propanol, t-butanol, hexane, heptane, octane, nonane, decane, acetone, benzophenone, acetophenone, 2,2-dimethyl-1,3-cyclopentanedione, tetrahydrofuran, benzene, toluene, xylene, ethylbenzene, cumene, mesitylene, or any mixture thereof.

68. The method according to any one of paragraphs 1-38 or 52 to 67, wherein the solvent is not reactive with any other component in the prepolymer reaction mixture.

69. The method according to any one of paragraphs 1, 2, 4-38 or 52 to 68, wherein the prepolymer is in liquid form at room temperature.

70. The method according to any one of paragraphs 1, 2, 4-38 or 52 to 69, wherein the prepolymer remains in liquid form at room temperature.

71. The method according to any one of paragraphs 1, 2, 4-38 or 52 to 68, wherein the prepolymer is in liquid form at room temperature and atmospheric pressure.

72. The method according to any one of paragraphs 1, 2, 4-38 or 52 to 69, wherein the prepolymer remains in liquid form at room temperature and atmospheric pressure.

73. A method for making an activated carbon product, comprising: reacting a hydroxybenzene compound and formaldehyde in the presence of a solvent to produce a prepolymer, wherein the hydroxybenzene compound comprises phenol, resorcinol, or a mixture of phenol and resorcinol, and wherein the hydroxybenzene compound is present in an amount of about 50 wt % to about 90 wt % and the formaldehyde is present in an amount of about 10 wt % to about 50 wt %, based on the combined weight of the hydroxybenzene compound and formaldehyde; combining the prepolymer, a carboxylic acid, and an anhydride to produce a wet gel reaction mixture, wherein the wet gel reaction mixture comprises about 10 wt % to about 80 wt % of the prepolymer, up to about 85 wt % of the carboxylic acid, and up to about 20 wt % of the anhydride, based on the combined weight of the hydroxybenzene compound, the formaldehyde, the carboxylic acid, and the anhydride; reacting the prepolymer, the carboxylic acid, and the anhydride to produce a wet gel product; drying the wet gel product to produce a dried gel product; pyrolyzing the dried gel product to produce a pyrolized product; and activating the pyrolized product to produce an activated carbon product, wherein the activated carbon product has at least one property selected from the group consisting of: a specific surface area of about 100 m²/g to about 7,000 m²/g, a pore volume of about 0.2 cm³/g to about 10 cm³/g, and an average pore size of about 0.5 nm to about 150 nm.

74. The method according to paragraph 73, wherein: the solvent comprises water, one or more alcohols, one or more alkanes, one or more ketones, one or more aromatic hydrocarbons, or any mixture thereof, the specific surface area is greater than 3,200 m²/g to about 5,000 m²/g, the pore volume is about 5.01 cm³/g to about 8 cm³/g, the average pore size is about 2 nm to about 10 nm, and the activated carbon product has a carbon content of at least 99 wt %.

75. The method according to paragraph 73 or 74, wherein the wet gel product is dried at a pressure below a critical pressure of the solvent to produce the dried gel product.

76. The method according to any one of paragraphs 73 to 75, wherein the solvent is not reactive with any other component in the prepolymer reaction mixture.

77. The method according to any one of paragraphs 73 to 76, wherein the prepolymer is in liquid form at room temperature.

78. The method according to any one of paragraphs 73 to 77, wherein the prepolymer remains in liquid form at room temperature.

79. The method according to any one of paragraphs 73 to 78, wherein the prepolymer is in liquid form at room temperature and atmospheric pressure.

80. The method according to any one of paragraphs 73 to 79, wherein the prepolymer remains in liquid form at room temperature and atmospheric pressure.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An activated carbon product, comprising:
a specific surface area of at least 3,050 m²/g to about 7,000 m²/g;
a pore volume of about 3 cm³/g to about 10 cm³/g; and
an average pore size of about 0.5 nm to about 150 nm.

2. The activated carbon product of claim 1, wherein the specific surface area is about 3,200 m²/g to about 5,000 m²/g.

3. The activated carbon product of claim 1, wherein the pore volume is about 4 cm³/g to about 8 cm³/g.

4. The activated carbon product of claim 1, wherein the pore volume is about 5.01 cm³/g to about 8 cm³/g, and the specific surface area is greater than 3,200 m²/g to about 5,000 m²/g.

5. The activated carbon product of claim 1, wherein the average pore size is about 2 nm to about 10 nm.

6. The activated carbon product of claim 1, wherein:
the pore volume is about 5.01 cm³/g to about 8 cm³/g,
the specific surface area is greater than 3,200 m²/g to about 5,000 m²/g,
the average pore size is about 2 nm to about 10 nm, and
the activated carbon product has a carbon content of at least 99 wt %.

7. A method for making an activated carbon product, comprising:
reacting a hydroxybenzene compound and an aldehyde compound in the presence of a solvent to produce a prepolymer;
combining the prepolymer and an additive to produce a wet gel reaction mixture, wherein the additive comprises a carboxylic acid, an anhydride, a homopolymer, a copolymer, or any mixture thereof;
reacting the prepolymer and the additive to produce a wet gel product;
drying the wet gel product at a pressure below a critical pressure of the solvent to produce a dried gel product;
pyrolyzing the dried gel product to produce a pyrolized product; and
activating the pyrolized product to produce an activated carbon product, wherein the activated carbon product has at least one property selected from the group consisting of:
a specific surface area of about 100 m²/g to about 7,000 m²/g,
a pore volume of about 0.2 cm³/g to about 10 cm³/g, and
an average pore size of about 0.5 nm to about 150 nm.

8. The method of claim 7, wherein the specific surface area is about 500 m²/g to about 5,000 m²/g.

9. The method of claim 7, wherein the pore volume is greater than 1 cm³/g to about 6 cm³/g.

10. The method of claim 7, wherein the average pore size is about 2 nm to about 10 nm.

11. The method of claim 7, wherein:
the specific surface area is at least 3,050 m²/g to about 7,000 m²/g,
the pore volume is about 3 cm³/g to about 10 cm³/g, and
the average pore size is about 0.5 nm to about 150 nm.

12. The method of claim 7, wherein:
pore volume is about 5.01 cm³/g to about 8 cm³/g,
the specific surface area is greater than 3,200 m²/g to about 5,000 m²/g,
the average pore size is about 2 nm to about 10 nm, and
the activated carbon product has a carbon content of at least 99 wt %.

13. The method of claim 7, wherein:
the pyrolized product is heated to a temperature of about 700° C. to about 1,500° C. for about 0.5 hours to about 48 hours in an atmosphere comprising an activating agent to produce the activated carbon product,
the activating agent comprises carbon dioxide, steam, oxygen, ozone, or any mixture thereof, and
the atmosphere comprising the activating agent is maintained at a pressure of about 50 kPa to about 200 kPa.

14. The method of claim 7, wherein:
the pyrolized product and an activating agent are combined to produce an activation mixture,
the activating agent comprises a hydroxide, a carbonate, a metal halide, a phosphorous-containing acid, a sulfur-containing acid, salts thereof, or any mixture thereof,
the activation mixture is dried to produce a dried activation mixture, and
the dried activation mixture is heated to a temperature of about 500° C. to about 1,500° C. in an atmosphere comprising an inert gas to produce the activated carbon mixture.

15. The method of claim 7, further comprising combining an activating agent with the wet gel product, the dried gel product, or the pyrolized product, wherein the activating agent reacts with the pyrolized product to produce the activated carbon product.

16. The method of claim 7, wherein the solvent comprises water, one or more alcohols, one or more alkanes, one or more ketones, one or more aromatic hydrocarbons, or any mixture thereof, and wherein the additive comprises the carboxylic acid and the anhydride.

17. The method of claim 7, wherein the additive comprises the homopolymer or the copolymer.

18. The method of claim 7, wherein the wet gel reaction mixture comprises about 10 wt % to about 80 wt % of the prepolymer, up to about 85 wt % of the carboxylic acid, up to about 20 wt % of the anhydride, up to about 30 wt % of the homopolymer, and up to about 30 wt % of the copolymer, and about 10 wt % to about 90 wt % of the additive, and wherein all weight percent values are based on the combined weight of the hydroxybenzene compound, the aldehyde compound, and the additive.

19. A method for making an activated carbon product, comprising:
reacting a hydroxybenzene compound and formaldehyde in the presence of a solvent to produce a prepolymer, wherein the hydroxybenzene compound comprises phenol, resorcinol, or a mixture of phenol and resorcinol, and wherein the hydroxybenzene compound is present in an amount of about 50 wt % to about 90 wt % and the formaldehyde is present in an amount of about 10 wt % to about 50 wt %, based on the combined weight of the hydroxybenzene compound and formaldehyde;
combining the prepolymer, a carboxylic acid, and an anhydride to produce a wet gel reaction mixture, wherein the wet gel reaction mixture comprises about 10 wt % to about 80 wt % of the prepolymer, up to about 85 wt % of the carboxylic acid, and up to about 20 wt % of the anhydride, based on the combined weight of the hydroxybenzene compound, the formaldehyde, the carboxylic acid, and the anhydride;
reacting the prepolymer, the carboxylic acid, and the anhydride to produce a wet gel product;
drying the wet gel product to produce a dried gel product;
pyrolyzing the dried gel product to produce a pyrolized product; and
activating the pyrolized product to produce an activated carbon product, wherein the activated carbon product has at least one property selected from the group consisting of:
a specific surface area of about 100 m²/g to about 7,000 m²/g,
a pore volume of about 0.2 cm³/g to about 10 cm³/g, and
an average pore size of about 0.5 nm to about 150 nm.

20. The method of claim 19, wherein:
the solvent comprises water, one or more alcohols, one or more alkanes, one or more ketones, one or more aromatic hydrocarbons, or any mixture thereof,
the specific surface area is greater than 3,200 m²/g to about 5,000 m²/g,
the pore volume is about 5.01 cm³/g to about 8 cm³/g,
the average pore size is about 2 nm to about 10 nm, and
the activated carbon product has a carbon content of at least 99 wt %.
